(19) United States
(12) Patent Application Publication
(10) Pub. No.: US 2023/0414440 A1
(43) Pub. Date: Dec. 28, 2023

(54) SYSTEM AND METHOD FOR ESTIMATING HUMAN JOINT MOVEMENTS AND CONTROLLING EXOSKELETON ASSISTANCE

(71) Applicant: Georgia Tech Research Corporation, Atlanta, GA (US)

(72) Inventors: Aaron Young, Mableton, GA (US); Dean Molinaro, Atlanta, GA (US); Inseung Kang, Atlanta, GA (US)

(21) Appl. No.: 18/340,981

(22) Filed: Jun. 26, 2023

Related U.S. Application Data
(60) Provisional application No. 63/355,242, filed on Jun. 24, 2022.

(51) Int. Cl. A61H 3/00; A61H 1/02; B25J 9/00; B25J 9/16; G06N 3/0464; G06N 3/084

(52) U.S. Cl. CPC A61H 3/00; A61H 1/0244; B25J 9/0006; B25J 9/1633; G06N 3/0464; G06N 3/084; A61H 2003/001; A61H 2201/5007; A61H 2201/1215; A61H 2201/1659; A61H 2201/5064; A61H 2201/5069; A61H 2201/5079; A61H 2201/5084; A61H 2230/625; A61H 2201/1623; A61H 2201/164; A61H 2201/0192; A61H 2003/007; A61H 2201/165; A61H 2201/1628

(57) ABSTRACT

A device may include a high-level control layer comprising a convolutional neural network (CNN) configured to receive exoskeleton sensor data from one or more sensors on an exoskeleton and generate a user state estimate. The device may include a mid-level control layer configured to receive the user state estimate and generate a torque command for an actuator based on the user state estimate. The user state estimate may be an estimated gait phase, where the mid-level control layer generates the torque command as a function of the estimated gait phase based on an assistance profile. The high-level control layer may include a backward labeler and a real-time adaptation trainer. The backward labeler relabels ground truth gait phase from the exoskeleton sensor data using a local peak detection. The real-time adaptation trainer trains the CNN in a single epoch of backpropagation with the ground truth gait phase.

### CROSS-REFERENCE TO RELATED APPLICATIONS

This application claims priority to U.S. Provisional Application Ser. No. 63/355,242 filed Jun. 24, 2022, the disclosure of which is expressly incorporated herein by reference.

### FEDERALLY SPONSORED RESEARCH AND DEVELOPMENT

This invention was made with government support under Grant No. NRI-1830215 awarded by the National Science Foundation. The government has certain rights in the invention.

### BACKGROUND

Exoskeletons are wearable devices that can augment or enhance the physical abilities of a person. Lower-limb exoskeletons specifically are designed to assist with mobility and movement of the legs. Generally, exoskeletons include powered, unpowered, and hybrid exoskeletons. Unpowered exoskeletons use springs or other elastic materials to store and release energy, which can reduce the effort required to walk or run. Athletes often use them to improve performance or reduce the risk of injury.

Powered exoskeletons use motors or actuators to provide mechanical assistance to the wearer's lower limbs and are often used to help individuals with mobility impairments due to spinal cord injuries, stroke, or other conditions. Hybrid exoskeletons combine elements of both powered and unpowered exoskeletons and can provide a balance of assistance and flexibility for the wearer. While powered and hybrid exoskeletons have shown promise in assisting individuals with mobility impairments, there are also limitations to their current capabilities. For example, power consumption of powered exoskeletons can limit their range and endurance while at the same time the size and weight of powered exoskeletons can make them uncomfortable to wear for long periods of time. Moreover, powered exoskeletons are typically optimized for particular modes of ambulation (e.g., level ground walking) and may not be able to navigate changing or uneven terrain, which can limit their usefulness.

Robotic lower-limb exoskeletons have the potential to restore human motor function and augment mobility. To date, lower-limb robotic exoskeletons have had substantial success in improving human mobility, such as improving human energetics, by offloading or adding to the mechanical work done by the underlying human musculature. While the tangible benefits and potential societal impacts of these devices continue to be discovered, we fail to see this technology deployed in the real-world.

### SUMMARY

A first aspect of the disclosure includes an exoskeleton control architecture of one or more memory structures and/or computer executable instructions stored on one or more non-transitory computer readable medium and executable by one or more processors. The exoskeleton control architecture comprises a high-level control layer comprising a convolutional neural network (CNN) configured to receive exoskeleton sensor data from one or more sensors on an exoskeleton and generate a user state estimate. The exoskeleton control architecture comprises a mid-level control layer configured to receive the user state estimate and generate a torque command for an actuator of the exoskeleton based on the user state estimate.

In some implementations of the first aspect of the disclosure, the exoskeleton control architecture comprises a low-level control layer implemented on a motor driver of the actuator and configured to translate the torque command into an actuator action to supply a joint torque.

In some implementations of the first aspect of the disclosure, the actuator action is a motor current, wherein the low-level control layer uses closed-loop current-feedback control to translate the torque command into the motor current.

In some implementations of the first aspect of the disclosure, the exoskeleton is an autonomous robotic joint exoskeleton.

In some implementations of the first aspect of the disclosure, the one or more sensors include an encoder configured to measure a joint position and/or angular velocity and/or one or more inertial measurement units (IMUs) configured to measure joint position and/or kinematics.

In some implementations of the first aspect of the disclosure, the exoskeleton sensor data comprises measured sensor data and/or derived sensor data including one or more of position, velocity, and/or acceleration.

In some implementations of the first aspect of the disclosure, the user state estimate is an estimated joint moment and the mid-level control layer is configured to scale, delay, and filter the estimated joint moment to generate the torque command.

In some implementations of the first aspect of the disclosure, the user state estimate is an estimated gait phase and the mid-level control layer is configured to generate the torque command as a function of the estimated gait phase based on an assistance profile.

In some implementations of the first aspect of the disclosure, timing and magnitude of nodes of the assistance profile represent control parameters, wherein the mid-level control layer comprises a human-in-the-loop optimization process that updates a cost landscape based on walking speed and samples the control parameters that increases walking speed improvement based on the updated cost landscape.

In some implementations of the first aspect of the disclosure, the CNN is a temporal convolutional network (TCN) and the TCN comprises a series of a plurality of residual blocks and skip connections, wherein an output of a previous residual block is summed elementwise with an output of a following residual block via the skip connections. Each of the plurality of residual blocks comprises one or more convolutional layers, wherein a dilation factor of the one or more convolutional layers increases with one or more subsequent residual blocks in the series of the plurality of residual blocks.

In some implementations of the first aspect of the disclosure, each of the plurality of residual blocks comprises two convolutional layers that are each followed by a weight normalization layer and an activation layer.

In some implementations of the first aspect of the disclosure, the TCN further comprises a convolution layers following each of the plurality of residual blocks.

In some implementations of the first aspect of the disclosure, the TCN further comprises a fully connected output layer.

In some implementations of the first aspect of the disclosure, the high-level control layer further comprises a backward labeler configured to relabel ground truth gait phase from the exoskeleton sensor data using a local peak detection. The high-level control layer further comprises a real-time adaptation trainer configured to train the CNN in a single epoch of backpropagation with the ground truth gait phase.

In some implementations of the first aspect of the disclosure, the backward labeler and the real-time adaptation trainer operate at different frequencies during an adaptation cycle, wherein the adaptation cycle occurs at a predetermined period.

In some implementations of the first aspect of the disclosure, the backward labeler and the real time adaptation trainer operate in parallel.

In some implementations of the first aspect of the disclosure, the CNN is trained based on sensor data from a second exoskeleton, wherein the high-level control layer comprises a transformation matrix that transforms the sensor data from the one or more sensors on the exoskeleton to a data form for the second exoskeleton.

In some implementations of the first aspect of the disclosure, the exoskeleton control architecture comprises further comprises a first processor configured to execute an inference process with the CNN as a dedicated process. The exoskeleton control architecture comprises a second processor configured to execute the mid-level control layer.

In some implementations of the first aspect of the disclosure, the first processor is further configured to execute an I/O process configured to receive and supply the exoskeleton sensor data to the inference process via an input queue.

In some implementations of the first aspect of the disclosure, the second processor is further configured to supply the torque command to the actuator of the exoskeleton.

### BRIEF DESCRIPTION OF DRAWINGS

FIGS. 1A and 1B show views of an exoskeleton system according to various implementations of the disclosure.

FIG. 2 is a flow diagram of a training and control architecture for the exoskeleton system according to various implementations of the disclosure.

FIG. 3 is a system block diagram of the control architecture for the exoskeleton system according to various implementations of the disclosure.

FIG. 4 is a temporal convolution network of the control architecture for the exoskeleton system according to various implementations of the disclosure.

FIG. 5A is a mid-level control layer of the control architecture for the exoskeleton system according to various implementations of the disclosure. FIG. 5B is a diagram of the metabolic cost of walking based on different mid-level delays.

FIG. 6A is a three-tier control scheme incorporating a deep learning-based gait phase estimator according to various implementations of the disclosure. FIG. 6B is an online adaptation framework according to various implementations of the disclosure. FIG. 6C shows a transfer of a pre-trained model to different hardware using a sensor data transformation technique according to various implementations of the disclosure.

FIG. 7 is a human-in-the-loop optimization of exoskeleton control parameters according to various implementations of the disclosure.

FIGS. 8A-8F show an evaluation of metabolic cost during level and inclined walking according to various implementations of the disclosure.

FIGS. 9A-9H show evaluation of joint work on level ground walking and ramp ascent according to various implementations of the disclosure.

FIGS. 10A-10C shows hip motion estimation root-mean square error between the baseline method and the temporal convolution network according to various implementations of the disclosure.

FIGS. 11A-11C shows hip motion estimation R² between the baseline method and the temporal convolution network according to various implementations of the disclosure.

FIGS. 12A-12D show representative examples of hip moments estimated by the temporal convolutional network (TCN) and the corresponding ground truth values.

FIGS. 13A-13B show results of testing on ambulation modes included in the training set and not included in the training set.

FIGS. 14A-14B show effects in RMSE and R² among the training set conditions.

FIGS. 15A-15C evaluate the online adaptation framework performance validation on able-bodied subjects.

FIGS. 16A-16B show the online adaptation framework performance validation on able-bodied subjects in a simulated asymmetric gait environment.

FIGS. 17A and 17B show the online adaptation framework performance validation on stroke survivors.

FIGS. 18A-18C show representative stroke survivor's adaptation performance in an overground validation trial.

FIGS. 19A-19C show evaluations of integration of gait phase adaptation and control parameter optimization in improving stroke gait.

FIG. 20 shows stride-averaged pelvis IMU data from a first subject.

FIG. 21 shows stride-averaged pelvis IMU data from a second subject.

FIGS. 22A-22B show the resulting RMSE for the accelerometer data and gyroscope data.

FIG. 23 shows the resulting RMSE of the online gait phase estimator when implemented on a new exoskeleton.

FIG. 24 shows backward labeling of the user's gait phase.

FIG. 25 shows a time series graph illustrating the application of a peak detection algorithm in stroke gait.

FIG. 26 shows offline performance validation of the adaptation framework.

FIGS. 27A-27B show performance of the online adaptation framework during multimodal locomotion.

FIGS. 28A-28B show gait phase estimator performance during level-ground walking using different baseline models.

### DETAILED DESCRIPTION

In evaluating what is preventing exoskeleton technology from being realized “in-the-wild”, one challenge lies within the exoskeleton controller. Generally, exoskeleton controllers can be divided into three layers: the high-level, the mid-level, and the low-level. The high-level layer estimates user and environmental state information, such as the user's ambulation mode or the ground slope, a significant component for modulating exoskeleton assistance with changes in the user's underlying physiological demands. These high-level state estimates are passed to the mid-level layer, used to compute the desired assistance based on predefined control laws (e.g., spline-based assistance trajectories or impedance equations). Finally, the output of the mid-level layer is passed to the low-level layer, which converts the desired exoskeleton assistance into actuator commands often using motor-level state feedback control.

While the advent of human-in-the-loop optimization and on-the-fly metabolic cost estimation hold promise for optimizing and personalizing exoskeleton control, these mid-level controllers still require reoptimizing controller gains for high-level state, a time intensive process. Further, given the hierarchical structure of this control framework, these advances in mid-level control are dependent on the accurate estimation of high-level states of the user and environment. While substantial research exists using physics-driven and machine learning models to quantify one or more high-level states in real-time, it becomes intractable to define, estimate, and subsequently optimize high-level and mid-level controllers for the set of possible states to parameterize human movement in-the-wild. Thus, there is a need for an alternative parameterization for exoskeleton control to enable the migration of exoskeletons from the lab into the real-world.

Recently, researchers have begun investigating the use of an alternative high-level state that could direct exoskeleton controllers to generalize to real-world contexts—instantaneous estimates of the user's underlying joint moments. Given that lower-limb joint moments naturally change with variations in ambulation mode and condition, it is possible to leverage the user's internal joint moment as a single, continuous high-level estimate for modulating exoskeleton assistance. While promising in theory, human joint moments cannot be directly measured with wearable sensors. Conventionally, ground truth human joint moments are computed post hoc using high fidelity motion capture and 6-axis force plate measurements from stationary in-lab equipment. Replacing these systems with wearable sensors results in incomplete information (e.g., missing shear forces), preventing the viability of purely analytical solutions from wearable sensors alone.

Alternatively, data-driven approaches offer the potential to map wearable sensor data to user joint moments, with higher accuracy than model-based approaches and without the need for any subject-specific calibration. Using these methods, researchers have conducted initial pilot experiments using instantaneous joint moment estimates in the exoskeleton control loop. Perhaps the most compelling implemented an ankle moment estimator using a quadratic regression model based on pressure insole data, yielding metabolic reductions relative to wearing the unpowered exoskeleton in three participants during level ground walking. While these preliminary results are promising, the limited expressiveness of a quadratic regression model makes it unlikely to scale beyond level ground walking and to exoskeletons that assist the hip and knee without reintroducing a state machine into the controller, (i.e., without largely removing the benefits of a physiologically-driven system). Thus, a unified exoskeleton control framework capable of autonomously assisting the user across a wide variety of ambulation modes and intensities (i.e., walking speeds, ground slopes, and stair heights) continues to elude researchers—maintaining the divide between in-lab exoskeleton technology and real-world benefits.

Robotic lower-limb exoskeletons can augment and restore human mobility, but current systems cannot modulate assistance across user and environmental contexts without extensive, context-specific hand tuning or optimization. This limitation has relegated exoskeleton benefits to highly specific, generally in-lab, conditions.

Disclosed herein is a unified exoskeleton control framework that autonomously adapts assistance based on instantaneous user joint moment estimates from convolutional neural network (CNN), and in some implementations, a temporal convolutional network (TCN). Other neural network or deep learning models are contemplated by this disclosure. When deployed on a hip exoskeleton, the TCN achieved state-of-the-art accuracy across several ambulatory contexts without any subject-specific calibration. Further, the unified controller significantly reduced user metabolic cost and lower-limb positive work during level ground and incline walking compared to walking without wearing the exoskeleton. This advancement bridges the gap between in-lab exoskeleton technology and real-world human ambulation, making exoskeleton technology viable for the broad community that may benefit from it. For instance, this exoskeleton framework could extend the endurance of workers in demanding occupations, such as search and rescue.

Disclosed herein is a novel, end-to-end framework for controlling a robotic exoskeleton based solely on instantaneous estimates of the user's joint moments (i.e., unified joint moment control). In various examples described below, the hip joint is targeted, since it is a primary power generator across several ambulation modes, making hip exoskeletons successful at augmenting human energetics across a variety of ambulatory conditions. However, the framework is also applicable to exoskeletons targeting other joints, such as the knee, arm, shoulder, back, or any other desired joint.

Computing hip moments from inverse dynamics requires complete kinematic information of the distal joints, suggesting that hip moment estimators would require complex and likely cumbersome multi-joint sensor suites. Instead, a temporal convolutional network (TCN) is disclosed for estimating hip flexion/extension moments, which leverages the temporal information in the exoskeleton sensor data as a substitute for multi-joint sensing. Specifically, the TCN relies solely on kinematic data from sensors embedded on the hip exoskeleton and does not require any subject-specific calibration or other user state information (e.g., ambulation mode and gait phase). The TCN is deployed on the hip exoskeleton, enabling the device with accurate estimates of the user's hip flexion/extension moments across a wide range of ambulation modes and intensities. To leverage estimates from the TCN in the control loop, a unified mid-level control layer was developed that computes exoskeleton assistance based solely on the instantaneous estimates of the user's hip moments from the TCN.

Because the disclosed unified controller naturally adapts exoskeleton assistance with changes in user joint dynamics, the controller reduces user metabolic cost during both level ground and incline walking compared to Zero Torque. Further, given the adaptive assistance of the unified controller and the lightweight design of the custom hip exoskeleton, using the unified controller also reduces users metabolic cost beyond that of No Exo during both level ground and incline walking, breaking the metabolic cost barrier across multiple ambulation modes. To further decompose the energetic effects of the system on the user, the impact of the unified controller on the user's lower-limb positive joint work compared to No Exo is quantified. Improvements in metabolic cost are reflected in lower-limb joint work as users would substitute the joint work required from their hip joints with that of the exoskeleton, reducing the overall positive mechanical work of the lower limb compared to No Exo.

The approach disclosed herein was benchmarked against a Baseline method designed to emulate bio-inspired exoskeleton controllers from previous studies, which included predicting the average hip moment profile computed a prior from the training set for each ambulation mode. Since the TCN captures variations in the hip moment with changes in individual user, with changes in ambulation intensity (i.e., walking speed, ramp slope, and stair height), and with changes due to stride-to-stride variability, the TCN outperforms the baseline method, even when implemented in its best case (i.e., the baseline method assumed a perfectly accurate ambulation mode and gait phase oracle). Specifically, the TCN reduces the root-mean-square error (RMSE) and increases the R² of the hip moment estimates compared to the Baseline method.

The disclosed system provides a first-of-its-kind unified exoskeleton controller powered by a deep learning model to completely reparametrize exoskeleton control. The disclosed system provides a unified exoskeleton controller that autonomously adapts assistance with changing ambulation mode and intensity. The approach did not require sensors other than those embedded on the device or any subject-specific calibration. As a result, the approach yields a strategy that seamlessly adapted assistance with changes across exoskeleton users, ambulation modes, and ambulation intensities without the need for any tuning or experimenter intervention. Using this control framework, significant improvements in user mobility metrics (i.e., metabolic cost and lower-limb joint work) are measured during both level ground and incline walking, demonstrating the viability of our approach for augmenting multimodal ambulation. Further, it was found that the TCN that powered the unified controller maintained high accuracy when implemented online, outperforming the best-case Baseline method.

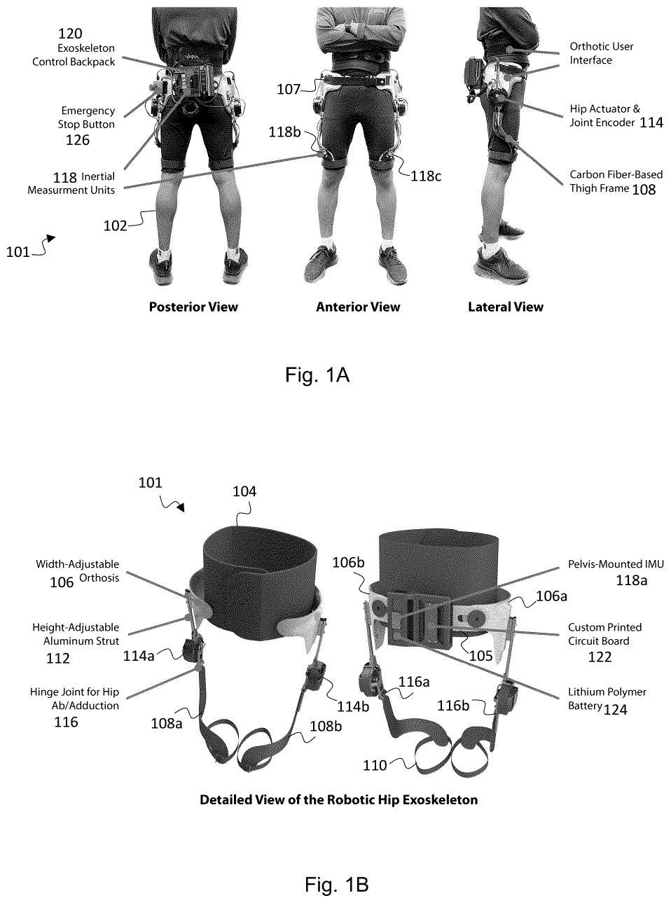

FIGS. 1A and 1B show views of an exoskeleton system 101 according to various implementations of the disclosure. FIG. 1A shows the exoskeleton system 101 in an installed configuration on a subject 102 and FIG. 1B shows the exoskeleton system 101 in an uninstalled configuration. The exoskeleton system 101 in the examples of FIGS. 1A and 1B is a powered bilateral robotic hip exoskeleton developed to assist hip flexion and extension (sagittal plane) movement during locomotion.

The exoskeleton system 101 includes a belt 104 for attaching the exoskeleton system 101 to the torso of the subject 102. Width-adjustable orthosis 106 (first width-adjustable orthosis 106a and/or second width-adjustable orthosis 106b), sometimes referred to as width-adjustable lumbosacral orthosis, are provided to fit the exoskeleton system 101 tightly to the pelvis of the subject 102, allowing the exoskeleton system 101 to transfer joint torque to the subject 102. In the example shown, the belt 104 is attached to a backplate 105 of the width-adjustable orthosis 106.

In various implementations, the width-adjustable orthosis 106 additionally includes a second belt 107 across the width-adjustable orthosis 106 (e.g., from the first width-adjustable orthosis 106a to the second width-adjustable orthosis 106b) for securing the width-adjustable orthosis 106 to the pelvis of the subject 102.

In various implementations, the width-adjustable orthosis 106 is formed from plastic, carbon fiber, aluminum, steel, or other suitable materials. In some implementations, warping of the width-adjustable orthosis 106 was identified when formed from plastic when operating the exoskeleton system 101 near its peak torque capabilities. In some implementations, a carbon fiber backplate 105 and width-adjustable orthosis 106 are provided to improve load transmission while maintaining medial/lateral adjustability and a similar device weight.

A thigh frame 108 (first thigh frame 108a and/or a second thigh frame 108b) extends down each thigh of the subject 102 and includes a thigh belt 110 releasably attachable to the thighs of the subject 102. The thigh frame 108 is shaped to extend down the side of the thigh of the subject 102 and around to the front of the thigh for transferring torque to the subject 102 just above the knee (e.g., within about 1-4 inches of the knee joint, where the term “about” is used throughout this disclosure to indicate a measurement within 10-25% of the stated values). In other words, the thigh frame 108 includes thigh interfaces designed to reorient actuator output torque into a perpendicular force on the anterior part of the subject 102 thigh segment. Therefore, loads resulting from the actuator output are transmitted to the subject 102 through the thigh frame 108. Other shapes and configurations of the thigh frame 108 are contemplated by this disclosure, such as a shape configured reorient actuator output torque into a perpendicular force on the posterior part of the subject 102 thigh segment. In various implementations, the thigh frame 108 is formed from carbon fiber, aluminum, steel, or other suitable materials.

A hip actuator and encoder 114 (first hip actuator and encoder 114a and/or a second hip actuator and encoder 114b) is coupled to the thigh frame 108 for transferring torque generated by the hip actuator and encoder 114 to the thigh frame 108. In the example shown, the first hip actuator and encoder 114a is coupled to the first thigh frame 108a and the second hip actuator and encoder 114b is coupled to the second thigh frame 108b. The hip actuator and encoder 114 also includes an encoder for measuring the hip joint position and/or angular velocity of the subject 102. The hip actuator and encoder 114 is also attached to the width-adjustable orthosis 106 bilaterally. In the example shown, the first hip actuator and encoder 114a is attached to the first width-adjustable orthosis 106a and the second hip actuator and encoder 114b is attached to the second width-adjustable orthosis 106b.

In various implementations, the encoder is a 12-bit incremental rotary encoder. In various implementations, the encoder and the hip actuator are provided as separate elements. While various examples are provided herein with reference to a rotary encoder, other encoders are contemplated by this disclosure, including hall effect encoders, mechanical encoders, potentiometers, optical encoders, or any other type of encoder suitable for measuring a movement of the thigh frame 108 relative to the hip actuator and encoder 114.

In various implementations, the hip actuator and encoder 114 is an electromechanical actuator (e.g., AK80-9, T-motor, China) including a brushless DC motor and a single-stage 9:1 planetary gearhead to provide relevant joint torque. The low gear ratio allows the hip actuator and encoder 114 to operate in quasi-direct drive behavior, providing a mechanical feature with two advantages: 1) reduced reflected inertia, making the system easy to back-drive in the case that the user needed to manually drive the device (e.g., if the exoskeleton unexpectedly turned off); and 2) efficiency in torque transmission.

In various implementations, the hip actuator and encoder 114 is able to provide up to 18 Nm peak torque, which is approximately 40% of the peak biological hip joint moment during level-ground walking for an average adult male. Other peak torque amounts are contemplated by this disclosure.

In various implementations, the hip actuator and encoder 114 has a peak angular velocity of 25.6 rad/s, which captures the entire range of the hip joint angular velocity across various locomotion modes. For example, it has been found that a speed of 25.6 rad/s at peak torque exceeds peak angular velocities of the hip joint in both walking and running. Other angular velocities are contemplated by this disclosure.

In various implementations, to ensure the hip actuator and encoder 114 does not limit the user's range of motion, the hip actuator and encoder 114 provides a hip flexion/extension range of motion from 2.22 rad of hip flexion to 0.65 rad of hip extension. During trials with this hip flexion/extension range, participants did not reach the maximum range of motion of the hip actuator and encoder 114. Other ranges of motion are contemplated by this disclosure.

In various implementations, the hip actuator and encoder 114 is attached to the width-adjustable orthosis 106 via a height-adjustable strut 112 (first height-adjustable strut 112a and/or second height-adjustable strut 112b) to ensured that a shaft or pivot point of the hip actuator and encoder 114 is coaxially aligned with the biological hip joint of the subject 102. In other words, the hip actuator and encoder 114 are mounted in parallel with the hip joint of the subject 102. In various implementations, the height-adjustable strut 112 is formed from aluminum, carbon fiber, steel, or other suitable materials.

In a specific implementation, the width-adjustable orthosis 106 is formed from plastic, the thigh frame 108 is formed from carbon fiber, and the height-adjustable strut 112 is formed from aluminum.

In various implementations, the hip actuator and encoder 114 is coupled to the thigh frame 108 via a passive hinge joint 116 (first passive hinge joint 116a and/or second passive hinge joint 116b). The passive hinge joint 116 has an axis of rotation orthogonal to an axis of rotation of the hip actuator and encoder 114. The passive hinge joint 116 allows for mediolateral movement, reducing or eliminating potential discomfort of the subject 102 caused during hip abduction and hip adduction. In other words, the passive hinge joint 116 positioned under the hip actuator and encoder 114 allows for hip abduction and adduction movement.

In various implementations, the hip actuator and encoder 114 allows for a range of hip joint movement between 37° extension and 127° flexion, covering the full range of the hip joint position during level-ground walking.

Inertial measurement units (IMUs) 118 are coupled to the exoskeleton system 101 for measuring acceleration and angular velocity data. The IMUs 118 include a pelvis mounted IMU 118a, a first thigh frame mounted IMU 118b, and a second thigh frame mounted IMU 118c. The thigh frame mounted IMUs 118b, 118c are mounted on an anterior section of the respective thigh frame 108, such as along the thigh interface of the thigh frame 108. In various implementations, the IMUs 118 are 6-axis IMUs (e.g., MPU-9250, InvenSense, USA). In various implementations, the pelvis mounted IMU 118a is mounted near the sacrum of the subject 102 as a proxy to capture pelvis kinematics. In various implementations, one or more of the IMUs 118 may be omitted. For example, in one implementation, the IMU 118b and/or 118c may be omitted.

A control system 120 includes a controller 122 and a power supply 124. The control system 120 is mounted to the backplate 105 of the exoskeleton system 101. The controller 122 is electrically coupled (wired or wireless) to receive measurements from the IMUs 118 and the encoder of the hip actuator and encoder 114. The controller 122 processes the received measurements and generates one or more control signals (power and/or commands) for a targeted torque to the hip actuator and encoder 114. The hip actuator and encoder 114 in turn supplies output torque to thigh frame 108 based on the targeted torque. The power supply 124 provides power to the controller 122, the IMUs 118, and the hip actuator and encoder 114.

In various implementations, the controller 122 includes an onboard microprocessor (e.g., myRIO 1900, National Instruments, USA) to serve as a main host unit to control the exoskeleton system 101 including sensor data acquisition. An additional coprocessor (e.g., Jetson Nano, Nvidia) may be integrated into the controller 122 to execute real-time inference and online adaptation of the gait phase model using data from onboard sensors, as described in detail below. In some implementations, the host microprocessor is equipped with a field programmable gate array (FPGA), which allows the controller 122 to communicate with different sensors effectively without overloading the computational power in the main host unit. The terms microprocessor, microcontroller, and processor are used interchangeably throughout this disclosure to refer to distinct computational hardware systems (e.g., different control boards, different on-board computers, different chips on a single control board, and/or different cores or other hardware within a processor).

In various implementations, the controller 122 communicated directly with the IMUs 118 via SPI communication. For the hip actuator and encoder 114, an SPI-CAN converter (e.g., MCP 2515), which included a CAN transceiver (e.g., TJA 1050), is used to convert relevant data packets between the controller 122 and a motor driver of the hip actuator and encoder 114.

In various implementations, sensor data acquisition and torque command are updated at 200 Hz in a main control loop of the main host unit of the controller 122. A motor driver of the hip actuator and encoder 114 executes the targeted torque via closed-loop current control at 1 kHz. Real-time sensor data is streamed to the high-level coprocessor (e.g., FPGA) at 200 Hz via a standard ethernet cable using a TCP/IP protocol for real-time inference and adaptation.

In various implementations, the power supply 124 includes a 24 V 3600 mAh lithium polymer battery (Venom Power, USA). In some implementations, the battery voltage delivered to the controller 122 main host processor is stepped down to 11 V using an adjustable step-down voltage regulator (LM2596, Texas Instruments, TX, USA). In some implementations, the battery voltage delivered to the controller 122 additional coprocessor is stepped down to 5 V. In some implementations, the additional coprocessor of the controller 122 is powered by a separate 5 V batter.

In an implementation, the exoskeleton system 101 has a total mass of 4.8 kg, including the electronics and batteries.

A summary of relevant design specifications of the exoskeleton system 101 are provided in Table 1, below.

TABLE 1

| Parameter | Value | |
|---|---|---|
| Peak Torque | 18 | Nm |
| Max. Continuous Torque | 9 | Nm |
| Max. Speed at Peak Torque | 25.6 | rad/s |
| Actuator Mass | 0.49 | kg |
| Total Exoskeleton Mass | 4.8 | kg |

| | |
|---|---|
| Hip Extension Range of Motion | −2.22 to 0.65 rad |

While the exoskeleton system 101 is described above with particular reference to the powered bilateral robotic hip exoskeleton shown in FIGS. 1A and 1B, the disclosure is applicable to other exoskeleton systems, include those that apply torque across any other joints, such as a knee, arm, shoulder, back, or any other desired joint.

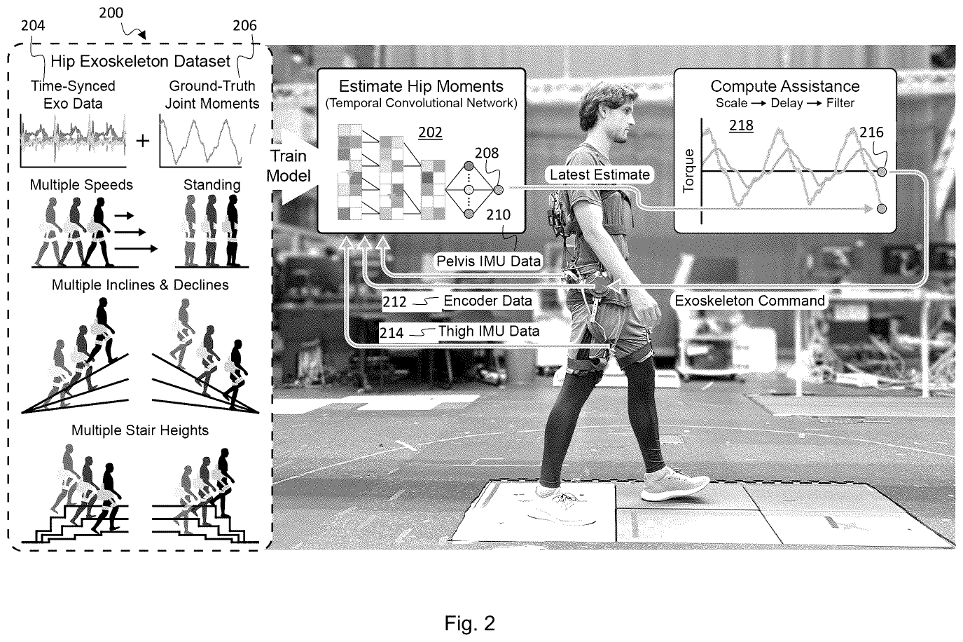

FIG. 2 is a flow diagram of a training and control architecture 200 for the exoskeleton system 101 according to various implementations of the disclosure. A temporal convolutional network (TCN) 202 is trained using time-synced exoskeleton data 204 and ground truth labels 206 to generate an estimate of hip moments 208 of a user based on input data 210 from the pelvis mounted IMU 118a, input data 212 from the thigh frame mounted IMUs 118b, 118c, and input data from the encoder of the first and second hip actuator and encoders 114a, 114b mounted on the exoskeleton system 101, as described above. While the TCN 202 is described in various examples throughout the disclosure, it is contemplated that in various implementations a convolutional neural network (CNN) may be used. The estimated hip moments 208 from the TCN 202 are converted to desired exoskeleton assistance 216 using a mid-level control layer 218, which scales, delays, and filters the estimated hip moments 208, as described in more detail below. The exoskeleton assistance 216 may take the form of an exoskeleton command, voltage, current, or other control signal. By training TCN 202 with data from a variety of conditions (e.g., multiple speeds, inclines, declines stair heights, stationary standing, etc.), the TCN 202 seamlessly adapts desired exoskeleton assistance 216 across different users, ambulation modes, and ambulation intensities without the need for subject-specific calibration data.

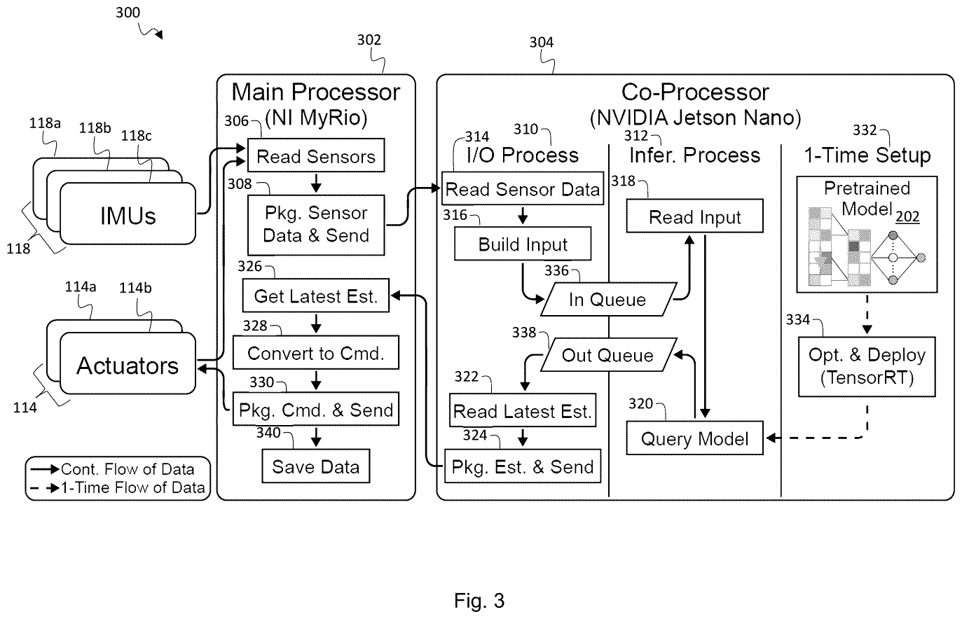

FIG. 3 is a system block diagram of a control architecture 300 for the exoskeleton system 101 according to various implementations of the disclosure. The control architecture 300 includes a main processor 302 and a co-processor 304. As shown, the main processor 302 and the co-processor 304 are distinct computer hardware systems. The main processor 302 is electrically connected (wired or wirelessly) to receive sensor data from the IMUs 118 and the encoder from the hip actuator and encoder 114. At 306, the main processor 302 reads sensor data from the IMUs 118 and the encoder of the hip actuator and encoder 114. At 308, the main processor 302 then packages and sends the sensor data to an input/output (I/O) process 310 of the co-processor 304. In some implementations, the main processor 302 immediately sends the sensor data to the co-processor 304.

The co-processor 304 runs two independent processes: the I/O process 310 and an inference process 312. The I/O process 310 handles communication of data with the main processor 302 and shapes the sensor data for model inference. At 314, the I/O process 310 of the co-processor 304 receives the sensor data sent from the main processor 302. At 316, the I/O process 310 shapes, formats, processes, or otherwise prepares the sensor data for input to the TCN 202.

In some implementations, the inference process 312 is dedicated solely to model inference to minimize estimate latency. At 318, the inference process 312 reads or receives the shaped sensor data. At 320, the inference process 312 queries the TCN 202 with the shaped sensor data to generate a hip moment estimate (e.g., one of the estimated hip moments 208, described above). The resulting hip moment estimates from TCN 202 are read by the I/O process 310 at 322. The read hip moment estimate is communicated back to the main processor 302 at 324.

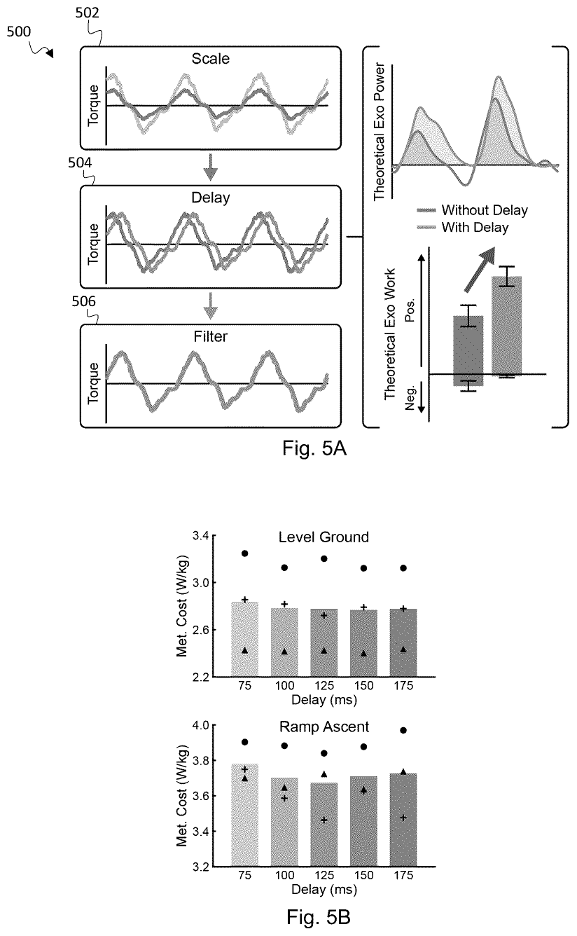

At 326, the main processor 302, receives the hip moment estimate. At 328, the main processor 302 implements a mid-level control layer that converts/transforms the hip moment estimate into an actuator command (torque command) for causing the hip actuator and encoder 114 to impart a torque on the subject 102. In some implementations, the conversion of the hip moment estimate to the actuator command is performed according to the mid-level control layer described below with reference to FIG. 5A. In some implementations the actuator command (torque command) is a torque amount or torque level that the hip actuator and encoder 114 is instructed to provide.

At 330, the main processor 302 packages and sends the actuator command(s) (torque commands) to the hip actuator and encoder 114 for applying torque to the subject 102. In various implementations, the actuator command(s) can take the form of an exoskeleton command, voltage, current, or other control signal for controlling the application of torque by the hip actuator and encoder 114. In an example, the desired torque determined by the mid-level control layer is passed to motor drivers (i.e., the low-level layer) of the hip actuator and encoder 114, which converts the desired torque to a commanded motor current using closed-loop current-feedback control.

In some implementations, to further increase the inference speed of the inference process 312, the TCN 202 used to estimate the hip moments of the subject 102 is converted to a TensorRT runtime engine 334 before deployment in a 1-time setup process 332.

In some implementations, an input queue 336 and an output queue 338 are used to exchange data between the I/O process 310 and the inference process 312.

In some implementations, though typically uncommon, in the case that any of the processes 310, 312 on the co-processor 304 run too slowly (e.g., model inference took longer than expected during one forward pass), the I/O and queue operations (e.g., elements 306, 308, 314, 316, 336, 338, 322-330) within the main processor 302 and co-processor 304 are implemented with non-blocking logic (i.e., if new data was not available fast enough, the process would continue based on data from the previous loop after predetermined timeouts) to maintain a desired exoskeleton loop rate (e.g., 200 Hz).

In some implementations, at 340, the main processor 302 additionally saves one or more logs of the sensor data at 308, the received hip moment estimates at 326, the command generated at 328, and/or any other data handled by the main processor 302.

The software used to control the exoskeleton system 101 is distributed across the main processor 302 (i.e., the myRio) and the co-processor 304 (i.e., the Jetson Nano) to efficiently integrate the neural network-based hip moment estimator (i.e., TCN 202) into the control loop. In an example, software on the main processor 302 is developed using LabVIEW v2019, while the co-processor software is developed in Python v3.6.9.

In an example, with each new message, the incoming sensor data is added to a first-in-first-out buffer on the co-processor via the I/O process 310, at 314. Input sequences for the left and right leg are then queried from the buffer and transformed such that two input sequences, one for each anatomical side, are generated from the latest exoskeleton sensor data. The input sequences are then concatenated into a 3D tensor (i.e., with a batch size of two) at 316 and passed to the inference process 312 via a Python multiprocessing input queue 336. The input tensor is copied to a GPU of the co-processor 304 and passed through the TCN 202 to estimate the left and right hip flexion/extension moments at 320. To minimize inference latency in real-time, the pretrained neural network (e.g., TCN 202) is loaded onto the GPU of the co-processor 304 after being converted into a TensorRT runtime engine using TensorRT v8.0.1.6. The resulting hip moment estimates are then copied to a CPU of the co-processor 304 within the inference process 312, returned to the I/O process 310 via a second multiprocessing output queue 338, and returned to the main processor to be used for exoskeleton control.

In an example, the average latency between sending exoskeleton sensor data to the co-processor 304 and receiving the corresponding hip moment estimates was 5 ms (i.e., the estimated hip moments are one timestep delayed on average).

In an example, with each loop of the controller, the main processor 302 receives the angular position of an actuator output shaft from an actuator-mounted encoder of the hip actuator and encoder 114. The main processor 302 also receives 6-axis acceleration and angular velocity data from the IMUs 118.

In an example, at 308, the angular velocity of the hip actuator and encoder 114 is computed onboard the main processor 302 using backward finite differencing and is lowpass filtered using a 2nd order Butterworth filter with a 10 Hz cutoff frequency. Encoder and IMU data is subsequently streamed to the co-processor over an ethernet connection using TCP/IP.

In some implementations, to communicate with the main processor 302, a graphical interface is provided on an external computer (not shown)(e.g., laptop, desktop, tablet, phone, etc.) to display exoskeleton state information streamed from the main processor 302 (e.g., copies of the data saved at 340). The graphical user interface on the external computer may additionally facilitate a user to start or stop the main processor 302 and/or toggle whether the main processor 302 provides assistance to the subject 102 by sending commands at 330. In some implementations, the co-processor 304 also communicates with the external computer using Secure Shell Protocol (SSH), allowing the user to start I/O process 310 and/or the inference process 312 on the co-processor 304 from a remote terminal. In an example, the main processor 302, co-processor 304, and external computer are connected using a wired or wireless network hosted by a Wi-Fi router or other wireless communication protocol.

While a particular control architecture 300 is shown in described in FIG. 3, other control architectures and processor configurations and data flows are contemplated by this disclosure.

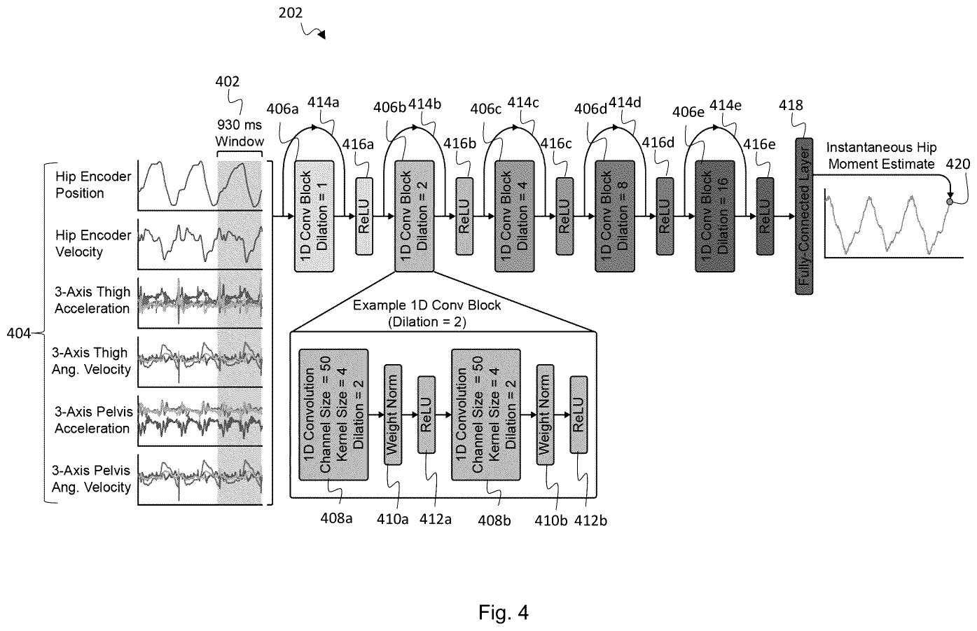

FIG. 4 is an example of the temporal convolutional network (TCN) 202 for generating hip moment estimations of the subject 102 with the control architecture 200, 300 for the exoskeleton system 101 according to various implementations of the disclosure.

The TCN 202 uses a window 402 (e.g., 930 ms) of exoskeleton sensor data 404 to estimate instantaneous hip flexion/extension moments. The exoskeleton sensor data 404 may be data directly measured from the hip actuator and encoder 114 and IMUs 118 or derived from such measurements. For example, time stamped position data may be directly measured and used to derive velocity and/or acceleration data. In the example shown, the sensor data includes hip encoder position data, hip encoder velocity data, pelvis mounted IMU 118a 3-axis velocity and acceleration, and thigh frame mounted IMU 118b, 118c 3-axis velocity and acceleration. Other sensor data or measurements derived from the sensor data are contemplated by this disclosure.

The TCN 202 comprises five residual blocks 406 (individually or collectively residual block 406a-406e). Each of the residual blocks 406 is made up of two 1D causal convolutional layers 408 (causal convolution layer 408a and causal convolution layer 408b) that are each followed by a weight normalization layer (weighted normalization layer 410a and weighted normalization layer 410b) and a ReLU activation layer (ReLU activation layer 412a and ReLU activation layer 412b). Each convolutional layer 408 (causal convolution layer 408a and/or causal convolution layer 408b) uses 50 filters and a kernel size of four. The output of the previous residual block 406 is summed elementwise with the output of the following residual block 406 via respective skip connections 414 (individually or collectively 414a-414e). The skip connections 414 may interchangeably be referred to as residual connections. The skip connections 414 stabilized the TCN 202 during training. An additional convolution layer 416 (e.g., individually or collectively ReLU convolution layer 416a-416e) with kernel size of one is used to reshape the data passed via the skip connections 414 in the case that the number of filter maps does not match from the output of one of the residual blocks 406 to the output to the next one of the residual blocks 406 (e.g., at a first residual connection 414a). A single linear layer 418 (e.g., fully connected output layer) is also implemented after a last residual connection 414e of the TCN 202 to compress the 50-channel output into a scalar value (i.e., the estimated hip moment).

Within the causal convolution layers 408, the dilation factor of the convolutional filters is exponentially increased with each of the subsequent residual blocks 406. In the example shown, the dilation factor of the causal convolution layers 408 of the residual block 406a is 1, the dilation factor of the causal convolution layers 408 of the residual block 406b is 2, the dilation factor of the causal convolution layers 408 of the residual block 406c is 4, and so on. While the details of the residual block 406b is shown, the remaining residual blocks 406 are implemented using the same structure, modifying the dilation factor as discussed above. In some implementations, the dilation factor is increased with each subsequent layer either incrementally or exponentially.

The TCN 202 uses dilated causal 1D convolution to efficiently map patterns in the input sequence data to the target output, replacing the need for hand-engineered feature extraction methods. Additionally, the fixed input sequence length of TCNs has been shown to retain information over longer periods of time than recurrent networks, suggesting they can better leverage time history information on larger timescales compared to alternative neural network architectures. As such, TCNs have been successful in many sequence modeling tasks.

The TCN 202 architecture used dilated convolution to exponentially increase the fixed input sequence length of the model with a linear increase in network depth, minimizing the total number of model parameters compared to conventional convolutional neural networks. Specifically, the dilation factor (d) of the 1D convolutional filters in the iₜₕ residual block 406 of the TCN 202, indexed starting at 0, is computed as

dᵢ=2ⁱ, (1)

such that the 1D convolution operation F(·) returns the jₜₕ output of the input sequence x as

$${F}_{j} ( x ) = {\sum }_{n = 0}^{k - 1} {f}_{n} {x}_{j - dn} , \qquad ( 2 )$$

where k is the kernel size and fₙ is the nₜₕ weight of the learned convolutional filter. Thus, the input sequence length (h) of the TCN 202 is computed as

$$h = 1 + {\sum }_{i}^{i - 1} 2 ( k - 1 ) {d}_{i} , \qquad ( 3 )$$

where l is the number of residual blocks o the network. Thus, the TCN 202 shown in FIG. 4 results in an input sequence length of 187 (i.e., 930 ms), computed from Eqn. 3.

The TCN 202 has a single output head that estimates the instantaneous flexion/extension moment of the user's left or right hip scaled by the body mass of the subject 102.

In the example implementation of FIG. 4, the input sequence of the TCN 202 includes the ipsilateral actuator encoder position and velocity, 6-axis ipsilateral thigh-mounted IMU data and 6-axis pelvis-mounted IMU data. Thus, for each model estimate the input sequence to the TCN 202 is a R^{187×14} vector including the latest 930 ms of exoskeleton sensor data. Sensor data from the contralateral limb was not included as input to the model since the majority of the training and testing conditions included symmetric movements which could cause the model to overfit to this type of behavior. Instead, data from the left leg is mirrored such that the left leg input data used the same anatomical coordinate system as the right leg. Further, when inputting data for left-side hip moment estimation, the pelvis IMU data are also mirrored to fit the left-side anatomical coordinate system. This allowed a single network to be trained in a side-independent manner, meaning input sequence data pertaining to the left and right hip joint did not need to be distinguished.

In an example, the TCN 202 is trained via supervised learning in Pytorch v1.8.0 using Python v3.6.9. Left-leg and right-leg training data sequences are randomly shuffled to train the model to estimate the hip moment from either anatomical side. Further, the TCN 202 is trained using an Adam optimizer with an MSE loss function and an initial learning rate of 0.0005 for a minimum of 100 epochs and maximum of 500 epochs. To minimize model training time, each mini-batch includes 4 sequences with a length of 218 (containing valid labels for the last 32 instances in each sequence). Early stopping based on data from a hold-out subject is used to end network training if the validation MSE does not decrease for 50 sequential epochs. In this case, the learned parameters that performed best on the validation data are reloaded and saved as the final model used for further analyses unless otherwise specified. The ground truth label is the hip flexion/extension moments computed from a biomechanical model and scaled by body mass of the subject 102.

In various implementations, a memory (not shown) of the co-processor 304 can include one or more devices (e.g., memory units, memory devices, storage devices, etc.) for storing data and/or computer code for completing and/or facilitating the various processes described in the present disclosure, such as real time execution of the TCN 202 for predicting hip moments. In some implementations, memory includes tangible computer-readable media (e.g., a non-transitory computer readable medium) that stores code or instructions executable by the co-processor 304. Tangible, computer-readable media refers to any physical media that is capable of providing data that causes co-processor 304 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory can include random access memory (RAM), read-only memory (ROM), hard drive storage, temporary storage, non-volatile memory, flash memory, optical memory, or any other suitable memory for storing software objects and/or computer instructions. Memory can include database components, object code components, script components, or any other type of information structure for supporting the various activities and information structures described in the present disclosure. Memory can be communicably connected to co-processor 304 and can include computer code for executing (e.g., by co-processor 304) one or more processes described herein.

The memory of the co-processor 304 includes the TCN 202 or the TensorRT runtime engine 334 converted from the TCN 202. The memory also may include one or more databases, and/or one or more libraries of programming code for implementation of the TCN 202. The TCN 202 is a neural network with a memory structure comprising layers of nodes connected via one or more layers. The nodes can have numeric weights that can be tuned during training of the neural network based on experience, which makes the neural network adaptive and capable of learning. For example, the numeric weights can be used to train the neural network such that the neural network can perform the one or more functions on a set of input variables and produce an output that is associated with the set of input variables. In various implementations, the memory structures of the neural network may be stored as tensors.

The training of the neural network can be formulated as solving a constrained optimization problem. The goal of the optimization problem is to identify a set of optimized weights for the neural network so that a loss function of the neural network is minimized under a constraint that defines the relationship between the input variables and a desired output. Machine learning models may be trained using any suitable supervised or unsupervised training method.

The libraries may include PyTorch, TensorFlow, or any other library for deep learning using GPUs and CPUs. In some implementations, the libraries may be omitted. In such instances, the TCN 202 may be a converted to the TensorRT runtime engine 334.

Certain aspects of the disclosure include operations and data structures with respect to the TCN 202 improve how to estimate user states (e.g., hip moments, gait phase, locomotion mode, walking speed, etc.). Such a structure can improve the control of exoskeleton systems by seamlessly adapting desired exoskeleton assistance across different users, ambulation modes, and ambulation intensities without the need for subject-specific calibration data. Additional or alternative aspects of the disclosure can implement or apply rules of a particular type that improve existing technological processes involving machine-learning techniques. For instance, in order to reduce estimation latency, a dedicated inference process for generating the user state estimates runs on the co-processor 304. The co-processor 304 is a specialized computing system that may be used for executing the TCN 202 and generating user state estimates.

Examples of architectural features of the TCN 202 can include the number of layers, the number of nodes in each layer, the activation functions for each node, or some combination thereof. For example, a neural network may include an input layer, one or more hidden layers, and an output layer. In some implementations, no hidden layers may be present. For instance, the dimension of the input variables can be utilized to determine the number of nodes in the input layer. Likewise, the number of desired outputs can be used to determine the number of nodes in the output layer, that is, one node in the output layer corresponds to one output. Other aspects of the neural network, such as the number of hidden layers, the number of nodes in each hidden layer, and the activation function at each node can be determined based on various factors such as the complexity of the prediction problem, available computation resources, accuracy target, and so on.

The output of a node or an output layer node can be determined by an activation function implemented at that particular node. In some aspects, the output of each of the nodes can be modeled as a logistic function of the input so that node and the output of the neural network can be modeled as a logistic function of the outputs of the nodes in the last hidden layer.

Further, in addition to the activation functions described herein, the TCN 202 can have any activation function that accepts real number inputs and outputs a real number. Examples of activation functions include, but are not limited to, the logistic, arctangent, sigmoid, and hyperbolic tangent functions. In addition, different layers of the neural network can employ the same or different activation functions.

FIG. 5A is a mid-level control layer 500 of the control architecture 200, 300 for the exoskeleton system 101 according to various implementations of the disclosure. In the example described herein, the mid-level control layer 500 is described with reference to the hip exoskeleton system 101 described above. However, the mid-level control layer 500 may likewise be implemented for exoskeleton systems targeting other joints, such as the knee, arm, shoulder, back, or any other desired joint. In various implementations, the mid-level control layer 500 is implemented at 328, as discussed above. FIG. 5B is a diagram of the metabolic cost of walking based on different mid-level delays.

The mid-level control layer 500 computes desired exoskeleton assistance (e.g., actuator command, torque command, torque amount, torque level) based on the instantaneous hip moment estimates from the high-level layer (e.g., the TCN 202). In an example implementation, the mid-level control layer 500 is implemented in three steps in which the received hip moments estimates are scaled 502 to a desired assistance percentage, delayed 504 by a predefined magnitude, and lowpass filtered 506. Delaying the torque assistance relative to the estimated hip moments substantially increases the positive mechanical work delivered from the exoskeleton system 101 to the user.

Theoretical exoskeleton power and exoskeleton work are computed from published 1.25 m/s treadmill walking data. As shown, the delay 504 results in increased exoskeleton power and work applied to the subject 102.

As shown in FIG. 5B, the metabolic cost of walking of participants during level ground walking and 5° ramp ascent is measured across several magnitudes of mid-level delay. Bars represent means, and markers represent the individual results of each participant. As shown, the metabolic cost to participants was least with a delay in the range of about 100-150 ms with a minimum metabolic cost during ramp ascent at 125 ms of delay. For joints other than hip joints, different amounts of delay are contemplated. For example, a knee joint will use a delay less than the 100-150 ms delay described above. Other joints, such as at an ankle, arm, shoulder, back, or any other desired joint will likewise use different delays.

Since hip exoskeleton assistance that solely mimics the biological hip moments of the subject 102 is likely suboptimal for augmenting human energetics, the three steps of the mid-level control layer 500 is used to map hip moment estimates (208, 326) into exoskeleton assistance (216, 328).

In some implementations, the received/incoming hip moment estimates are scaled 502 by about 20% of their total magnitude. Providing an assistance magnitude at about 20% of the magnitude of the hip moment estimates has been shown to benefit the subject 102 and result in peak torque assistance close to the maximum assistance the exoskeleton system 101 could provide.

In some implementations, the estimated hip moments are delayed 504 using a first-in-first-out buffer (not shown) before being used to command the exoskeleton. Delaying the peak hip assistance timing relative to the biological hip moment provides additional metabolic benefits to the subject 102. This is due to the fact that delayed hip assistance increases the amount of positive mechanical work done by the exoskeleton system 101 since the peak assistance of a delayed controller better aligns with peak hip velocities during the stride.

In some implementations, the delayed torque values are lowpass filtered 506 using a 2nd order Butterworth filter with a 10 Hz cutoff frequency to smooth the commanded torque, imparting an additional delay (e.g., 25 ms) to the signal. The magnitudes of the delay 504 described above are inclusive of the additional delay of the lowpass filter unless otherwise specified.

It is found that delaying exoskeleton assistance by 125 ms relative to the biological hip moment could theoretically increase the positive mechanical work done by the exoskeleton during level walking by approximately 70% (FIG. 5A). In support of this delayed assistance strategy, it is found that delaying exoskeleton assistance between 100 and 150 ms is preferred by several novice and expert users during pilot testing compared to smaller delay magnitudes. In one study, user metabolic cost was not sensitive to delay magnitudes ranging from 75 to 175 ms (FIG. 5B). Specifically, the tested mid-level control delays that are tested only effected user metabolic cost by a maximum of 2.9% across level ground and 5° incline walking. Testing even smaller delays are anticipated to result in larger metabolic penalties but are omitted since they are uncomfortable to the subject 102. In various implementations, a programmed delay of 100 ms (total delay of 125 ms including the filter) is used to minimize overall delay, align with user preference, and have a small metabolic cost.

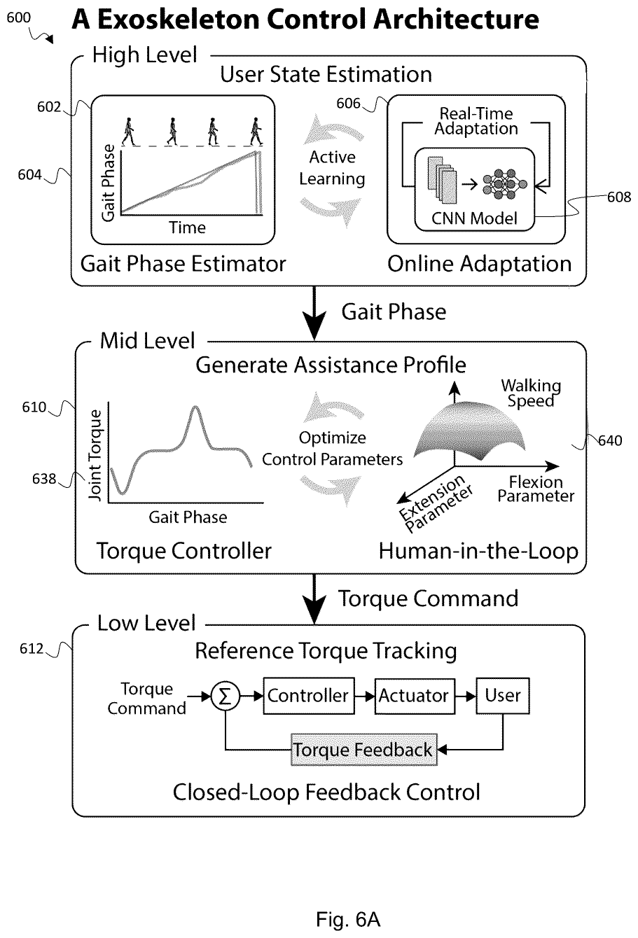

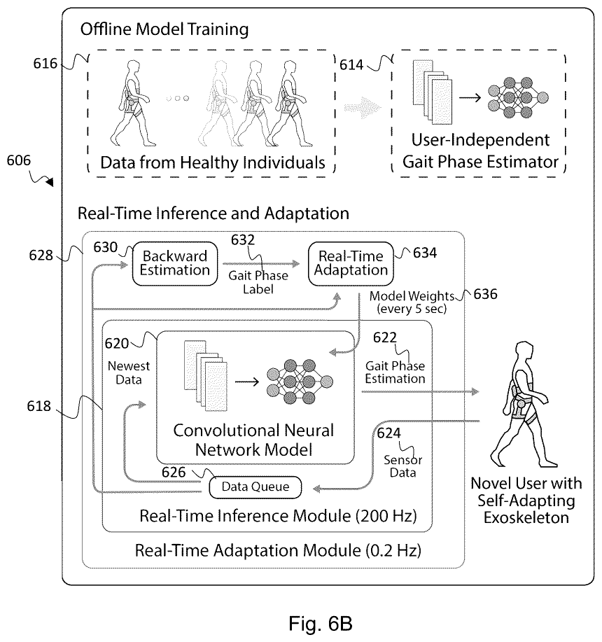

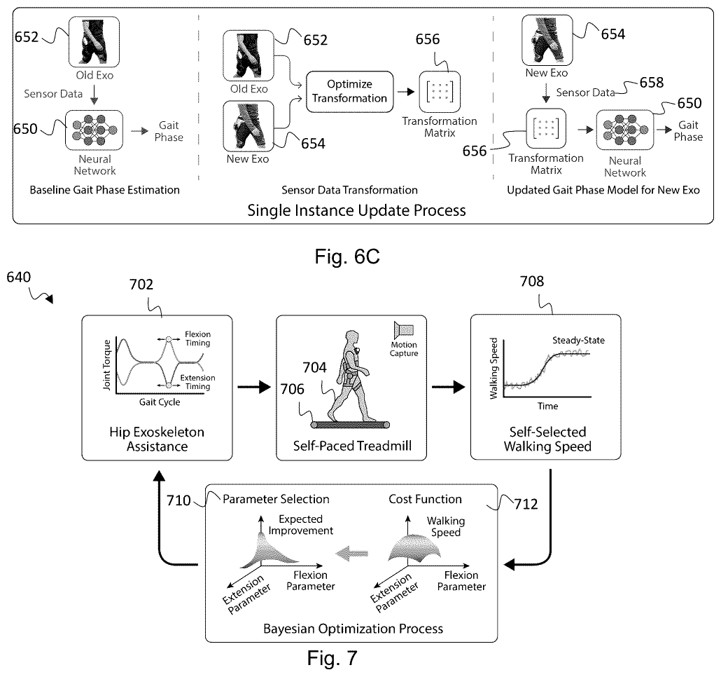

FIG. 6A is a three-tier control scheme 600 incorporating a deep learning-based gait phase estimator 602 according to various implementations of the disclosure. The three-tier control scheme 600 incorporates an online adaptation framework 606 in which the exoskeleton system 101 learns user-specific data to customize the underlying model to the individual's gait patterns. As shown in FIG. 6B, the online adaptation framework 606 enables personalization of exoskeleton assistance by adapting to both the user and the environment. Further, with reference to FIG. 6C, to deploy the deep learning system on different devices, a unique approach for transferring state estimation models across devices without the need for device-specific training data is disclosed. The disclosed approach enables the personalization of exoskeleton assistance without the need for user-specific training data, allowing the development of a generalizable control framework that can seamlessly adapt to new users, hardware, and environments.

For clinical populations such as stroke patients with gait asymmetry, relying on user-independent models for developing and transferring control frameworks to exoskeletons may not be effective. This is because the developed assistance strategy may not be suitable for individuals with motor impairments that exhibit significant gait deviations. While existing gait phase estimation approaches may work for populations with small inter-subject variations in gait patterns, they may not be applicable to clinical populations with high variability in gait patterns. No gait phase estimation-based exoskeleton adaptation framework has been developed for the stroke population or any heavily asymmetric gait population. Unlike the other exoskeleton study which requires user-specific tuning, the online adaptation framework 606 successfully estimated gait phase in this population without any manual tuning or experimenter intervention specific to in-lab environments. Thus, the online adaptation framework 606 of automatically adjusting the underlying model to a new patient can revolutionize real-world deployment in clinical populations.

As disclosed above, deep learning has enabled improved estimation of the user's state information in real-time, enabling robust control of the exoskeleton system 101 during dynamic locomotion. In the example discussed above with reference to FIGS. 1A-5B, the TCN 202 is used to generate estimated hip moments 208. In the example provided with reference to FIGS. 6A-6C, the TCN 202 is used to generate an estimated gait phase of a user. A robust deep learning-based user state estimator (e.g., TCN 202) allows for a concrete hierarchical controller where the exoskeleton assistance can dynamically adjust depending on the estimated user's state (e.g., locomotion mode, gait phase), potentially even within a single step.

It has been determined that assistance timing is a control parameter that governs the overall human-exoskeleton performance, such as reducing the metabolic cost of walking. A user state variable that directly relates to assistance timing is the user's gait phase. Gait phase corresponds to the user's joint configuration throughout the gait cycle, typically represented as a linearly increasing function from 0% to 100% throughout one gait cycle (e.g., from one heel strike to the next). That is, gait phase is a percentage representation of the user's joint configuration during a gait cycle. Gait phase-based exoskeleton control allows for a time-independent assistance paradigm, enabling a robust assistance strategy independent of the user's dynamic changes in cadence (e.g., adaptable to changes in the user's walking speed). The immediate effect of gait phase accuracy on the assistance level is substantial as it can potentially reduce the overall human-exoskeleton performance (e.g., metabolic cost). For example, a 6% gait phase shift in an ankle exoskeleton assistance timing can alter the overall metabolic cost benefit by 3.5%, indicating the significance of accurate gait phase estimation for exoskeleton control.

Previously, several groups have explored various techniques to develop a robust gait phase estimator. The most simple approach is time-based estimation, which extracts time since the most recent gait event (e.g., heel contact using a foot switch) divided by the average stride duration from the previous number of strides. Another notable method in estimating gait phase is using an adaptive oscillator, which leverages the sinusoidal nature of hip joint position during locomotion. Similarly, a holonomic phase variable can be used to represent gait phase by utilizing the user's hip joint or thigh-limb kinematics. While these heuristic methods have been adopted widely in the field, there are several limitations in deploying these models to the real world, such as the inability to accommodate multimodal locomotion, poor performance during abrupt transients, and a need for additional manual tuning for new users. Regardless, it is evident from the increase of literature studies regarding this topic that a robust, multimodal, user-independent gait phase estimator is needed.

To integrate the online adaptation framework 606 in the high-level control layer 604, a deep convolutional neural network 608 provides user-independent gait phase estimates. The deep convolutional neural network 608 is trained using a dataset from able-bodied subjects navigating through different locomotion modes (level-ground, ramp and stair ascent/decent). Estimates of the user's current gait phase are generated by the deep convolutional neural network 608 based on kinematic input from on-board exoskeleton sensors (e.g., IMUs 118 and hip actuator and encoder 114). In some implementations, the deep convolutional neural network 608 is different than the TCN 202 described above. In various implementations, the deep convolutional neural network 608 is structured such as described in I. Kang, D. D. Molinaro, S. Duggal, Y. Chen, P. Kunapuli and A. J. Young, “Real-Time Gait Phase Estimation for Robotic Hip Exoskeleton Control During Multimodal Locomotion,” IEEE Robotics and Automation Letters, vol. 6, no. 2, pp. 3491-3497, April 2021, doi: 10.1109/LRA.2021.3062562, hereby incorporated by reference.

While a standard representation of gait phase utilizes heel contact (0%) as a deterministic gait event, in the example of the exoskeleton system 101, the maximum hip extension position is used as the start of the gait cycle, which roughly corresponds to a toe-off event. This approach is selected to leverage sensors native to the exoskeleton system 101 (whereas a heel contact detection additionally uses an external foot switch). Using a local peak detection method (e.g., evaluating local maximum with or without a baseline threshold, evaluating zero crossings of the derivative of the signal, detecting gaussian peaks, or any other peak detection method), the local hip extension points from 0% to 100% are linearly interpolated.

The exoskeleton system 101 operates under the three-tier control scheme 600 where a high-level layer 604 incorporates the deep learning-based gait phase estimator 602. The high-level layer 604 is implemented to infer user and environmental states (gait phase in the example shown) that understands the user's movement and surrounding environments. An online adaptation framework 606 is integrated, where the pre-trained weights of the deep convolutional neural network 608 are fine-tuned to the user in real-time.

A mid-level control layer 610 generates torque commands based on the estimated gait phase generated by the high-level layer 604. The mid-level control layer 610 governs the exoskeleton system 101 dynamic performance using physical control laws, generating assistance envelopes throughout the gait cycle. In the mid-level layer 610, control parameters are optimized for the user using human-in-the-loop optimization to generate a desired joint torque.

A low-level layer 612 ensures that the desired joint torque is matched via standard feedback control. The low-level layer 612 ensures that the desired torque trajectory is matched using conventional closed-loop current feedback control.

In some implementations, the layers of the three-tier control scheme 600 operate at different control loop frequencies. In an example, the high-level layer 604 operates at 200 Hz for gait phase estimation and 0.2 Hz for adaptation, the mid-level control layer 610 operates at 200 Hz, and the low-level layer 612 operates at 1 kHz.

In some implementations, the computational burden (real-time inference and adaptation) of the online adaptation framework 606 in the high-level layer 604 is off-loaded to a separate on-board microprocessor, such as the co-processor 304 described above. The mid-level control layer 610 is implemented on a main processor, such as the main processor 302 described above with reference to FIG. 3. For example, the mid-level control layer 610 receives and converts the gate phase estimated by the high-level layer 604 into a torque command, such as described above with reference to 326-340. The low-level layer 612 is implemented on the motor driver of the hip actuator and encoder 114 and configured to translate the received torque command into actuator actions to supply the desired torque.

FIG. 6B is a block diagram of an online adaptation framework 606 according to various implementations of the disclosure. The online adaptation framework 606 facilitates active and online learning using live-streamed exoskeleton sensor data (e.g., from IMUs 118 and the encoder from the hip actuator and encoder 114, such as shown in FIG. 3) during locomotion.

Traditionally, to train a deep learning-based model that is intended to be deployed to a new user, a dataset including many exoskeleton users (generally from able-bodied individuals) in different environmental contexts may be needed. While this trained model may have adequate performance in a lab setting, this training pipeline has a fundamental limitation of assuming that the pre-trained model will retain its performance in a new setting (both user and environment), despite the shift in the data distribution. Furthermore, training data sets and deep learning-based user state estimators are heavily skewed towards young and healthy individuals, which does not fully represent potential exoskeleton users, such as stroke survivors.

To mitigate this limitation, the online adaptation framework 606 of a deep learning-based model (e.g., deep convolutional neural network 608, TCN 202) further reduces the user state estimation error by personalizing the underlying model parameters to accommodate user-specific gait dynamics. The online adaptation framework 606 actively learns the new user's gait dynamics in real time. Specifically, a pre-trained deep learning-based baseline gait phase estimator 614 (e.g., deep convolutional neural network 608, TCN 202) has model parameters fine-tuned by leveraging real-time streaming sensor data from the exoskeleton system 101. The online adaptation framework 606 provides the ability to translate assistance across different exoskeleton hardware, locomotion settings, and user populations—including the neurologically impaired.

The online adaptation framework 606 presents significant scientific and technological contributions to the field of robotic exoskeletons. These contributions include: 1) a fully user-independent gait phase estimation system using deep learning during multimodal locomotion, 2) a robust adaptation framework using online learning across different user populations, devices, and environmental conditions, and 3) a parallel processing architecture that enables a reliable and simultaneous adaptation and real-time inference. Furthermore, the online adaptation framework 606 fully implements an exoskeleton system that can reliably adapt to the user's gait in clinical populations. The integration of these features enables personalized exoskeleton assistance, paving the way for assistive technology to be translated into real-world usage for a diverse range of users.

The online adaptation framework 606 uses the baseline gait phase estimator 614 pre-trained in an offline setting to provide a user-independent baseline gait phase model (e.g., deep convolutional neural network 608, TCN 202). In the example shown, the baseline gait phase estimator 614 is trained from training data 616 of healthy individuals. While the baseline gait phase estimator 614 is trained with training data 616 from health people, the online adaptation framework 606 is able to adapt the baseline gait phase estimator 614 to other user populations, including the neurologically impaired.

The user-independent baseline gait phase estimator 614 is loaded in a real time inference process 618 as a current gait phase estimator 620. As discussed above with reference to FIG. 3, in some implementations, the baseline gait phase estimator 614 may be loaded as a TensorRT runtime engine. In some implementations, the real time inference process 618 may be implemented on the co-processor 304 as the inference process 312 described above.

During locomotion, the real time inference process 618 estimates the user's gait phase in real-time and supplies a gait phase estimation output 622. The gait phase estimation output 622 is supplied to the mid-level control layer 610 and processed to generate torque commands, as described in more detail below. In parallel, live-streamed sensor data 624 are queued into a fixed-sized data buffer 626. The sensor data 624 is received from the encoder of the hip actuator and encoder 114 and IMUs 118, for example. The data buffer 626 may be implemented as the input queue 336, described above with reference to FIG. 3.

In some implementations, the real time inference process 618 is deployed to an on-board microprocessor (Jetson Nano, Nvidia, CA). The current gait phase estimator 620 (e.g., deep convolutional neural network 608) runs in real-time and provides inferences at 200 Hz, equivalent to the frame rate that assistance torque profiles are generated.

Asynchronously, an adaptation process 628 uses a batch of real-time sensor data (e.g., current batch of sensor data 624 stored in the data buffer 626) and retroactively relabels the ground truth gait phase to update weights of the current gait phase estimator 620 with one epoch training.

In an implementation, at an adaptation interval (e.g., every 5 seconds) a backward labeler 630 relabels the ground truth gait phase using the hip joint position of the exoskeleton system 101, such as from the encoder of the hip actuator and encoder 114 and/or the IMUs 118. For example, the ground truth gait phase is labeled in the adaptation process 628 using a local peak detection method from the sensor data 624. At the detected local peak, the gait phase is labeled at 0% and the local hip extension points are linearly interpolated to 100% therefrom.

Afterwards, labeled sensor data 632 is used by real-time adaptation trainer 634 to update the weights of the current gait phase estimator 620 via one epoch backpropagation training. For example, the real-time adaptation trainer 634 may maintain a copy of the current gait phase estimator 620 for use for backpropagation training using the labeled sensor data 632 to generate an updated gait phase estimator 636. As discussed below, the updated gait phase estimator 636 becomes the current gait phase estimator 620 and the adaptation process 628 loops again.

In an example, at every adaptation cycle (e.g., 5 seconds), the baseline gait phase model is online adapted via single epoch training using this ground truth labeled data (e.g., Algorithm 1). To ensure that the model can adapt reliably to a small amount of data, the learning rate and the optimizer were hyperparameter swept based on a preliminary offline experiment using exoskeleton data. One feature to consider during this online adaptation is to freeze existing batch normalization layers in the architecture. Generally, adding a normalization layer to the network improves the overall performance as the layer can stabilize the input data via re-centering and re-scaling. However, if the layer is not locked during adaptation, the normalization statistics can be changed based on the buffer data, which can lead to performance degradation. After the adaptation cycle, the adapted model was transferred to the real-time inference module.

Algorithm 1: Online Adaptation for User State Estimation in Real-Time

Given: model π, initial parameters θᵢₙᵢₜ, buffer window size T, should adapt
Initialize: data = zeros(channels, T)
While True do

| | |
|---|---|
| xₜ = recv( ) | [symbol] Receive data from exoskeleton |
| data[end+1] = xₜ | [symbol] Enqueue new data |

data = data[1:end]

| | |
|---|---|
| yₜ = π_{θ}_{ᵢ}(xₜ) | [symbol] Current state estimate |
| send(yₜ) | [symbol] Update state for robot |

if xₜ contains heel strike and should adapt then

| | |
|---|---|
| online labels = label(data[tₚᵣₑᵥ: t]) | [symbol] Ground truth label new stride |
| online data = data[tₚᵣₑᵥ: t] | [symbol] Segment latest stride |
| θᵢ₊₁ = model.train(online data, online labels) | [symbol] Update model |

```
    tₚᵣₑᵥ = t
    model.save( )
  end if
end while
```

In some implementations, to ensure that there is no discontinuity in real-time gait phase estimation during the online learning process, the real time inference process 618 and adaptation process 628 operate in parallel, such as using multiprocessing features available in the co-processor 304 (e.g., Nvidia Jetson Nano). That is, in addition to the I/O process 310 and inference process 312 (e.g., real time inference process 618), the co-processor 304 may additionally implement the adaptation process 628. In some implementations, the real time inference process 618 and the adaptation process 628 operate in parallel on separate processors.

At the end of each adaptation cycle, the updated gait phase estimator 636 is passed from the adaptation process 628 to the real time inference process 618. In various implementations, the current gait phase estimator 620 as a whole is replaced at each adaptation interval. Alternatively, changed hyperparameters (e.g., weights) of the current gait phase estimator 620 are updated with values from the updated gait phase estimator 636 at each adaptation interval. Using the online adaptation framework 606, the exoskeleton system 101 dynamically learns the user's gait pattern and retains high estimation performance agnostic of the user's locomotion environment (e.g., changes in the walking speed or ambulation mode).

An advantage of the online adaptation framework 606 is its generalizability to other applications. Specifically, the personalization provided by the online adaptation framework 606 is transferrable to other high-level user state variables beyond gait phase. As long as the variable can be reliably reconstructed post-hoc, then the online adaptation framework 606 can be used. For example, the online adaptation framework 606 likewise works for walking speed and locomotion mode as well as other state variables such as ground slope estimation, thereby extending the online adaptation framework 606 to other ambulation contexts beyond level-ground walking. In the example user-independent gait phase system described above, the gait phase estimates are agnostic to locomotion modes such as stairs and ramps due to the training strategy, allowing the online adaptation framework 606 to seamlessly integrate with these other strategies. Since backward labeling in these other modes is feasible, the online adaptation framework 606 can maintain reliable adaptation performance in these settings.

During multimodal adaptation, care should be taken to ensure distributed learning across multiple types of ambulation (i.e., to prevent overlearning). One potential solution to achieve balanced learning is by binning newly acquired gait data into different classes (e.g., level-ground vs. ramp descent) and updating the current gait phase estimator 620 with a balanced gait data matrix at every update sequence. In cases where there is no recent data available for a particular class, previously acquired data can be repeated.

The online adaptation framework 606 demonstrates robustness in reliably adapting to the user's gait dynamics in various environmental settings, such as different locomotion modes and walking speeds, highlighting the system's capability to adapt to different environmental conditions. This generalizability is not limited to able-bodied subjects but also extended to clinical populations. For example, an adapted model is shown to consistently maintained high estimation performance during an outdoor overground trial of a representative stroke survivor, demonstrating resilience to changes in the walking environment (i.e., speed changes during overground locomotion).

The online adaptation framework 606 is also robust to different populations. Kinematic variations in stroke gait, such as reduced range of motion and muscle spasticity in the paretic leg, greatly degrade a static model's performance as such patterns are not captured within the original able-bodied training dataset. However, the online adaptation framework 606 not only leveraged the baseline model's gait representations but also quickly learned the new user's gait dynamics in less than a minute of walking. Therefore, the online adaptation framework 606 showcased its ability to adapt to users in clinical populations despite there being no a priori neurologically impaired individuals or user-specific tuning of the gait phase model or adaptation framework before implementing the system for stroke survivors. This generalizability indicates extends to additional target populations, such as aging gait or other neurological injuries, such as cerebral palsy.

Referring back to FIG. 6A, the mid-level control layer 610 uses a biological torque controller 638 that generates toque commands as a function of the gait phase based on an assistance profile. The biological torque controller 638 generates smooth and continuous hip flexion and extension joint torque envelopes during the phase in line with the human biological joint demand. In an example, to generate the assistance profile, a Piecewise Cubic Hermite Interpolating Polynomial spline function dependent on gait phase is used where the nodes of this curve represented different control parameters, such as assistance timing and magnitude. For the timing parameters, values shown to have the largest metabolic cost benefit in able-bodied subjects are used. During real-time exoskeleton control, the biological torque controller 638 employs the estimated gait phase to generate a target torque, and safety measures are implemented to ensure that the provided assistance is in the intended direction of the user's movement. Specifically, if an estimated gait phase value is lower than the previous estimate, the previous estimated gait phase value is repeated to prevent any reversal of the exoskeleton system 101.

To further optimize exoskeleton control parameters, a Bayesian human-in-the-loop optimization 640 is provided by the mid-level control layer 610 (described in more detail with reference to FIG. 7). Different from a conventional approach, the user's self-selected walking speed is used as the evaluating cost function. The four control parameters for optimization are bilateral peak flexion and extension assistance timing.

To ensure that the high-level gait phase adaptation and mid-level controller parameter optimization do not counteract each other, in an implementation, the online adaptation framework 606 is performed sequentially with the human-in-the-loop optimization 640. For example, first the online adaptation framework 606 is implemented for estimating a user's (e.g., a stroke survivor) gait phase using a generic assistance profile (same as the one for able-bodied subjects). Once the adaptation by the online adaptation framework 606 is completed, hyperparameters (e.g., weights) of the current gait phase estimator 620 are locked. Afterward, human-in-the-loop optimization 640 process is carried out using the current gait phase estimator 620 (e.g., adapted neural network model).

In an example, in a first iteration of the human-in-the-loop optimization 640, the general timing parameters (optimized based on able-bodied subjects) are evaluated. At the end of each iteration (one minute each), the participant's walking speed is evaluated by taking an average speed from the last 15 seconds of data. During this evaluation phase, the optimization updated the cost landscape (axis representing each control parameter) using Gaussian processes. Based on the updated cost landscape, the next sampling parameters are chosen by maximizing the expected improvement. After a predetermined number of iterations (e.g., 24), human-in-the-loop optimization 640 process is stopped, and the final optimized control parameters are selected.

FIG. 6C shows a transfer of an existing gait phase model 650 pre-trained for operation on an initial exoskeleton system 652 to a different exoskeleton system 654 using a sensor data transformation technique according to various implementations of the disclosure. This single instance update process leverages a small amount of sensor dataset from the two exoskeleton systems 652, 654 to obtain a transformation matrix 656 that can transform sensor data 658 from the different exoskeleton system 654 to a data form for the existing gait phase model 650 for the initial exoskeleton system 652.

Supervised learning-based neural networks can be a powerful tool for estimating gait parameters in exoskeleton control, such as gait phase and walking speed. However, their efficacy is often restricted to the specific device used to gather training data. Distributional shift in data is a limiting component of many supervised learning algorithms and generalization under distributional shift is a difficult problem to overcome. This greatly limits the rate of development and the accessibility of exoskeleton technology since collecting model training data is time consuming for both the users and experimenters. Theoretically, sensor data could be transformed from the coordinate system of one device to another based solely on geometric measurements of sensor orientations and positions; however in practice, this approach can be inaccurate or infeasible given three primary considerations: 1) the exact sensor placements may be unknown, especially when working with data from commercial devices; 2) the placement of the sensors may be known but unreliable (e.g., if using data from wearable sensors attached directly to the body, which are often placed based on rough estimates of anatomical landmarks); and 3) user fit often changes across devices from imperfect orthotic interfaces, causing geometric measurements of sensor placements relative to an assumed ground frame to have inaccuracies when fit to the user (e.g., the lumbar backplate mounting an IMU may pitch backward when attached to the user on one device but not on another based on its size and curvature).

Different exoskeleton designers often locate and orient sensors differently, which is a common limiting factor for deep learning-based models, making them susceptible to shifts in sensor data. Due to the limited physical measurement information provided by most commercially available devices, calculating the geometric relationship between sensors in different exoskeleton systems is impractical. As a result, changes to sensor data content historically require new labeled data to be collected to retrain state estimation models, significantly limiting the transferability and accessibility of deep learning-informed exoskeleton control across systems.

Here, a unique approach for transforming sensor data across devices is provided, eliminating the need to retrain the state estimators before deployment on a new device. Specifically, by optimizing the transformation matrix 656 using a limited set of sensor data from the two exoskeleton systems 652, 654 (e.g., only 10 strides of data from a single subject on each system), incoming sensor data 658 from the different exoskeleton system 654 is able to be transformed to a new coordinate system, enabling the transfer of the existing gait phase model 650 to the different exoskeleton system 654. This is the first time a deep learning model used for exoskeleton control has been transferred across devices, improving the accessibility of exoskeletons in the real world.

The transformation matrix 656 facilitates transformation between sensors of different exoskeleton devices or wearable sensor suites without the need for any assumptions about sensor orientation or position a priori aside from the knowledge that the sensors to be aligned are mounted on the same body segment when donned. The transformation matrix 656 is generated based on the kinematic trajectories of the exoskeleton sensor data 658 collected during two trial. Each of the trials is performed by user operation of a respective one of the exoskeleton systems 652, 654 for a predetermined period of time (e.g., 10-second-long walking trials while the user wears one of the exoskeleton systems 652, 654) to optimize a transformation between the sensors from each device. This allows the sensor calibration from one device to another to be completed in one-shot (i.e., only done one time for a new exoskeleton) and did not require the subject to assume any specific calibration poses aside from their normal gait, maximizing the similarities in the sensor data between the two trials. By applying this transformation to the incoming data stream, user state estimators (e.g., a gait phase estimator) can be transferred across devices without the need to retrain the model to accommodate the sensor locations of the new device (i.e., without needing to collect a device-specific labeled dataset).

In the example provided here the sensor data transformation is applied to exoskeletons targeting the same joint. To expand this framework to a new joint, a new set of baseline training data needs to be collected one time, but then similar transformations can be created to transfer state estimation models (e.g., hip moment estimator, gait phase estimator, etc.) between hardware targeting assistance across the new joint. Regarding other joints, one scenario is the use case of multi-joint exoskeleton control (e.g., hip and knee joints). In this case, the performance of the gait phase estimator model disclosed herein will not be affected unless the assistance provided at the other joint (e.g., knee) significantly alters the user's hip kinematics. However, such cases are rare, because excessive assistance that modifies the user's nominal joint kinematics can have a negative impact on the overall human-exoskeleton performance. Since the primary objective of exoskeleton control is to provide assistance that enhances human outcome measure, excessive assistance is unlikely to occur. Therefore, the baseline gait phase model performance is maintained even if an additional degree-of-freedom is added to the exoskeleton structure.

In an example, the existing gait phase model 650 (e.g., a static gait phase estimator) trained on data from one device (EXO1), such as the initial exoskeleton system 652 is transferred such that it is compatible with a completely new device (EXO2), such as the different exoskeleton system 654.

Specifically, a rotation matrix and position vector (e.g., transformation matrix 656) is optimized to map incoming measurements from a pelvis IMU of the EXO2 (not shown) into the EXO1 coordinate system before inputting the transformed sensor data into the existing gait phase model 650. While this examples uses pelvis-mounted IMU data for a gait phase estimator, the same approach applies to models trained to estimate alternative gait states or to use other sensors by modifying the optimized variables.

To optimize the transformation of IMU data from EXO2 into the coordinate system of EXO1, the optimization approach uses data sampled over 10 consecutive strides from each exoskeleton. The resulting EXO1 and EXO2 data are aligned in time post hoc, such that they are of equal length N. The accelerometer (A) and gyroscope (G) data measured from the IMUs of EXO1 and EXO2 (i.e., A_{E1}, A_{E2}, G_{E1}, G_{E2}) is then extracted from the data as,

$$\begin{matrix}A = [ \begin{matrix}{a}_{1 , 1} & {a}_{1 , 2} & ⋯ & {a}_{1 , N} \\ {a}_{2 , 1} & {a}_{2 , 2} & ⋯ & {a}_{2 , N} \\ {a}_{3 , 1} & {a}_{3 , 2} & ⋯ & {a}_{3 , N}\end{matrix} ] , & ( 4 ) \\ G = [ \begin{matrix}{g}_{1 , 1} & {g}_{1 , 2} & ⋯ & {g}_{1 , N} \\ {g}_{2 , 1} & {g}_{2 , 2} & ⋯ & {g}_{2 , N} \\ {g}_{3 , 1} & {g}_{3 , 2} & ⋯ & {g}_{3 , N}\end{matrix} ] , & ( 5 )\end{matrix}$$

such that the rows of A and G represented the x-, y-, and z-axes of the sensors, respectively. Since the relative change in orientation and position between the IMUs of EXO1 and EXO2 are unknown due to differences in user fit between the devices, a rotation matrix (^{E1}\hat{R}*_{E2}) and position vector (^{E1}\hat{p}*_{E2E1}), further denoted as \hat{R}* and \hat{p}*, are optimized to transform the IMU data measured by EXO2 (A_{E2} and G_{E2}) into the EXO1 coordinate system (Â_{E1} and Ĝ_{E1}). Specifically, the vector Z of dimension [symbol] ^{6×1} is defined, comprised of three Euler angles and the position vector \hat{p}

$$Z = [ \begin{matrix}\hat{θ} \\ \hat{ϕ} \\ \hat{ψ} \\ \hat{p}\end{matrix} ] , \qquad ( 6 )$$

such that,

\hat{R}(θ,ϕ,ψ)=R_{z}(\hat{ψ})*R_{y}(\hat{ϕ})*Rₓ(\hat{θ}). (7)

The optimized vector Z* is then computed as,

$${Z}^{*} = [ \begin{matrix}{\hat{θ}}^{*} \\ {\hat{ϕ}}^{*} \\ {\hat{ψ}}^{*} \\ {\hat{p}}^{*}\end{matrix} ] = {argmin}_{\hat{θ} , \hat{ϕ} , \hat{ψ} , \hat{p}} ( \sum \tilde{G} ( \hat{θ} , \hat{ϕ} , \hat{ψ} ) + \sum \tilde{A} ( \hat{θ} , \hat{ϕ} , \hat{ψ} \hat{p} ) ) , \qquad ( 8 )$$

where \tilde{G} and Ã represent the mean squared error between the accelerometer and gyroscope data of EXO1 and the transformed data of EXO2. Thus,

$$\tilde{G} = [ \begin{matrix}{\tilde{g}}_{1} \\ {\tilde{g}}_{2} \\ {\tilde{g}}_{3}\end{matrix} ] , \qquad ( 9 )$$

where each element (\tilde{g}ᵢ) of \tilde{G} was computed as,

$$\begin{matrix}{\tilde{g}}_{i} = \frac{1}{N} {\sum }_{j = 1}^{N} {( {g}_{i , j} - {\hat{g}}_{i , j} )}^{2} ∀ {g}_{i , j} ∈ {G}_{E 1 , i} , {\hat{j}}_{i , j} ∈ {\hat{G}}_{E 1 , i} , \\ and , & ( 10 ) \\ \tilde{A} = [ \begin{matrix}{\tilde{a}}_{1} \\ {\tilde{a}}_{2} \\ {\tilde{a}}_{3}\end{matrix} ] , & ( 11 )\end{matrix}$$

where each element (\tilde{α}ᵢ) of A is computed as

$${\tilde{a}}_{i} = \frac{1}{N} {\sum }_{j = 1}^{N} {( {a}_{i , j} - {\hat{a}}_{i , j} )}^{2} ∀ {a}_{i , j} ∈ {A}_{E 1 , i} , ∀ {\hat{a}}_{i , j} ∈ {\hat{A}}_{E 1 , i} . \qquad ( 12 )$$

It is assumed that EXO1 and EXO2 are fixed to the user's pelvis, allowing Ĝ_{E1} and Â_{E1} to be computed from rigid body kinematics as

Ĝ_{E1}=\hat{R}*G_{E2}, (13)

Â_{E1}=A_{E2}+(\hat{α}_{E1}×\hat{p})+(Ĝ_{E1}×(Ĝ_{E1}×\hat{p})), (14)

where \hat{α}_{E1} is the angular acceleration of the EXO2 IMU computed in the EXO1 coordinate system as

$${\hat{α}}_{E 1} = \frac{d}{dt} {\hat{G}}_{E 1} . \qquad ( 15 )$$

Thus, after optimizing \hat{R}* and \hat{p}*, incoming IMU data from EXO2 can be quickly transformed into the EXO1 coordinate system using Equations (13) and (14) before being input to the existing gait phase model 650 to estimate the user's gait phase.

FIG. 7 is a human-in-the-loop optimization of exoskeleton control parameters 702 of the mid-level control layer 610 according to various implementations of the disclosure. The user's self-selected walking speed is used as the evaluating cost function. In an example, the exoskeleton control parameters 702 include four control parameters for optimization, including bilateral peak flexion and extension assistance timing.

Optimal assistance strategy (e.g., magnitude and timing) for exoskeleton systems varies across users. For able-bodied subjects, exoskeleton performance benefit can range up to, in the context of the metabolic cost of walking, 18% or more if the selected assistance profile is suboptimal. Recently, the field has started to adopt an optimization scheme in exploring optimal exoskeleton assistance levels for stroke gait. Human-in-the-loop optimization is a popular, yet powerful, method that directly integrates the user's feedback into the control parameter optimization process. Completing the personalization exoskeleton framework for using human-in-the-loop optimization includes mid-level control parameter optimization, such as described above with reference to mid-level layer 610.

The human-in-the-loop optimization 640 includes determining the objective function (metabolic cost vs. walking speed) and optimizing other control parameters (assistance magnitude vs. timing). The high-level online adaptation framework 606 and mid-level control layer 610 controller optimization contribute to the same goal of personalizing the exoskeleton system to a new user. These two layers, interlinked and dependent on one another, create a fully stacked personalization framework, significantly contributing to maximizing the user's gait performance as the system organically adapts and learns the user's gait pattern over time.

Human-in-the-loop optimization 640 of exoskeleton control parameters 702 uses the user's self-selected walking speed 704. To optimize exoskeleton control parameters 702 for a specific user, a Bayesian-based human-in-the-loop optimization 640 is implemented. A user (e.g., stroke survivor) walks on a motion capture-based self-paced treadmill 706 while wearing an exoskeleton (e.g., exoskeleton system 101). At each iteration (e.g., predetermined intervals), the subject's self-selected walking speed 704 is evaluated (e.g., average walking speed of the last 15 seconds). In various implementations, the interval is sufficiently long to allow the user to reach a steady state walking speed 708. Based on a determination of the self-selected speed, the human-in-the-loop optimization 640 updates a cost landscape 712 and chooses the next sampling parameters 710 by maximizing the expected improvement. After a predetermined number of iterations (e.g., 24 iterations) the human-in-the-loop optimization 640 is stopped and final optimized control parameters are selected.

### Experimental Results

Unified Exoskeleton Control

We measured the effect of the unified controller on user metabolic cost relative to not wearing the exoskeleton (No Exo) and to wearing the exoskeleton without assistance (Zero Torque) during both level ground walking and ramp ascent (i.e., during ambulation modes requiring large amounts of work from the hip). User metabolic cost (i.e., the rate of whole-body human energy expenditure used to move) has become the gold-standard for evaluating exoskeleton technology on human effort (1) given its objectivity, requiring decades of exoskeleton research before devices started to break the “metabolic cost barrier”. In this study, we hypothesized that because our unified controller naturally adapts exoskeleton assistance with changes in user joint dynamics, our controller would reduce user metabolic cost during both level ground and incline walking compared to Zero Torque (H1). Further, given the adaptive assistance of our unified controller and the lightweight design of our custom hip exoskeleton, we hypothesized that using the unified controller would also reduce users metabolic cost beyond that of No Exo during both level ground and incline walking (H2), breaking the metabolic cost barrier across multiple ambulation modes. To further decompose the energetic effects of our system on the user, we also quantified the impact of the unified controller on the user's lower-limb positive joint work compared to No Exo. We hypothesized that the improvements in metabolic cost would be reflected in lower-limb joint work as users would substitute the joint work required from their hip joints with that of the exoskeleton, reducing the overall positive mechanical work of the lower limb compared to No Exo (H3).

While testing user outcomes provides insights into the human-exoskeleton response, it is also useful to quantify the accuracy of any high-level state estimators within the controller to validate the system performance across conditions. Though offline analyses are valuable for initial development and validation, high-level state estimators should be evaluated online (i.e., when integrated in the exoskeleton controller) since coupling the outputs of the estimator with the resulting human-exoskeleton dynamics can lead to error propagation that cannot be detected in offline analyses. In this study, we benchmarked the online accuracy of our deep learning-based hip moment estimator (e.g., TCN 202) during level ground walking, ramp ascent and descent, and stair ascent and descent (35 total conditions of varying walking speeds, ground slopes, and stair heights), as well as during neutral standing, during transitions between walking and standing, and during conditions withheld from the training set to simulate real-world conditions. Our approach was benchmarked against a baseline method designed to emulate bio-inspired exoskeleton controllers from previous studies, which included predicting the average hip moment profile computed a priori from the training set for each ambulation mode. Since the TCN 202 should capture variations in the hip moment with changes in individual user, with changes in ambulation intensity (i.e., walking speed, ramp slope, and stair height), and with changes due to stride-to-stride variability, we expected the TCN 202 to outperform the Baseline method, even when implemented in its best case (i.e., the Baseline method assumed a perfectly accurate ambulation mode and gait phase oracle). Specifically, we hypothesized that the TCN would reduce the root-mean-square error (RMSE) and increase the R² of the hip moment estimates compared to the Baseline method (H4 and H5, respectively).

This work presents a first-of-its-kind unified exoskeleton controller powered by a deep learning model to completely reparametrize exoskeleton control. Our approach did not require sensors other than those embedded on the device or any subject-specific calibration. As a result, our approach yielded a strategy that seamlessly adapted assistance with changes across exoskeleton users, ambulation modes, and ambulation intensities without the need for any tuning or experimenter intervention. Using this control framework, we measured significant improvements in user mobility metrics (i.e., metabolic cost and lower-limb joint work) during both level ground and incline walking, demonstrating the viability of our approach for augmenting multimodal ambulation. Further, we found that the TCN 202 that powered the unified controller maintained high accuracy when implemented online, outperforming the best-case Baseline method.

Augmenting Human Energetics During Level Ground Walking and Ramp Ascent

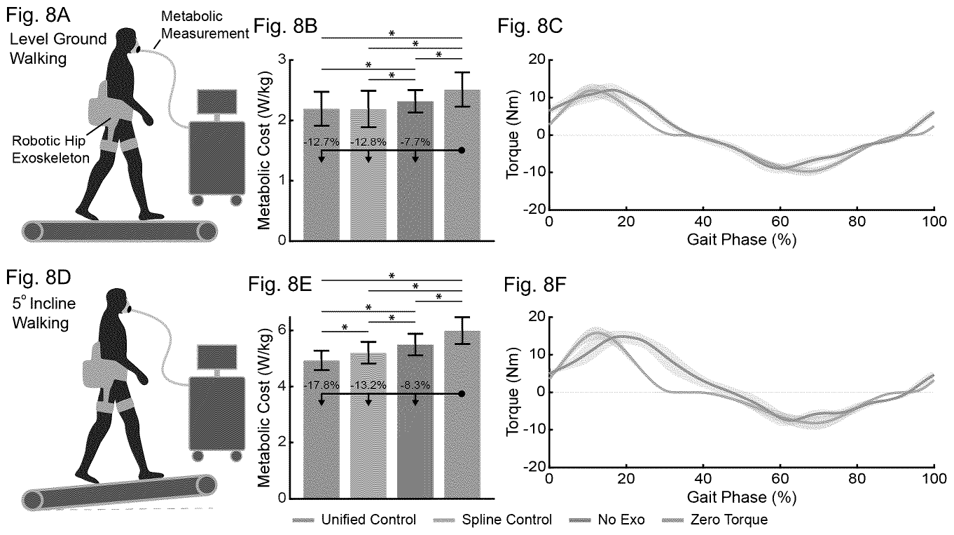

We measured the metabolic cost of walking for 10 able-body participants (participant details in Table 2) during level ground walking and 5° ramp ascent at 1.25 m/s under four assistance conditions: 1) while wearing the exoskeleton which provided assistance using our unified joint moment controller (Unified Control); 2) while wearing the exoskeleton which provided assistance based on a generic spline from human-in-the-loop optimization (Spline Control); 3) while not wearing the exoskeleton (No Exo); and 4) while wearing the exoskeleton which actively commanded zero torque (Zero Torque) (FIGS. 8A and 8D). During level walking, Unified Control significantly reduced the participants' metabolic cost by 0.12±0.13 W/kg (5.4±5.6%) compared to No Exo (mult. comparisons, P=0.0219, n=10) and by 0.32±0.07 W/kg (12.7±2.8%) compared to Zero Torque (mult. comparisons, P=6×10-8, n=10), shown in FIG. 8B. Further, during incline walking, Unified Control resulted in significant metabolic cost reductions of 0.57±0.24 W/kg (10.3±4.4%) compared to No Exo (mult. comparisons, P=4×10-8, n=10) and of 1.06±0.31 W/kg (17.8±5.1%) compared to Zero Torque (mult. comparisons, P=3×10-14, n=10), shown in FIG. 8E. These results confirm our hypotheses (H1 and H2), demonstrating that the unified controller provided beneficial exoskeleton assistance during both ambulation modes compared to No Exo and Zero Torque. While the magnitude of metabolic cost reductions of our controller was similar to those of previous autonomous exoskeleton studies, this is the first hip exoskeleton to yield significant reductions in metabolic cost during both level ground and incline walking without any manual modifications to the controller by the experimenter or participant between modes (e.g., manually switching the controller from level ground mode to incline mode).

Relevant information about each participant in this study is provided in Table 2.

TABLE 2

| | | | | |
|---|---|---|---|---|
| Participant # | Gender | Height (m) | Body Mass (kg) | Age (years) |

Experimental Phase 1

| | | | | |
|---|---|---|---|---|
| AB01 | Male | 1.73 | 73.1 | 30 |
| AB02 | Female | 1.75 | 73.8 | 20 |
| AB03 | Male | 1.79 | 66.2 | 20 |
| AB04 | Female | 1.67 | 62.3 | 23 |
| AB05 | Female | 1.80 | 57.0 | 20 |
| AB06 | Male | 1.82 | 84.0 | 22 |
| AB07 | Female | 1.62 | 64.1 | 20 |
| AB08 | Male | 1.76 | 73.4 | 21 |
| AB09 | Male | 1.80 | 80.1 | 26 |
| Mean ± SD | 5 Males, | 1.75 ± 0.07 | 70.4 ± 8.7 s | 22 ± 3 |
| | 4 Females | | | |

Experimental Phase 2

| | | | | |
|---|---|---|---|---|
| AB10 | Male | 1.77 | 66.1 | 29 |
| AB11 | Male | 1.83 | 71.2 | 23 |
| AB12 | Male | 1.68 | 64.1 | 21 |
| AB13 | Male | 1.70 | 69.6 | 28 |
| AB14 | Female | 1.67 | 64.0 | 23 |
| Mean ± SD | 4 Males, | 1.73 ± 0.07 | 67.0 ± 3.3 | 25 ± 3 |
| | 1 Female | | | |

Experimental Phase 3

| | | | | |
|---|---|---|---|---|
| AB15 | Female | 1.66 | 51.2 | 24 |
| AB16 | Male | 1.74 | 73.8 | 22 |
| AB17 | Male | 1.75 | 80.1 | 20 |
| AB18 | Male | 1.85 | 90.8 | 25 |
| AB19 | Male | 1.75 | 78.6 | 23 |
| AB20 | Male | 1.83 | 90.5 | 25 |
| AB21 | Female | 1.60 | 65.0 | 22 |
| AB22 | Male | 1.74 | 60.7 | 31 |
| AB23 | Female | 1.73 | 70.9 | 24 |
| AB24 | Male | 1.80 | 78.6 | 20 |
| Mean ± SD | 7 Males, | 1.75 ± 0.07 | 74.0 ± 12.6 | 24 ± 3 |
| | 3 Females | | | |

Experimental Phase 4

| | | | | |
|---|---|---|---|---|
| AB25 | Male | 1.83 | 92.9 | 18 |
| AB26 | Male | 1.7 | 71.8 | 19 |
| AB27 | Male | 1.7 | 82.5 | 26 |
| AB28 | Male | 1.7 | 55.7 | 22 |
| AB29 | Male | 1.63 | 66.2 | 25 |
| AB30 | Female | 1.57 | 63.9 | 31 |
| AB31 | Male | 1.83 | 87.5 | 30 |
| AB32 | Female | 1.77 | 67.7 | 22 |
| AB33 | Male | 1.65 | 61.2 | 34 |
| AB34 | Male | 1.75 | 83.4 | 26 |
| Mean ± SD | 8 Males, | 1.71 ± 0.08 | 73.3 ± 12.5 | 25 ± 5 |
| | 2 Females | | | |

Additionally, averaging personalized assistance splines across able-body participants can yield generic assistance trajectories that are effective for reducing human effort. Thus, comparing the user's metabolic cost when walking with the unified controller to that of Spline Control, provided an additional point of reference to determine the effectiveness of our approach. We found that the unified joint moment controller had no significant difference in user metabolic cost during level walking but significantly reduced user metabolic cost by 0.27±0.15 W/kg (5.3±2.8%) during ramp ascent (mult. comparison, P=0.0025, n=10) when compared to Spline Control. While initially surprising that Unified Control outperformed the previously optimized Spline Control during ramp ascent, it is likely this result is due to limitations in human-in-the-loop optimization. Specifically, the splines used in this study were optimized on a different device, with differing torque capabilities and actuator dynamics (i.e., cable-driven actuators); it is possible that this optimization process would have to be repeated with each new device to maintain energetic benefits. Additionally, it is possible that the optimized assistance profiles from human-in-the-loop optimization may not represent the global optimum, despite often requiring tens of minutes or even hours of walking to converge. Nevertheless, the result of our metabolic tests confirmed that our unified control approach both autonomously modulated exoskeleton assistance across modes and generated exoskeleton assistance that was as beneficial or better than the previous state-of-the-art in subject-independent, “off-the-shelf” control.

As shown in FIG. 8A, each participant's metabolic cost was measured during level walking at 1.25 m/s while wearing the exoskeleton with the unified joint moment controller (Unified Control), while wearing the exoskeleton with a spline-based controller that provided assistance based on a function of gait phase (Spline Control), while not wearing the exoskeleton (No Exo), and while wearing the exoskeleton as it commanded zero torque (Zero Torque). As shown in FIG. 8B, the resulting metabolic cost of each condition during level ground walking is shown, and the percent reduction of each condition relative to Zero Torque is depicted with the arrows. As shown in FIG. 8C, the commanded exoskeleton torque averaged across participants is shown as a function of gait phase for Unified Control and Spline Control. As shown in FIG. 8D, each participant's metabolic cost was also measured during 5° incline walking at 1.25 m/s. As shown in FIG. 8E, the average metabolic cost resulting from the incline tests are shown. As shown in FIG. 8F, the average commanded exoskeleton torques during incline walking are shown for Unified Control and Spline Control. Gait cycles were segmented by heel strike and hip extension is positive. Bars and curves represent means, error bars and shaded regions represent ±1 standard deviation about the mean, and asterisks indicate statistical significance (P<0.05).

Reducing Joint-Level Positive Mechanical Work of the User

To analyze the effect of our unified controller at the joint-level, lower-limb mechanical work was measured across 10 participants under the Unified Control and No Exo conditions during level ground and 5° incline walking at 1.25 m/s. The total positive mechanical work of the user's lower-limb joints (i.e., sum of hip, knee, and ankle positive work in the sagittal plane) was significantly lower with the Unified Control assistance compared to No Exo during both level ground (change of 0.16±0.05 J/kg [17.5±5.7%]; paired t-test, P=5×10-6, n=10) and incline walking (change of 0.16±0.08 J/kg [11.7±6.2%]; paired t-test, P=2×10-4, n=10), confirming our hypothesis (H3). Interestingly, we found larger relative reductions in metabolic cost between Unified Control and No Exo during incline walking but larger reductions in positive lower-limb joint work in level ground walking. This suggests the additional benefits in metabolic cost during incline walking may come from improved muscle-level efficiencies or reduced co-contraction when wearing the device, hinting that future generations of exoskeleton controllers may benefit even more by accounting for the user's underlying muscle dynamics.

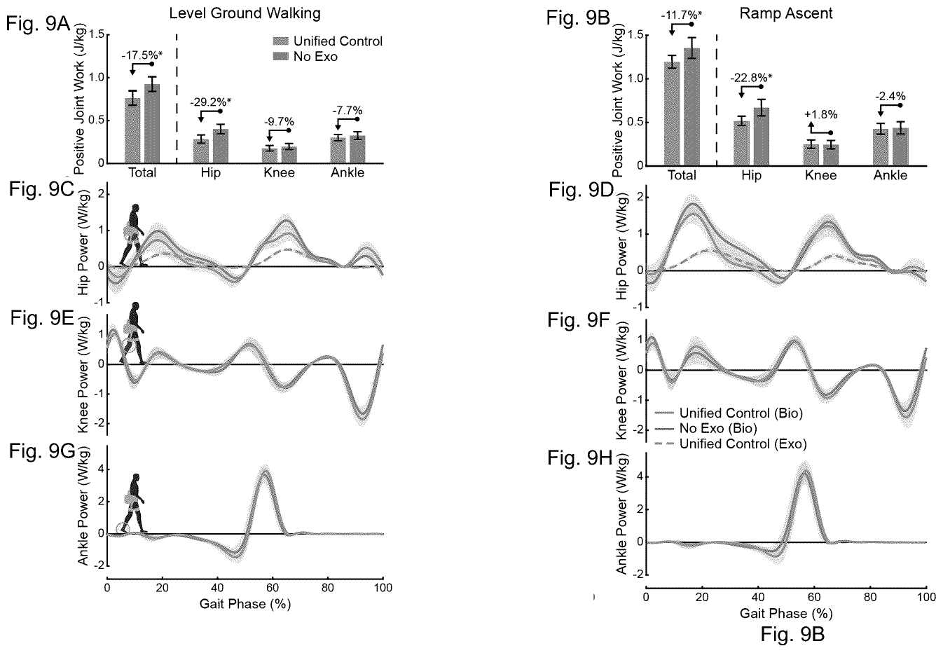

The per-stride, positive biological joint work of the hip, knee, ankle, and sum of all three joints (i.e., total) during level ground is shown in FIG. 9A and during 5° incline walking is shown in FIG. 9B. Joint work was measured while participants wore the exoskeleton, which provided assistance using the unified joint moment controller (Unified Control) and while participants did not wear the exoskeleton (No Exo). The average power of the biological hip and of the exoskeleton are shown during level ground in FIG. 9C and incline walking in FIG. 9D. Biological hip power during the Unified Control condition was computed by first subtracting the exoskeleton torque from the total hip moment. The average knee power is shown during level ground in FIG. 9E and incline walking in FIG. 9F. Additionally, the average ankle power during level ground is shown in FIG. 9G and during incline walking is shown in FIG. 9H. Gait cycles were segmented by heel strike. All results were computed with respect to the sagittal plane. Bars and curves represent means, error bars and shaded regions represent ±1 standard deviation about the mean, and asterisks indicate statistical significance (P<0.05).

At the individual joint level, we found that Unified Control significantly reduced the positive mechanical work of the hip joint by 0.12±0.04 J/kg (29.2±10.9%) during level ground walking (mult. comparisons, P=2×10-8, n=10) and by 0.15±0.08 J/kg (22.8±12.2%) during incline walking (mult. comparisons, P=8×10-6, n=10) compared to No Exo. Interestingly, by delaying the exoskeleton assistance relative to the instantaneous hip moment estimate in the mid-level control layer, the unified joint moment controller provided peak assistance torque during the periods of the stride with high hip velocities, increasing the total amount of positive mechanical work provided by the exoskeleton. Thus, the unified controller was able to reduce the positive work at the hip joint by more than 20% despite only scaling the assistance torque to 20% of the total estimated hip moment. This result demonstrates that additional energetic benefits can be achieved simply by correctly timing hip exoskeleton assistance relative to the biological joint moment.

Validating Temporal Convolutional Network Accuracy In-the-Loop

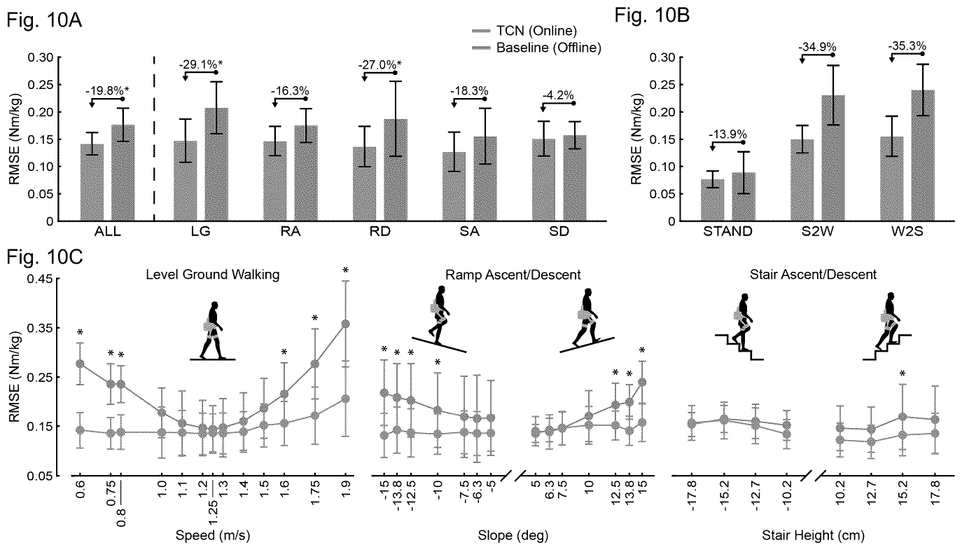

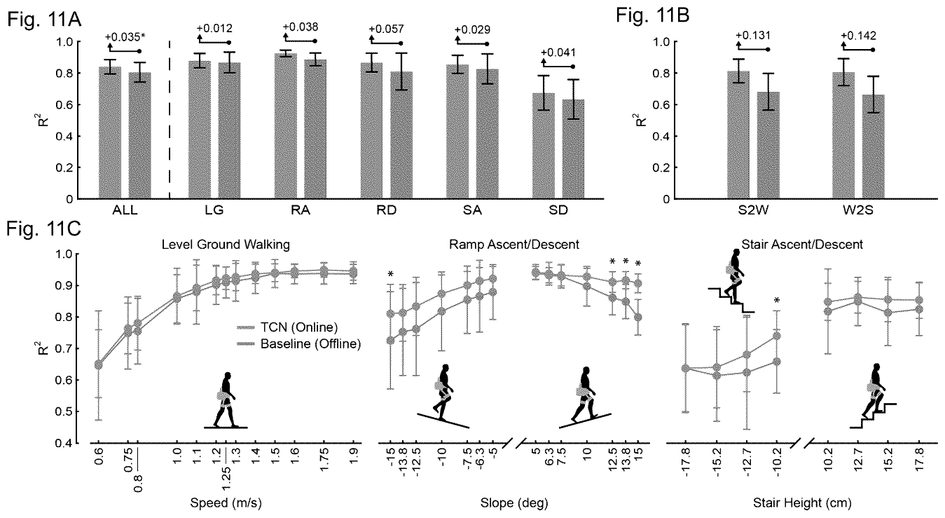

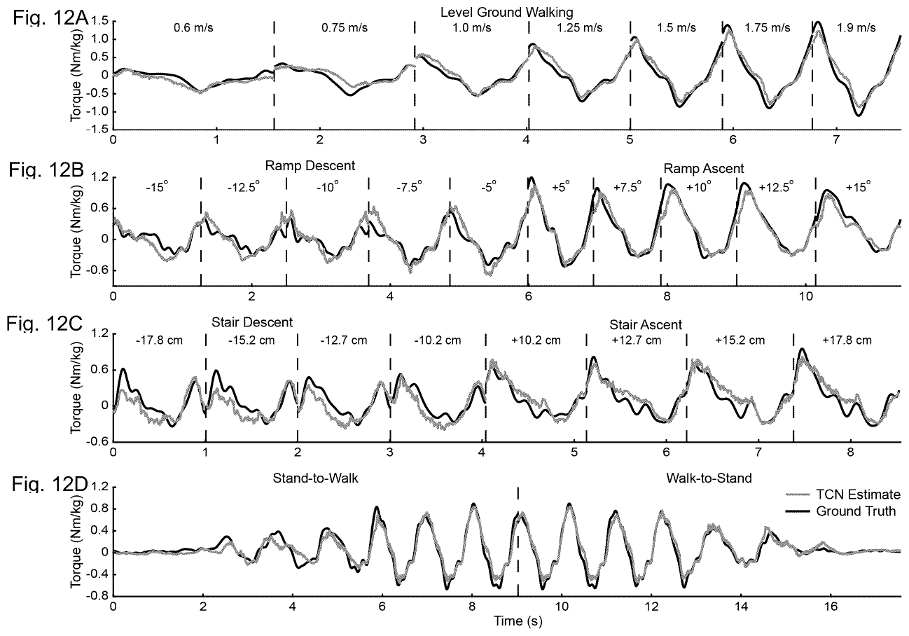

Hip moment estimation performance was evaluated online (i.e., when implemented in the exoskeleton control loop) during 35 conditions consisting of level ground walking, ramp ascent/descent, and stair ascent/descent. To best emulate real-world scenarios, the validation conditions including walking speeds ranging from 0.6 to 1.9 m/s, inclines and declines ranging from −15° to 15°, and stair spanning the range of ADA compliant step heights of 10.2 to 17.8 cm (4 to 7 inches). The RMSE (FIGS. 10A-10C) and R² (FIGS. 11A-11C) of the TCN estimates were compared to those of the Baseline method, which estimated hip moments based on the average hip moment for each ambulation mode computed from the training set. As hypothesized in H4, the overall RMSE of the TCN averaged across the five ambulation modes was 0.142±0.021 Nm/kg, which was significantly lower than the Baseline method (change of 0.035±0.016 Nm/kg [19.8±9.3%]; paired t-test, P=9×10-5, n=10), with representative strides of the TCN estimates shown in FIGS. 12A-12D. Significant reductions in RMSE within modes were also found for the level ground (change of 0.060±0.022 Nm/kg [29.1±10.5%]; mult. comparisons, P=0.0012, n=10) and ramp descent conditions (change of 0.051±0.035 Nm/kg [27.0±18.8%]; mult. comparisons, P=0.0092, n=10). Additionally, the resulting overall R² of the TCN was 0.840±0.045, which was significantly higher than that of the Baseline method (change of 0.035±0.034 [4.4±4.2%]; paired t-test, P=0.0088, n=10) as hypothesized in H5. Thus, the TCN 202 significantly outperformed the Baseline method in estimating the user's hip moments, even though the Baseline method in this study assumed a perfectly accurate ambulation mode classifier and gait phase estimator. In practice, mode classifiers and gait phase estimators also incur error, further increasing the differences between the TCN and Baseline methods. This indicates that the TCN 202 not only learned to accurately estimate hip moments as ambulation mode and gait phase varied, but also learned the unique differences in hip moments across participants and ambulation intensities (i.e., walking speed, ground slope, and stair height).

FIG. 10A shows the average root-mean-square error (RMSE) of the temporal convolutional network (TCN) 202 compared to the RMSE of the Baseline method during level ground walking (LG), ramp ascent (RA), ramp descent (RD), stair ascent (SA), and stair descent (SD) walking. The average RMSE across the five ambulation modes (ALL) is also shown (n=10). FIG. 10B shows the average RMSE of the TCN 202 during neutral standing (STAND), stand-to-walk transitions (S2W), and walk-to-stand transitions (W2S) relative to the Baseline method (n=5, no statistical tests performed). FIG. 10C shows the average RMSE of the TCN and Baseline method for each test condition within the LG, RA, RD, SA, and SD ambulation modes. All TCN results are based on online estimates used in the control loop. All Baseline results were computed post hoc using the same data. Bars and markers represent means, error bars represent ±1 standard deviation about the mean, and asterisks indicate statistical significance (P<0.05).

FIG. 11A shows the average R² of the temporal convolutional network (TCN) 202 compared to that of the Baseline method during level ground walking (LG), ramp ascent (RA), ramp descent (RD), stair ascent (SA), and stair descent (SD) walking. The average R² across the five ambulation modes (ALL) is also shown (n=10). FIG. 11B shows the average R² of the TCN 202 during stand-to-walk (S2W) and walk-to-stand transitions (W2S) relative to the Baseline method (n=5). FIG. 11C shows the average R² of the TCN and Baseline method for each test condition within the LG, RA, RD, SA, and SD ambulation modes. All TCN results are based on online estimates that were used in the control loop. All Baseline results were computed post hoc using the same data. Bars and markers represent means, error bars represent ±1 standard deviation about the mean, and asterisks indicate statistical significance (P<0.05).

FIGS. 12A-12D show representative examples of hip moments estimated by the temporal convolutional network (TCN) 202 and the corresponding ground truth values. FIG. 12A shows representative strides from six of the 13 total level ground walking conditions (average RMSE of the depicted strides is 0.137 Nm/kg). FIG. 12B shows representative strides from 10 of the 14 total inclines and declines (average RSME of the depicted strides is 0.138 Nm/kg). FIG. 12C shows representative strides of stair ascent and descent at each of the tested stair heights (average RMSE of the depicted strides is 0.137 Nm/kg). FIG. 12D shows a representative time series of a stand-to-walk and walk-to-stand transition (average RMSE of the depicted strides is 0.096 Nm/kg). The stand-to-walk and walk-to-stand trials were extended from their original segmentation for visual purposes (details for the default segmentation of the transition trials are provided in the materials and methods). Each representative trial was selected based on the average RMSE for each condition. Within each ambulation mode, the depicted strides are from the same participant. Gait cycles were segmented by heel strike and hip extension is positive.

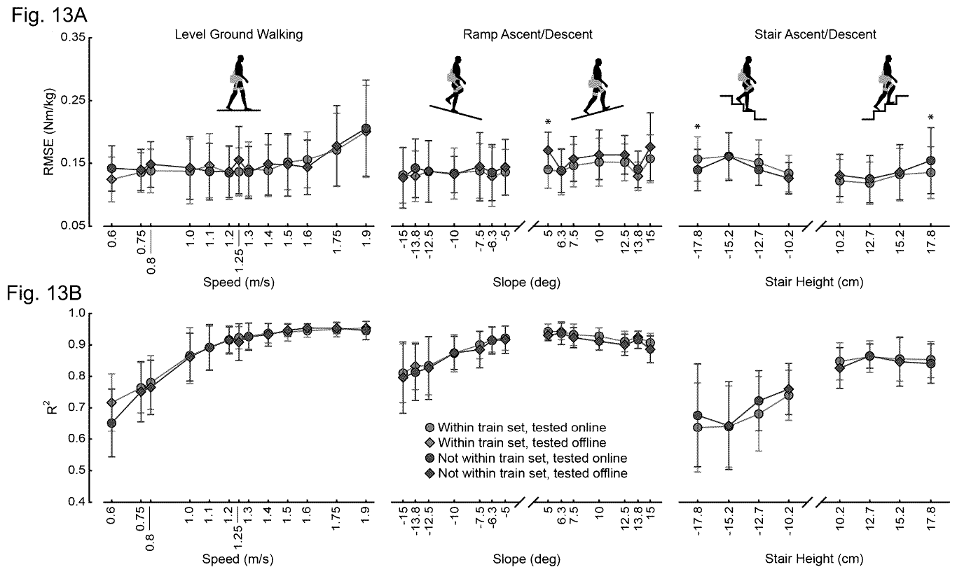

FIG. 13A shows the temporal convolutional network (TCN) 202 used to estimate user hip moments was tested across several ambulation modes and intensities. The TCN 202 was trained and tested under two conditions: 1) tested on each ambulation mode and intensity when it was included in the training set and 2) tested on each ambulation mode and intensity when it was not included in the training set. Due to experimental time constraints, each condition was either evaluated online (i.e., when actively deployed on the hip exoskeleton and used in the control loop) or offline (i.e., tested post hoc on the same data). The results of the TCN 202 under each condition are shown using RMSE in FIG. 13A and R² in FIG. 13B. In each condition, the model was tested on data from participants that were not included in the training set (i.e., subject-independent evaluation). Markers represent means, error bars represent ±1 standard deviation about the mean, and asterisks indicate statistical significance (P<0.05).

While multiple studies have proposed methods for estimating lower-limb joint moments using solely wearable sensors, this is the first to validate the accuracy of a joint moment estimator across multiple ambulation modes when implemented in the control loop of an exoskeleton (i.e., online). Validating these systems online is significant, as previous studies validating online classifier performance have shown larger online model errors (despite low offline errors) as incorrect class estimates can feedback into the controller, further propagating estimator error and controller instability. We found that when integrated into the exoskeleton controller, our deep learning-based hip moment estimator obtained similar or even better performance compared to previous state-of-the-art hip moment estimators that have been evaluated offline using physics- and data-driven approaches. Thus, by relying on a single regression model for high-level state estimation, the propagation of error from online estimator-controller dynamics was mitigated, increasing the reliability of the system.

When comparing the TCN and Baseline methods within ambulation modes, we found that the TCN significantly outperformed the Baseline method in several conditions (FIG. 10C and FIG. 11C), often when nearing the extrema within each mode (complete p-values available in the supplementary data). Further, we found little impact on model performance when the TCN was tested on novel conditions not included in the training set, with significant impacts on model performance in three of the 35 total conditions (details and results provided in reference to FIGS. 13A-13B). These results demonstrate that our deep learning-based approach not only maintained high accuracy across a diverse range of modes and intensities, but also generalized well when evaluated on conditions not included in the training set, which is a component for successfully deploying these types of systems in-the-wild.

Further, transitions between standing and walking are extremely common in community ambulation but typically are not accommodated by conventional exoskeleton controllers given the challenge of parameterizing these transient behaviors. By naturally varying assistance based solely on the estimated joint moments, our unified joint moment controller seamlessly adjusted exoskeleton assistance through mode transitions, without the need for any additional modifications to the controller (representative example shown in FIG. 12D). Specifically, our five-participant pilot analysis found that the TCN 202 reduced the estimation RMSE during stand-to-walk transitions by 0.081±0.031 Nm/kg (34.9±13.5%) and during walk-to-stand transitions by 0.085±0.014 Nm/kg (35.3±5.7%) compared to the Baseline method (FIG. 10B), with similar improvements in R² (FIG. 11B). Additionally, the estimator naturally turned-off assistance during neutral standing, with very little difference in RMSE between the estimates from the TCN 202 and those from estimating zero hip moment (i.e., the Baseline method; FIG. 10B).

In general, this work presents a first-of-its-kind framework that unifies exoskeleton control across a variety of ambulatory conditions. Our approach represents a significant advancement in exoskeleton technology, shrinking the gap between the exoskeleton benefits measured in-lab and real-world exoskeleton needs. We expect that our unified controller and hip moment estimator can be adopted by a broad community of researchers and technologists. For instance, our exoskeleton framework could extend the endurance of workers in demanding occupations, such as search and rescue. For those interested in large-scale health monitoring, our joint moment estimator could be used as a wearable sensor-based solution to monitor joint kinetics during daily life. Additionally, our approach could be extended to accommodate clinical populations, helping to restore mobility inside and outside of the clinic.

### Experimental Protocol

This study included four experimental phases. The first phase included modifying a preexisting dataset collected in our lab for use in this study. The final three phases included human-subject experiments in which participants walked overground and on an inclinable treadmill with and without our autonomous hip exoskeleton. Each participant enrolled in this study provided written informed consent according to the protocol approved by the Georgia Institute of Technology Institutional Review Board. To ensure the hip moment estimator was consistently evaluated on a subject-independent basis (i.e., trained without subject-specific data), each participant participated in one of the four phases of the study protocol.

During each trial that involved wearing the exoskeleton, the recorded exoskeleton data included angular position and filtered velocity of the left and right actuator encoders, 3-axis acceleration and 3-axis angular velocity data measured from IMUs 118 mounted on the left and right thigh struts as well as on the backplate, estimated hip moments from the TCN 202, commanded actuator torque, and measured actuator torque (computed by multiplying measured current from the motor drivers with the motor torque constant and actuator gear ratio). All data from the exoskeleton were collected at 200 Hz. For trials that included biomechanical measurements, motion capture data were collected at 200 Hz (Vicon Motion Systems, United Kingdom), and ground reaction force data were collected at 1000 Hz (Bertec, OH, USA). GRF data were synced natively with the motion capture data using a Vicon Lock Sync Box. Exoskeleton data were synced with the motion capture and GRF data by aligning the exoskeleton data to the rising edge of a 5V analog pulse generated by the Vicon Lock Sync Box at the start of each trial.

Phase 1: N=9 Initial Dataset

To generate an initial dataset to train the hip moment estimator, we transformed the exoskeleton sensor data of a previously collected dataset that used the Gait Enhancing and Motivating System (GEMS) (Samsung, South Korea), a lightweight, autonomous exoskeleton designed to assist the user's hip joints in the sagittal plane. The dataset includes nine able-body participants (Participants AB01-AB09, 5 males, 4 females, average height of 1.75±0.07 m, average body mass of 70.4±8.7 kg, and average age of 22±3 years) walking over level ground, inclines and declines of +7.8°, 9.2°, 11.0°, and +12.4°, and stairs of height 10.2 cm, 12.7 cm, 15.2 cm, and 17.8 cm while wearing the GEMS. The participants completed a minimum of 20 walking bouts over each condition while the exoskeleton provided hip assistance based on predefined gait phase-based spline trajectories. Gait phase was estimated onboard the device using a deep convolutional neural network (e.g., TCN 202).

The GEMS data were collected at 200 Hz and included angular positions and velocities of the actuator-mounted encoders and 3-axis acceleration and gyroscope data from left thigh-mounted, right-thigh mounted, and pelvis-mounted IMUs. The left and right thigh IMUs (MPU-9250, TDK InvenSense, CA, USA) were not installed on the GEMS by default but were manually added to improve the sensing capability of the device. Encoder velocities were computed post hoc using backward finite differencing and a 2^{nd} order Butterworth filter with a lowpass cutoff frequency of 10 Hz to match the GEMS velocity signals to those of our custom hip exoskeleton. Additionally, the IMUs onboard the GEMS were placed on the same linkages as those mounted on our custom hip exoskeleton but were placed in different positions and orientations. To transform the data from the IMUs onboard the GEMS into the coordinate systems of those on our custom hip exoskeleton, we reoriented the data from each IMU using a 3-axis rotation and 3-axis translation optimized based on calibration data from a single participant.

In addition to the exoskeleton data, the dataset included ground-truth lower-limb joint moments computed from motion capture (200 Hz) and GRF (1000 Hz) data collected using the same experimental methods used for the human-subject experiments conducted in this study (detailed above). Additionally, the joint moments were computed. The resulting dataset included ˜1.2 million labels consisting of left or right hip moments with corresponding exoskeleton data, which were added to the model training set used in this study.

Phase 2: N=5 Overground Dataset

Since the dataset from Phase 1 was collected on a different exoskeleton, it was beneficial to collect training data from the specific device used in this study to minimize the difference between the distributions of the training set and testing set (i.e., online deployment of the model in the control loop). Thus, we conducted a follow-up data collection with five able-body participants (Participants AB10-AB14, 4 males, 1 female, average height of 1.73±0.07 m, average body mass of 67.0±3.3 kg, and average age of 25±3 years) in which participants walked overground under the same conditions as the dataset detailed in Phase 1, completing 10 “down-and-back” walking bouts per trial. To further expand the domain of the training set, the participants also completed 20 “down-and-back” walking bouts overground where one stand-to-walk and one walk-to-stand transition was recorded per bout. During the overground walking trials, the participants were instructed to walk with a starting leg pattern that collected an even number of left and right leg strides for each condition (e.g., “complete the first five bouts starting with your right foot and the second five bouts starting with your left foot”). Finally, an additional trial of neutral standing for 30 seconds was included, in which participants were encouraged to slightly sway side-to-side and back-and-forth to further increase the richness of the data. During each trial, the exoskeleton provided assistance using the joint moment-informed controller with a hip moment estimator trained on the Phase 1 dataset. Assistance was manually turned off by an experimenter during the standing trial and during the standing portion of the stand-to-walk and walk-to-stand transition trials for this phase of the experimental protocol since the model had not previously been trained on standing data. During each trial, time-synced data from the exoskeleton, motion capture system, and force plates were collected as detailed above. Ground-truth hip moments were then computed. The resulting Phase 2 dataset included ˜700,000 examples of labeled hip moments with corresponding exoskeleton data.

Phase 3: N=10 User-Exoskeleton Training and User Outcomes Testing

Phase 3 of the experimental protocol was designed to test the effects of the unified joint moment controller on two user outcomes: 1) the metabolic cost of walking and 2) the lower-limb positive mechanical joint work. Ten able-body participants (Participants AB15-AB24, 7 males and 3 females) with an average height of 1.7±7.4 m, body mass of 74.0±12.6 kg, and age of 24±3 years were enrolled in the protocol. The Phase 3 protocol was sectioned into two sessions. Session 1 trained the participants in walking with the exoskeleton and tested the effect of the exoskeleton assistance on each participant's lower-limb mechanical joint work. Session 2 quantified the effect of the exoskeleton assistance on each participant's metabolic cost of walking. During this Phase 3 protocol, the unified joint moment controller was implemented using a hip moment estimator trained using the labeled data from Phase 1 and Phase 2.

During Session 1, each participant walked on a level treadmill (0.75, 0.8, 1.0, 1.2, 1.4, 1.5, 1.6, and 1.75 m/s), on an inclined/declined treadmill (−5 at 1.25 m/s, ±7.5° at 1.13 m/s, ±10° at 1.0 m/s, ±12.5° at 0.88 m/s, and +15° at 0.75 m/s), and over a height-adjustable staircase (stair heights of ±10.2 cm, 12.7 cm, 15.2 cm, and ±17.8 cm) while wearing the hip exoskeleton. During each condition, the exoskeleton provided hip flexion/extension assistance using the unified joint moment controller. Each treadmill condition lasted 30 seconds and each stair condition included 12 passes up and down the 6-step staircase. Additionally, each participant completed treadmill trials of level walking and 5° ramp ascent both at 1.25 m/s trials while 1) the exoskeleton provided assistance using the unified joint moment controller (Unified Control) and 2) without wearing the exoskeleton (No Exo). Each condition lasted 6 minutes to ensure the participants' joint kinetics converged to a steady-state, with the last two minutes of each trial being used to analyze the exoskeleton effect on user lower-limb joint work (see Analyzing Exoskeleton Effects on User Mechanical Joint Work for more details). The Unified Control and No Exo conditions were completed in a randomized order as were the ambulatory conditions (i.e., level walking and 5° incline walking); however, either both of the Unified Control conditions or both of the No Exo conditions were completed first to minimize don/doff time in the protocol. Time-synced data from the exoskeleton, motion capture system, and force plates were collected for all trials completed in Session 1 of the Phase 3 protocol. Thus, the Session 1 protocol allowed the participants to train with the exoskeleton, a factor when studying exoskeleton effects on user metabolic cost and yielded a third labeled dataset for hip moment estimation (˜3 million examples of labeled hip moments).

Session 2 of the Phase 3 protocol was conducted to evaluate the effect of our exoskeleton controller on user metabolic cost. Volumetric flowrates of oxygen intake (\dot{V}O₂) and carbon dioxide exhaust (\dot{V}CO₂) from the breaths of each participant were measured using a metabolic measurement system (TrueOne 2400, ParvoMedics, UT, USA) and used to compute metabolic cost (details in Analyzing Exoskeleton Effects on User Metabolic Cost). The metabolic trials were conducted under the same ambulatory conditions used to analysis lower-limb joint work: 1) walking at 1.25 m/s on a level treadmill and 2) walking at 1.25 m/s on a 5° inclined treadmill. For each ambulatory condition, we tested four exoskeleton assistance conditions: 1) wearing the exoskeleton which provided assistance based on our unified joint moment controller (Unified Control); 2) wearing the exoskeleton which provided assistance based on a previously optimized spline (Spline Control); 3) without wearing the exoskeleton (No Exo); and 4) wearing the exoskeleton which actively commanded zero torque (Zero Torque). As described above, Unified Control scaled exoskeleton assistance to 20% of the total hip moment estimated by the TCN. The assistance trajectories used for the Spline Control condition were generated using piecewise cubic Hermite interpolating polynomials based on the average spline resulting from previous human-in-the-loop optimization studies for level ground walking and 5° ramp ascent at 1.25 m/s. The splines were parameterized by six nodes, describing the timing for extension onset, peak extension torque, extension offset, flexion onset, peak flexion torque, and flexion offset with respect to gait phase. Since the metabolic trials were conducted at steady-state, gait phase was computed at each point in time based on the average stride duration of the previous 20 strides. Each stride duration was computed based on measured heel strikes detected by force sensitive resistors mounted under the user's heel and integrated into our hip exoskeleton. The FSR data were also used to segment the users strides for analyzing the exoskeleton data from the metabolic trials post hoc. The assistance magnitude of Spline Control was modified for each participant to match the peak torque provided by the Unified Control condition (FIGS. 8C and 8E).

Before completing the metabolic trials, participants habituated to the exoskeleton by walking with assistance at 25, 50, and 75% of the final assistance level used for the metabolic trials, each lasting two minutes. Participants then walked with 100% of the final assistance level for the metabolic trial for 5 minutes. These habituation trials were completed with the powered assistance condition (i.e., Unified Control or Spline Control) that was second in the experimental order. After this first habituation phase, participants then completed a final 5-minute habituation trial with the alternative assistance condition at 100% of the final assistance level. Thus, the participants walked for approximately 40 minutes with exoskeleton assistance from the Session 1 and 2 protocols before completing the metabolic trials. Due to scheduling constraints Participants AB17 and AB18 completed Session 2 prior to Session 1, meaning they experienced 16 minutes of exoskeleton walking before completing the metabolic trials; however, neither participant responded out of the norm (metabolic cost results for each subject are provided in the supplementary data).

The metabolic protocol used a within-participant counter-balanced design (ABCD-DCBA) with each trial lasting 6 minutes to allow the participants' metabolic cost to reach and maintain a steady-state. Participants were blinded to the exoskeleton assistance conditions, and the order of conditions were pseudo-randomized with the No Exo condition either in the A or D position to minimize don/doff time. The order of ambulation modes was also randomized, either completing level ground walking trials or ramp ascent trials first.

Phase 4: N=10 Validating the Hip Moment Estimator In-the-Loop

Given that the hip moment estimator implemented in Phase 3 of the experimental protocol included data from five participants wearing the custom hip exoskeleton, we expected that the performance achievable by the hip moment estimator would be improved given a larger training set. Thus, we conducted Phase 4 of the experimental protocol to quantify the accuracy of the hip moment estimator when implemented in the control loop and when trained on a substantially larger training set (i.e., by combining the labeled datasets collected in Phases 1, 2 and 3). Ten able-body participants (Participants AB25-AB34, 8 males and 2 females) with an average height of 1.71±0.08 m, body mass of 73.3±12.5 kg, and age of 25±5 years were enrolled in this phase of the protocol. Each participant walked with the hip exoskeleton on a level treadmill at 0.75, 0.8, 1.0, 1.2, 1.4, 1.5, 1.6, and 1.75 m/s, on an inclined/declined treadmill at ±5° at 1.25 m/s, ±7.5° at 1.13 m/s, ±10° at 1.0 m/s, ±12.5° at 0.88 m/s, and ±15° at 0.75 m/s, and over a height-adjustable staircase with stair heights of ±10.2 cm, 12.7 cm, 15.2 cm, and ±17.8 cm. To analyze the online performance of the TCN when tested on novel conditions that were not included in the training set, each participant also walked on a level treadmill at 0.6, 1.1, 1.3 and 1.9 m/s and on an inclined/declined treadmill of ±6.3° at 1.19 m/s and ±13.8° at 0.82 m/s. Each participant also repeated the stair ascent/descent trials with stair heights of ±12.7 cm and ±17.8 cm while using a hip moment estimator with these two conditions iteratively withheld from the training set, respectively. Each treadmill trial lasted 30 seconds, and the stair ascent/descent trials included completing six passes up and down the 6-step staircase. Finally, five of the 10 participants completed an additional five stand-to-walk and walk-to-stand transitions by ramping the treadmill from neutral standing to 1.25 m/s at 0.3 m/s² and from 1.25 m/s to neutral standing at −0.3 m/s², respectively. Stand-to-walk trials were segmented from the first toe-off in the trial to the first toe-off of the same leg after 4.17 seconds (i.e., after the time it took the treadmill to accelerate to 1.25 m/s). Similarly, the walk-to-stand trials were segmented based on the last heel strike in the trial and the first heel strike of the same leg that occurred at least 4.17 seconds earlier. These participants also completed a 30 second trial of neutral standing. During each trial, the exoskeleton provided assistance using the unified joint moment controller based on the instantaneous hip moment estimates from the TCN. Throughout this protocol, exoskeleton, motion capture, and GRF data were collected using the methods described above and ground-truth joint moments were computed. The resulting dataset included ˜3.5 million examples of labeled hip moments.

Biomechanical Modeling

In various examples, biomechanical analyses were conducted using the opensource musculoskeletal modeling software, OpenSim with the gait2392 lower-limb model. Since the hip exoskeleton occluded markers placed on the pelvis, the segment dimensions, masses, and inertias of the default model were first scaled to each participant's anthropometry using motion capture data from a No Exo neutral standing trial. This scaled model was then used for computing joint kinematics and kinetics for trials without the exoskeleton. Since the exoskeleton occluded the motion capture markers around the pelvis, a copy of the scaled model was also rescaled using marker data from a second neutral standing trial consisting of the participant wearing the exoskeleton with a modified marker set. During the rescaling process, the OpenSim model segment masses and inertias were not modified (i.e., only marker locations relative to the segments were modified), which preserved the anthropometric features of each participant. The added mass of the exoskeleton was then added as a point mass to the pelvis of the rescaled model to minimize residual errors between the OpenSim model dynamics and the measured GRFs. The rescaled model was used to compute joint kinematics and kinetics for trials that included wearing the exoskeleton.

Joint kinematics were computed for each trial using the OpenSim Inverse Kinematics tool based on the motion capture marker data. The resulting joint kinematics and corresponding GRFs for each trial were then used to compute joint moments using the OpenSim Inverse Dynamics tool. Before computing joint kinematics and moments, marker data were lowpass filtered using a zero-lag, 5^{th} order Butterworth filter with a 6 Hz cutoff frequency, and GRF data were lowpass filtered using a zero-lag, 5^{th} order Butterworth filter with a 20 Hz cutoff frequency. Additionally, the resulting joint kinematics and moments were filtered using a zero-lag, 5^{th} order Butterworth filter with a 6 Hz cutoff frequency.

Analyzing Exoskeleton Effects on User Metabolic Cost

For each trial in which \dot{V}O₂ and \dot{V}CO₂ data were collected, instantaneous metabolic cost (Pₘₑₜ) scaled by body mass (m) was computed using the modified Brockway equation

$${P}_{met} = \frac{( 0.278 * \dot{V} {O}_{2} + 0.075 * \dot{V} {CO}_{2} )}{m} . \qquad ( 16 )$$

Steady-state metabolic cost was then computed as the average metabolic cost from the last three minutes of each six-minute trial. The metabolic cost of walking was then computed by subtracting the participant's basal metabolic rate, computed as the steady-state metabolic cost during neutral standing, from the steady-state metabolic cost for each trial, a common method of evaluating the whole-body energetic cost for human movement. Since each assistance condition (i.e., Unified Control, Spline Control, No Exo, and Zero Torque) was run twice using the counter-balanced experimental design, the metabolic cost of walking for each participant was computed by averaging the results of the two trials for each assistance condition and ambulation mode.

Analyzing Exoskeleton Effects on User Mechanical Joint Work

Sagittal plane net joint power (Pₙₑₜ) (i.e., the total power at the joint including both human and exoskeleton contributions) was computed at the hip, knee, and ankle using the angular velocity of the biological joint (\dot{θ}_{bio}) and the net joint moment (τₙₑₜ) as

Pₙₑₜ=τₙₑₜ*\dot{θ}_{bio}. (17)

Similarly, the exoskeleton power delivered to the biological joint (Pₑₓₒ) was computed as

Pₑₓₒ=τₑₓₒ*\dot{θ}_{bio}, (18)

such that the human-exoskeleton interaction torque (τₑₓₒ) was computed by subtracting the actuator torque lost to motor dynamics (τ_{dyn}) from the total actuator torque (τ_{act}) as

τₑₓₒ=τ_{act}−τ_{dyn}. (19)

Since the actuators used a low gear ratio (N) of 9 to 1, τ_{act} was computed from the measured motor current (iₘₒₜₒᵣ) and motor torque constant (kₜ), such that

τ_{act}=N*kₜ*iₘₒₜₒᵣ. (20)

Additionally, τ_{dyn} was computed from the angular velocity (\dot{θ}_{act}) and acceleration (\ddot{θ}_{act}) of the actuator output encoder using a second-order model of the actuator dynamics, as

τ_{dyn}=N²*(J*\ddot{θ}_{act}+b*\dot{θ}_{act}), (21)

where the motor inertia (J) and damping constant (b) were approximated from a similar electric motor (26) (J=1.2×10⁻⁴ kg·m² and b=1.6×10⁻⁴ Nm·s). Finally, the biological joint power of the user (P_{bio}) was computed as

P_{bio}=τ_{bio}*θ_{bio}, (22)

where the biological joint moment (τ_{bio}) was computed based on τₙₑₜ and τₑₓₒ, as

τ_{bio}=τₙₑₜ−τₑₓₒ. (23)

The resulting positive mechanical work (W⁺) of the exoskeleton (Wₑₓₒ⁺) and user (W_{bio}⁺) were computed as the average positive mechanical work computed for each of the S strides collected per condition (Wₛ⁺) using Pₑₓₒ and P_{bio}, respectively, such that

$${W}^{+} = \frac{1}{S} {\sum }_{i = 1}^{S} {W}_{s , i}^{+} , \qquad ( 24 )$$

where the positive mechanical work of the i^{th} stride with duration d was computed from the positive power over the stride (P+), as

W_{s,i}⁺=∫₀^{d}Pᵢ⁺(t)dt, (25)

with the positive power at each time instance t computed as

$${P}^{+} ( t ) = \{ \begin{matrix}P ( t ) & if P ( t ) > 0 \\ 0 & otherwise\end{matrix} . \qquad ( 26 )$$

Total positive lower-limb joint work for each stride was then computed by summing the positive joint work at the hip, knee, and ankle. All results are presented as the inter-subject average of the resulting positive mechanical work values.

Analyzing Online Hip Moment Estimation Accuracy

During Phase 4 of the experiment, the estimated hip moment was recorded onboard the exoskeleton and aligned in time with the ground-truth hip moments post hoc to evaluate the accuracy of the TCN when integrated into the unified controller. Two common performance metrics were used to analyze the estimator accuracy: 1) the inter-subject average root-mean-square error (RSME) and 2) the inter-subject average of the square of the Pearson correlation coefficient (R²). Average RMSE provided an absolute metric of error and is easily compared to previous studies that have investigated wearable sensor-based joint moment estimators. Average R² provided a nondimensional metric to analyze the goodness of fit of the TCN (i.e., the amount of variance in the ground-truth hip moments explained by the TCN estimates via a fitted line). When considering joint moment estimation for exoskeleton control, R² also provided a metric for analyzing the ability of the model to correctly estimate the “shape” of the hip moment signal, ignoring error induced from incorrect scaling or bias. In general, this provided a useful metric to evaluate the utility of the hip moment estimator given that scale and bias of the signal could be modified on-the-fly by the mid-level exoskeleton control layer as needed. The results were computed to weigh each participant, ambulation mode, and ambulation intensity equally. Specifically, results reported per intensity (i.e., per walking speed, ground slope, and stair height) were individually computed per condition then averaged across participants. Results reported per ambulation mode were computed by taking the average of the results computed per intensity within the respective mode (e.g., the average of the RMSE values computed per level ground walking speed), then averaged across participants. Overall results were computed similarly, by averaging the results computed per ambulation mode, then averaging across participants.

The accuracy of the TCN was benchmarked against a Baseline method designed to emulate conventional exoskeleton controllers that use predefined ambulation mode-specific curves to compute assistance based on gait phase estimates. Specifically, the Baseline method was implemented post hoc and estimated the user's hip moments based on a precomputed hip moment curve for each ambulation mode. The hip moment curve for each ambulation mode (i.e., level ground walking, ramp ascent, ramp descent, stair ascent, and stair descent) was computed as the inter-subject average hip moment over the stride from the ground-truth hip moments in same dataset used to train the TCN that was deployed in Phase 4 (i.e., the hip moment data from Phase 1, 2, and 3 of the study protocol). In this case, the Baseline method was given access to a perfectly accurate ambulation mode classifier and gait estimator which have error in practice, meaning our benchmark represented the best-case (yet unrealistic) scenario for estimating hip moments from mode-specific curves. In this case, outperforming the Baseline method meant that the subject-independent TCN captured inter-subject, inter-condition, or inter-stride variability that the Baseline method could not represent

Statistical Analyses

All statistical tests were conducted using Minitab v19 with an alpha level of significance of 0.05. Further, statistical tests were computed using within-participant methods (i.e., using repeated-measures). When comparing differences among multiple factors and/or multiple within-factor conditions, a post hoc multiple comparisons test (abbreviated as mult. comparisons when presenting statistical results) was used to identify significant pairwise differences in the case that significant effects were found from an ANOVA. All post hoc multiple comparisons were conducted using a Bonferroni correction to control the family-wise error rate. Since the Bonferroni correction can greatly reduce the statistical power of each pairwise comparison when many pairwise matches exist, we only evaluated a subset of the possible pairwise comparisons which were selected a priori (i.e., before looking at the results) to limit the amount that each p-value needed to be adjusted. Since Minitab did not support this planned comparison approach, we ran a full multiple comparisons test following each ANOVA that yielded statistical significance and adjusted the p-values to account for the reduced number of comparisons being evaluated.

Metabolic cost comparisons across the four tested exoskeleton assistance conditions (i.e., Unified Control, Spline Control, No Exo, and Zero Torque) were analyzed for a main effect using a one-way ANOVA followed by a multiple comparisons test. Differences in positive joint work between the exoskeleton conditions (i.e., Unified Control and No Exo) across the lower-limb joints (i.e., hip, knee, and ankle) were evaluated using a two-way ANOVA for level ground and ramp ascent. Pairwise comparisons were only conducted for testing significant differences between Unified Control and No Exo within each joint (15 possible comparisons reduced to 3 evaluated comparisons). Additionally, the total positive lower-limb joint work resulting from Unified Control and No Exo were compared separately from the other joints using a paired t-test for each ambulation mode.

The same statistical tests were run for analyzing both the RMSE and R² of the hip moment estimators evaluated in this study (i.e., the TCN and Baseline method). The overall average results of the TCN across the level ground, ramp ascent, ramp descent, stair ascent, and stair descent conditions were compared to those of the Baseline method using a paired t-test. For comparisons at the ambulation mode level, a two-way ANOVA was used to test for significant main and interaction effects across ambulation modes and between estimators (i.e., the TCN and Baseline method). A post hoc multiple comparisons test was also used to test for pairwise differences between the two estimators within each ambulation mode (45 total possible comparisons reduced to 5 evaluated comparisons). Within each ambulation mode, a two-way ANVOA was used to test for significant main and interaction effects across ambulation mode intensity and between estimators. Additionally, a post hoc multiple comparisons test was used to test for significant differences between the TCN and Baseline method within each intensity (13 out of 325 comparisons evaluated for level ground walking, 7 out of 91 comparisons evaluated for ramp ascent and for ramp descent, and 4 out of 28 comparisons evaluated for stair ascent and for stair descent).

Effect of Delay Timing on User Metabolic Cost

To tune the delay of the mid-level controller, we conducted a small, three-participant (Participants AB01-AB03, 3 males, average height of 1.76±0.08 m, average body mass of 67.1±3.7 kg, average age of 24±4 years) pilot study in which the user's metabolic cost of walking was measured under five delay magnitudes when using the unified joint moment controller. The evaluated delays were 75, 100, 125, 150, 175 ms including the delay from the lowpass filter. The order of delay magnitudes was randomized and blinded to each participant. Each delay magnitude was evaluated during level ground walking at 1.4 m/s and 5° incline walking at 1.0 m/s using a within-participant counter-balanced design (ABCDEEDCBA). Each trial lasted four minutes while the volumetric flowrate of oxygen intake (\dot{V}O₂) and of carbon dioxide exhaust (\dot{V}CO₂) of the participant's breath were measured using a metabolic measurement system (TrueOne 2400, ParvoMedics, UT, USA). Each participant's basal metabolic rate was also measured during neutral standing without wearing the exoskeleton. Hip moment estimates used in the unified joint moment controller were estimated using a TCN trained on the data from the Phase 1 of the experimental protocol.

Prior to the metabolic tests, participants underwent a habituation protocol to acclimate to the exoskeleton assistance. The participants first walked for 1 minute each with a scale factor of 7.5% and 15% of the total estimated hip moment and a delay magnitude of 125 ms (i.e., the median delay magnitude). The participants then walked with full exoskeleton assistance (i.e., 20% of the estimated hip moment) with a delay magnitude of 125, 100, 75, 150, and 175 ms, sequentially for two minutes each. The habituation trials were completed under the same ambulatory condition (i.e., level ground or incline walking) as the following metabolic trials.

Instantaneous metabolic cost was computed for each time point using the modified Brockway equation. The resulting data was fit using a first-order model to estimate steady-state metabolic cost from the four-minute trial. The steady-state metabolic cost of walking was then computed by subtracting each participant's basal metabolic rate from the estimated steady-state metabolic cost.

In both the level ground and incline trials, the metabolic cost of walking showed little sensitivity to the delay magnitudes tested in this pilot study (FIG. 5B). During level ground walking, the average metabolic cost varied by 0.07 W/kg across conditions (2.6% of lowest value). Similarly, during incline walking the average metabolic cost varied by 0.11 W/kg across conditions (2.9% of lowest value). Though we did not find substantial differences in metabolic cost across delay magnitudes, it is likely that further decreasing the delay would further increase metabolic cost, as the largest metabolic cost for both level ground and incline walking was measured during the lowest delay magnitude of 75 ms. Delays below 75 ms were noted as uncomfortable during initial pilot experiments by both novice and expert exoskeleton users, leading us to omit them from the metabolic pilot study.

Testing the Hip Moment Estimator on Novel Conditions

To predict the real-world performance of machine learning-based high-level state estimators, these systems should be evaluated under novel conditions (i.e., walking speeds, inclines/declines, and stair heights that are not included in the training set). Otherwise, researchers may not detect overfitting, falsely assuming their models generalize across conditions. In our previous work, we found that withholding each ground slope and stair height from the training set had little effect on the RMSE and R² of our hip moment estimator outside of the steepest incline of 18°. While these results were promising, our analysis relied on simulated IMUs and was conducted offline. Given these limitations, the TCN could fail to generalize to novel conditions when using real exoskeleton sensor data, which contains substantial amounts of noise from measurement uncertainty and the physical decoupling between the human and exoskeleton. Further, the impact on model generalization of implementing the hip moment estimator in the control loop remains unknown. It is possible that inaccuracies in the hip moment estimator during novel conditions could propagate as the resulting exoskeleton assistance based on incorrect estimates could drive the user into a gait pattern far outside of the training set distribution (36). In this study, we conducted a rigorous evaluation of TCN generalization to novel ambulatory conditions using both online and offline methods.

In this study, we tested the TCN when implemented online (i.e., deployed onboard the exoskeleton and used for exoskeleton control) during several ambulatory conditions that were included in the training set, denoted “Within Train Set, Tested Online;” however to evaluate the generalizability of our controller framework, we also tested the unified controller under completely novel conditions of level ground walking (0.6 m/s, 1.1 m/s, 1.3 m/s and 1.9 m/s) and ramp ascent/descent (±6.3° at 1.19 m/s and ±13.8° at 0.82 m/s) and during stair height conditions withheld from the training set (±12.7 cm and ±17.8 cm). The results from these level ground walking, ramp ascent/descent, and stair descent trials were denoted “Not Within Train Set, Tested Online.” The level ground walking speeds were selected to test the TCN accuracy with never-before-seen walking speeds both within and outside of the training set distribution (training set ranged from 0.75 to 1.75 m/s). The novel incline and decline slope angles fell within the training set distribution (training set ranged from −15° to +15°) as 15° was the maximum slope of the treadmill. To test online TCN generalization during stair ascent/descent, we could not select completely novel stair heights since the height-adjustable staircase included four preset stair heights (spanning the full range of ADA compliant stair heights). Instead, two additional TCN models were trained from random initialization a priori: one while withholding the ±12.7 cm data from the training set and the other while withholding the ±17.8 cm data. These models were then deployed during separate trials of the experiment and tested on the respective stair heights withheld from each model.

To quantify TCN generalizability during the remaining conditions of the Phase 4 experimental protocol (i.e., nine level ground walking speeds, five inclines and declines, and two stair heights), we quantified the TCN performance offline using a leave-one-out approach. These results were denoted “Not Within Train Set, Tested Offline.” Specifically, we conducted a leave-one-out analysis in which we iteratively withheld each ambulatory condition from the training set while training the TCN from random initialization. For each model, the labeled data from Phases 1, 2, and 3 of the experimental protocol were used (i.e., the same labeled dataset used to train the models deployed online). Each model was trained using the same validation set for early stopping (i.e., the data from Participant AB05 of the Phase 1 dataset) and was tested on each respective hold-out condition from the Phase 4 dataset. To ensure the ambulatory conditions were completely withheld from the training set, the Phase 1 level ground walking data (overground at a self-selected walking speed) were removed when training the level ground walking hold-out models. Similarly, the ±7.8° Phase 1 ground slope data were removed for the 7.5° hold-out model, the ±9.2° and ±11° Phase 1 ground slope data were removed for the 10° hold-out model, and the +12.4° Phase 1 ground slope data were removed for the 12.5° hold-out model.

Similarly, we conducted an offline leave-one-in analysis to test the effect of including the never-before-seen ambulatory conditions evaluated online in the Phase 4 protocol in the model training set. The results from these conditions were denoted as “Within Train Set, Tested Offline.” Since these conditions did not exist in the Phase 1, 2, and 3 datasets, we retrained the TCN with the labeled data from Phases 1, 2, and 3 as well as the data for each respective hold-in condition from the Phase 4 dataset. Since the models were subsequently tested on the Phase 4 dataset, we iteratively retrained the TCN using a leave-one-subject-out, hold-one-condition-in approach in which 10 models were trained for each hold-in condition, with one model per withheld subject. The 10 models were subsequently tested on the data corresponding to the hold-in ambulatory condition(s) of their respective hold-out subject, maintaining complete subject-independence in the analysis. During training, the same validation set was again used for early stopping (i.e., the data from Participant AB05 of the Phase 1 dataset) to prevent overfitting.

Using this approach, we obtained an average RMSE and R² of the TCN for each ambulatory condition when both including and excluding it from the training set (FIGS. 13A & 13B). To quantify any loss in model accuracy due to testing on novel conditions, we used a two-way ANOVA to test for significant main and interaction effects among the ambulatory conditions and between the hold-in and hold-out conditions for each ambulation mode. Upon finding a significant effect, pairwise comparisons within each ambulation mode were conducted using a post hoc multiple comparisons test with a Bonferroni correction. Of all possible pairwise comparisons, pairwise differences were tested between the hold-in and hold-out results within each ambulation condition.

When testing the relevant pairwise comparisons, we found a significant difference in RMSE of the hold-out models compared to the hold-in results on the 5° ramp ascent condition (increase of 0.031±0.022 Nm/kg [22.2±16.0%]; mult. comparisons, P=0.0245, n=10), +17.8 cm stair ascent condition (increase of 0.019±0.024 Nm/kg [14.1±17.9%]; mult. comparisons, P=0.0265, n=10), and −17.8 cm stair descent condition (decrease of 0.017±0.020 Nm/kg [11.1±12.9%]; mult. comparisons, P=0.0388, n=10) (FIGS. 13A & 13B). Other comparisons of RMSE and R² between the hold-in and hold-out conditions were not statistically significant.

Overall, the model generalized well to the conditions within the distribution of the training set (e.g., interpolation), which was consistent with our previous offline findings. Within the ramp ascent and stair ascent ambulation modes we found significant increases in RMSE during the conditions that had the largest range of peak-to-peak hip moments (i.e., 5° incline at 1.25 m/s and +17.8 cm stairs). Thus, the TCN started to increase in estimation error at the bounds of the training set distribution. Interestingly, we did not find any significant differences in R² between the hold-in and hold-out conditions, suggesting the TCN correctly maintained the “shape” of the hip moment curves even when tested under these extreme conditions. Instead, this result indicates that the TCN incorrectly scaled the hip moment magnitude under these two extreme conditions. Thus, even when encountering high intensity conditions outside of the training set distribution, the unified joint moment controller maintains the correct assistance timing but may begin to incorrectly scale the assistance magnitude.

Opposite to our expectations, we found that the TCN RMSE of the −17.8 cm stair descent condition was lower (i.e., better) when withheld from the training set compared to when it was included in the training set. This result suggests that adding condition-specific data actually worsened model RMSE when tested on this specific condition. It is likely that the low signal-to-noise ratio of the exoskeleton kinematic sensors along with the heterogeneity in subject-to-subject hip moments during steep stair descent did not provide useful training examples for the TCN in this condition. Regardless, we found that the magnitude of the −17.8 cm SD RMSE of the hold-in and hold-out models were still similar to those of the other conditions; however, further analyses should be conducted, investigating additional sensors or alternative loss functions that may improve the usefulness of this training data.

Effect of Training Data on Hip Moment Estimation Accuracy

As with any data-driven approach, the accuracy of neural network models is heavily dependent on the number of samples available in the training dataset. Thus, we conducted an offline analysis to quantify the impact of iteratively increasing the size of the training dataset on TCN accuracy. We iteratively added data from each phase of the study protocol (i.e., Phases 1 through 4) into the training set, substantially increasing the number of labeled data (and total number of participants) with each iteration. Thus, the TCN was tested when using four different training sets of varying sizes: 1) using data from Phase 1 only (i.e., P1; n=9 training set), 2) using data from Phases 1 and 2 (i.e., P1+2; n=14 training set), 3) using data from Phases 1, 2, and 3 (i.e., P1+2+3; n=24 training set) and 4) using data from Phases 1, 2, 3, and 4 (i.e., P1+2+3+4; n=33 training set). The models for each condition were trained from random initialization while withholding the data from Participant AB05, which was used as the validation set for early stopping during model training (see Materials and Methods for more details on model training).

The resulting models were each tested offline on the level ground, ramp ascent, ramp descent, stair ascent, and stair descent data from the Phase 4 dataset. Since Phase 4 data was also included in the training set for the P1+2+3+4 condition, we iteratively retrained the model from random initialization using a leave-one-subject-out approach, in which the data of the held-out Phase 4 participant was used as the test set. This approach ensured that the model would not be trained and tested on the same data while providing insight into the effects of using the Phase 4 dataset for model training.

Significant main effects in RMSE and R² among the training set conditions were tested for using a one-way ANOVA. Additionally, a post hoc multiple comparisons test with a Bonferroni correction was used to test for significant pairwise differences among the conditions. Finally, an exponential decay function (y=C₁e^{-(C}^{₂}^{*(x-C}^{₃}⁾⁾+C₄) parameterized by the [symbol] ⁴ vector (C) was fit to the RMSE and R² data using the nlinfit( ) function in MATLAB to evaluate the expected results at the asymptote (i.e., if the training data contained an infinite number of labeled examples).

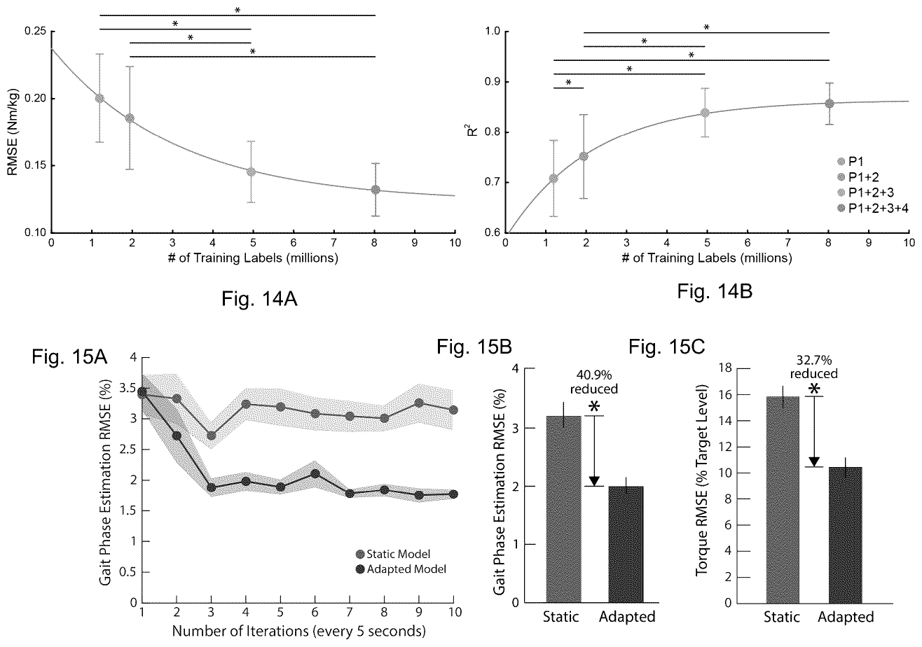

As shown in FIG. 14A, we found that the P1+2+3 condition significantly reduced test RMSE compared to the P1 condition (change of 0.055±0.017 Nm/kg [27.4±8.5%]; mult. comparisons, P=1×10⁻⁸, n=10) and the P1+2 condition (change of 0.040±0.019 Nm/kg [21.6±10.2%]; mult. comparisons, P=4×10⁻⁶, n=10). The P1+2+3+4 condition also significantly reduced test RMSE compared to the P1 condition (change of 0.068±0.024 Nm/kg [34.0±12.2%]; mult. comparisons, P=1×10⁻¹⁰, n=10) and P1+2 condition (change of 0.053±0.028 Nm/kg [28.8±14.9%]; mult. comparisons, P=2×10⁻⁸, n=10); however, we did not find a significant difference in RMSE between the P1 and P1+2 conditions or between the P1+2+3 and P1+2+3+4 conditions. The asymptotic result of the RMSE trendline was 0.123 Nm/kg.

Further we found similar results in R² (FIG. 14B), with the P1+2+3 condition significantly improving R² by 0.131±0.039 (18.5±5.6%) compared to the P1 condition (mult. comparisons, P=9×10⁻¹⁰, n=10) and by 0.087±0.041 (11.6±5.4%) compared to the P1+2 condition (mult. comparisons, P=2×10⁻⁶, n=10). The P1+2+3+4 condition also significantly improved R² compared to the P1 condition by 0.149±0.056 (21.0±7.9%; mult. comparisons, P=5×10⁻¹¹, n=10) and compared to the P1+2 condition by 0.105±0.056 (14.0±7.4%; mult. comparisons, P=8×10⁻⁸, n=10). In this case, we also found that the P1+2 condition significantly improved R² compared to the P1 condition (change of 0.044±0.022 [6.2±3.2%]; mult. comparisons, P=0.0149, n=10); however, no significant difference in R² was found between the P1+2+3 and P+1+2+3+4 conditions. The asymptotic result of the R² trendline was 0.864.

Thus, adding in the Phase 3 data to the training set significantly improved model performance compared to only using the Phase 1 and 2 data; however, we found that also including the Phase 4 data into the training set had diminishing returns, even though the data from Phase 4 consisted of an extra 3.1 million labeled training examples (an increase in training set size of 62.3%). Thus, the online TCN validation conducted in Phase 4 of the study protocol, which used a TCN trained on the P1+2+3 dataset, provides a rigorous analysis of the TCN without concerns that the model could have been further improved with more data. Additionally, based on the fit trendlines, we found that the expected model performance given an infinite number of training examples would improve by 0.009 Nm/kg in RMSE and 0.007 in R², compared to training on the available data in our dataset (i.e., the P1+2+3+4 condition). Thus, researchers can use this publicly available dataset to evaluate new approaches for estimating human biomechanical signals from wearable sensors without concerns about the size of the dataset.

Unified Online Adaptation Framework

The unified online adaptation framework 606 that actively learns the new user's gait dynamics in real time is described above. In this framework, the pre-trained deep learning-based gait phase estimator fine-tunes model parameters by leveraging real-time streaming sensor data. Three innovative features make our framework unique: the ability to translate across different exoskeleton hardware, locomotion settings, and user populations—including the neurologically impaired.

These innovations are demonstrated across a set of 4 experiments. First, we evaluated our adaptation framework, such as the general performance and the rate of adaptation, on a group of eight able-bodied subjects. In this experiment, we were particularly interested in answering a research question about the advantage of adaptation in delivering accurate assistance level (e.g., joint torque) to the user. Second, we investigated how our framework operates in a gait environment that deviates from patterns exhibited in a healthy population. We systematically simulated asymmetric gait in a small subset of the main able-bodied group, using a split-belt treadmill to mimic a neurologically impaired locomotion. Here, our aim was to test the robustness of our method in its ability to adapt to each leg independently without any performance degradation. Third, we assessed our framework's generalizability to a real clinical population. We recruited a cohort of six stroke survivors and applied our strategy to explore how we can leverage adaptation to improve estimation performance in a population with significant variability in gait patterns. This experiment is distinct from the first experiment because the first evaluated inter-subject variations (e.g., differences in the range of motion) whereas this experiment captured physiological state-dependent variations (e.g., spasticity in the extensor muscles affecting swing phase kinematics). Lastly, we further expanded our adaptation scheme by deploying our adaptation framework to a different exoskeleton hardware through device-to-device transfer learning. Additionally, in this new hardware setting, we optimized the underlying control parameters (i.e., assistance timing) that directly dictate applied joint torque. We used a human-in-the-loop optimization technique based on a stroke survivor's self-selected walking speed to fine-tune assistance parameters that improve the subject's overall mobility such as increasing walking speed and reducing energetic cost.

This work presents significant scientific and technological contributions to the field of robotic exoskeletons through advanced algorithm design. These contributions include: 1) a fully user-independent gait phase estimation system using deep learning during multimodal locomotion, 2) a robust adaptation framework using online learning across different user populations, devices, and environmental conditions, and 3) a parallel processing architecture that enables a reliable and simultaneous adaptation and real-time inference. Furthermore, our work is the first to fully implement an exoskeleton system that can reliably adapt to the user's gait in clinical populations, making a significant contribution to both scientific impact and underlying engineering design. Our multifaceted evaluation of the online adaptation framework is unique and validates its generalizability and translatability to real-world settings. The integration of these features enables personalized exoskeleton assistance, paving the way for assistive technology to be translated into real-world usage for a diverse range of users.

Real-Time Inference and Online Adaptation of Gait Phase on Able-Bodied Subjects

The online adaptation framework 606 was evaluated on able-bodied subjects to observe its performance in a population with minimal variations in gait dynamics. On average, the online adaptation framework converged after 3 iterations (corresponding to 15 seconds) to a final adapted model (FIG. 15A). After the adaptation phase, the final adapted model reduced the relative gait phase estimation root mean squared error (RMSE) by 40.9±11.5% (mean±standard deviation) from the initial static model to a final absolute gait phase RMSE of 1.8±0.2% (paired t test, p=0.0002). This difference in the estimation performance was also consistent in an additional online validation trial, verifying the model's ability to maintain accuracy outside of the initial adaptation trial (FIG. 15B). During the validation trial, the adapted model had an absolute gait phase RMSE of 2.0±0.4%, resulting in a 31.8±16.1% lower relative gait phase RMSE than the static model (paired t test, p=0.002). The influence of the gait phase estimation error propagated to the error in the applied exoskeleton joint torque. The coefficient of determination (R²) of 0.95 between gait phase errors and joint torque errors indicated that there was a strong linear correlation between gait phase and exoskeleton assistance as expected. For exoskeleton torque, the adapted model had a torque magnitude RMSE (% target assistance level) of 9.9±3.2%, resulting in a 32.7±16.6% lower torque RMSE than the static model (paired t test, p=0.003, FIG. 15C).

FIGS. 15A-15C evaluate the online adaptation framework 606 performance validation on able-bodied subjects. The performance of the adaptation framework was evaluated on able-bodied subjects walking on a treadmill at 1.2 m/s. As shown in FIG. 15A, the online adaptation framework converged after 3 iterations to a final adapted model. As shown in FIG. 15B, the adapted model maintained performance during a separate validation trial. As shown in FIG. 15C, the gait phase estimation error directly influenced the error in the applied exoskeleton torque. The shaded regions and error bars represent ±1 standard error of the mean (SEM) and the asterisks indicate statistical differences (p<0.05).

Robustness of the Online Adaptation Framework During Asymmetric Gait

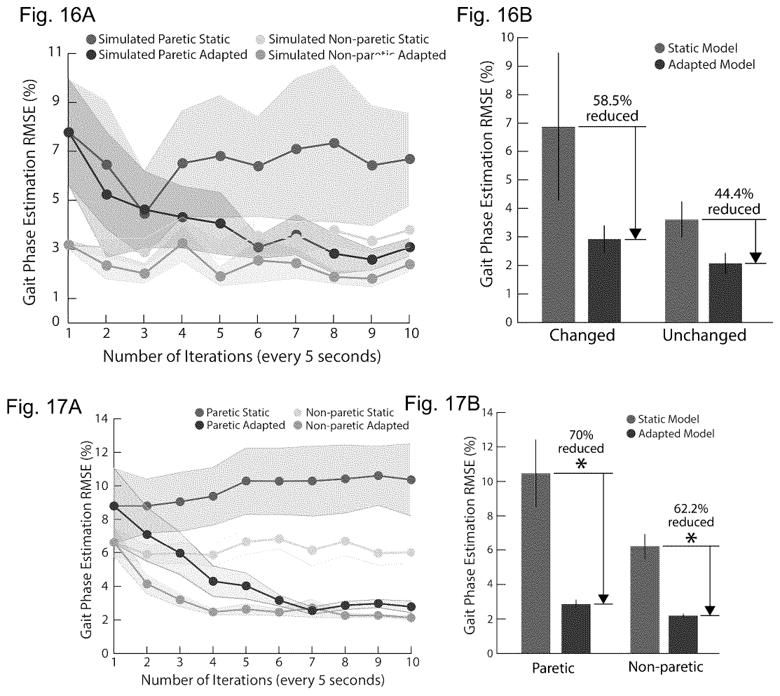

The online adaptation framework was evaluated on three able-bodied subjects walking on a split-belt treadmill, inducing an asymmetric gait. Inducing this simulated gait environment resulted in a baseline absolute gait phase RMSE of 6.8±4.3% for the speed-changed leg (FIG. 16A). During the adaptation phase, both legs converged to a steady gait phase estimation after 6 iterations. The final adapted model reduced the relative gait phase RMSE by 44.4±9.8% from the static model to a final absolute RMSE of 2.0±0.5% for the unchanged leg and reduced the relative gait phase RMSE by 58.5±36.0% to a final absolute RMSE of 2.8±0.7% for the speed-changed leg (FIG. 16B).

FIGS. 16A-16B show the online adaptation framework 606 performance validation on able-bodied subjects in a simulated asymmetric gait environment. Three able-bodied subjects walked on a split-belt treadmill (belt speed of 0.8 and 1.6 m/s) to evaluate the performance of our adaptation framework in a simulated asymmetric gait environment. As shown in FIG. 16A, the online adaptation framework converged reliably on both legs after 6 iterations to a final adapted model. As shown in FIG. 16B, the final adapted model reduced the gait phase estimation error reliably from the static model for both legs. The shaded regions and error bars represent ±1 SEM.

Generalizability of the Online Adaptation Framework to Stroke Populations

The online adaptation framework 606 was evaluated on a group of stroke survivors to validate its consistency in performance on a population with high variations in inter-limb coordination. Similar to the simulated asymmetric gait result, the baseline model performance was different between the paretic and non-paretic leg with an absolute gait phase RMSE of 10.5±4.8% and 6.2±1.8%, respectively (FIG. 17A). During the adaptation phase, the paretic and non-paretic legs converged to a steady gait phase estimation after 7 and 4 iterations, respectively. The final adapted model reduced the relative gait phase RMSE by 69.6±9.2% from the static model to a final absolute gait phase RMSE of 2.9±0.6% for the paretic leg and reduced the relative gait phase RMSE by 62.2±10.7% on average to a final absolute RMSE of 2.2±0.3% for the non-paretic leg (paired t test, p=0.001 and p=0.004, FIG. 17B).

FIGS. 17A and 17B show the online adaptation framework 606 performance validation on stroke survivors. The performance of the adaptation framework was evaluated on stroke survivors walking on a treadmill at their self-selected walking speed. As shown in FIG. 17A, the online adaptation framework converged reliably after 7 and 4 iterations for the paretic and non-paretic legs to a final adapted model, respectively. As shown in FIG. 17B, the final adapted model reduced the gait phase estimation error reliably from the static model for both the paretic and non-paretic legs. The shaded regions and error bars represent ±1 SEM and the asterisks indicate statistical differences (p<0.05).

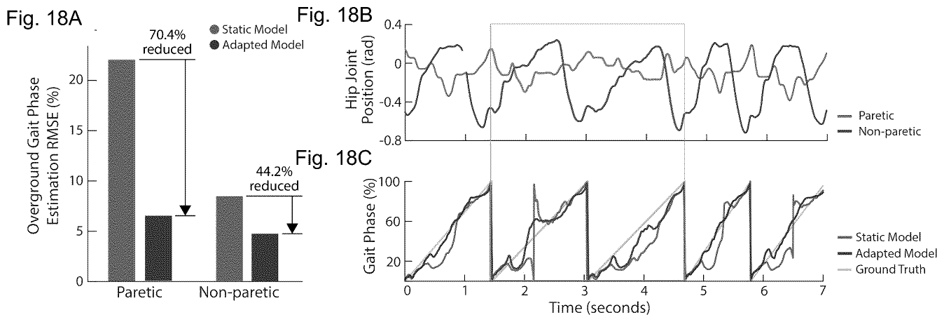

For one of the subjects, we evaluated the final adapted model in an outdoor environment. During the validation trial, the adapted model had an absolute gait phase RMSE of 6.5% and 4.7% for the paretic and non-paretic leg, resulting in a 70.4% and 44.2% lower relative gait phase RMSE than the static model, respectively (FIG. 18A). As shown with the representative subject's time series graph of this trial, poor gait phase estimation is mostly influenced by high step-to-step variations in hip kinematics of the paretic leg, specifically when the subject dynamically changed the walking speed (FIG. 18B). This deviation in the subject's gait pattern caused the baseline static model to falsely detect certain gait events, often generating a suboptimal assistance profile (FIG. 18C).

FIGS. 18A-18C show representative stroke survivor's adaptation performance in an overground validation trial. As shown in FIG. 18A, the adapted model maintained high performance for both the paretic and non-paretic legs during a separate outdoor overground validation trial. FIG. 18B shows a time series graph of the subject's hip kinematics. Greater step-to-step variations in hip joint position were observed in the paretic leg. FIG. 18B shows a gait phase estimation time series graph for the paretic leg during the validation trial. The subject's variations in the gait pattern, due to changes in the subject's walking speed (box), resulted in a substantial performance degradation in gait phase estimation for the static model.

Online Optimization of Exoskeleton Control Parameters in Improving Stroke Gait

To test the effect of our proposed controller in improving the mobility of stroke survivors, we evaluated the performance of our online adaptation framework with the Gait Enhancing and Motivating System (Samsung Electronics, South Korea), a robotic hip exoskeleton designed for restoring impaired locomotor function. In this experiment, we applied human-in-the-loop optimization on a stroke survivor's self-selected walking speed. Using this technique, we further optimized the exoskeleton control parameters, which included bilateral hip flexion and extension peak assistance timing, as described above in reference to FIG. 7.

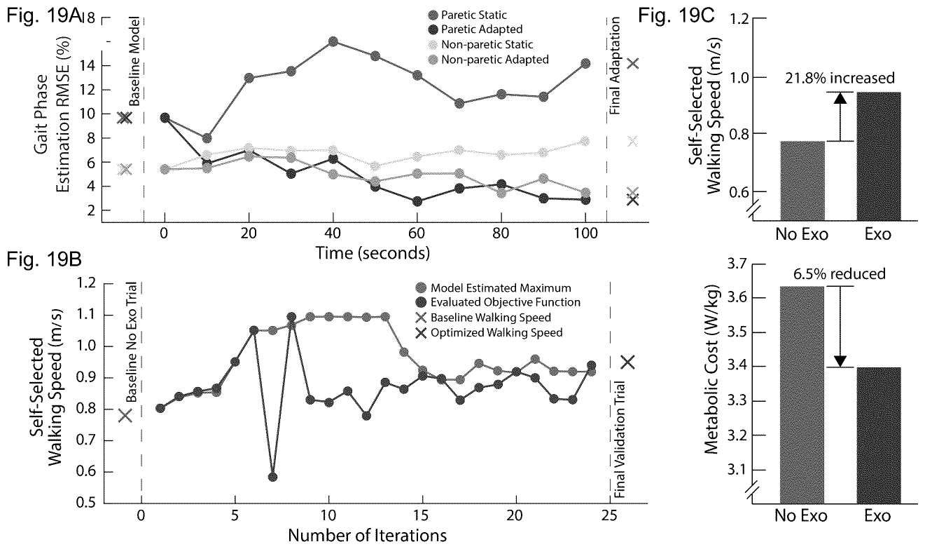

The final adapted model reduced the relative gait phase RMSE by 79.6% from the static model to a final absolute gait phase RMSE of 2.9% for the paretic leg and reduced the relative gait phase RMSE by 55.4% to a final absolute gait phase RMSE of 3.5% for the non-paretic leg (FIG. 19A). Our online validation result showed that the fully optimized system (both gait phase estimation and assistance timing parameters) increased the stroke survivor's self-selected walking speed by 21.8% and reduced the metabolic cost of walking by 6.5% compared to not wearing the exoskeleton (FIG. 19C).

FIGS. 19A-19C show evaluations of integration of gait phase adaptation and control parameter optimization in improving stroke gait. We tested the integrated personalization framework on stroke gait via online gait phase adaptation and control parameter optimization using the Samsung exoskeleton. As shown in FIG. 19A, the online adaptation framework performed reliably, and the final adapted model reduced the gait phase estimation RMSE by 79.6% and 55.4% from the static model for the paretic and non-paretic leg, respectively. As shown in FIG. 19B, using human-in-the-loop optimization, we optimized the exoskeleton's flexion and extension assistance timing based on the subject's self-selected walking speed. As shown in FIG. 19C, using the fully integrated system, the exoskeleton increased the stroke survivor's self-selected walking speed by 21.8% and reduced the metabolic cost of walking by 6.5% compared to not wearing the exoskeleton.

Online Adaptation Framework is Robust to Variations in the User and Environment

Our adaptation results have validated the robustness of our framework in multiple settings, corroborating our hypothesis that the deep learning model can further improve performance by learning user-specific data and personalizing the underlying model parameters to the individual's gait patterns. Although the absolute gait phase error of 1% for able-bodied subjects may appear insignificant, the relative improvement in comparison to the baseline model should be considered. In this study, the baseline model was already a state-of-the-art user-independent model that worked effectively for various healthy individuals. Despite this, our adaptation results demonstrated that the system can still adapt, even with a high-performing baseline model. We think that this improvement would be even more substantial for researchers using our framework with a mediocre-performing gait phase estimator. This is often the case due to limited access to state-of-the-art models.

Moreover, our adaptation framework demonstrated robustness in reliably adapting to the user's gait dynamics in various environmental settings, such as different locomotion modes and walking speeds, highlighting the system's capability to adapt to different environmental conditions. This generalizability was not limited to able-bodied subjects but also extended to clinical populations. This was exemplified in the time series graphs of a representative stroke survivor (FIG. 18C), where our adapted model consistently maintained high estimation performance during an outdoor overground trial, demonstrating its resilience to changes in the walking environment (i.e., speed changes during overground locomotion).

Lastly, our approach was robust to different populations. Kinematic variations in stroke gait (FIG. 18B), such as reduced range of motion and muscle spasticity in the paretic leg, greatly degrade the static model's performance as such patterns were not captured within the original able-bodied training dataset. However, the online adaptation framework not only leveraged the baseline model's gait representations but also quickly learned the new user's gait dynamics in less than a minute of walking. In both the able-bodied (asymmetric gait) and stroke groups, our framework reliably converged to an adapted model and consistently reduced the gait phase estimation error rate on average by 58.6% from the baseline static model (p<0.05). This adaptability and flexibility of our method is a powerful tool for translating the exoskeleton technology to clinical populations where collecting lots of user-specific data for each individual is infeasible. We view this adaptation performance in the clinical population as the most exciting result of our study. We consider the absolute improvement of 8% in gait phase estimation (corresponding to 80% relative improvement) on the paretic side (as shown in FIGS. 17A-17B) to be substantial. To provide a comprehensive explanation, a typical stride duration of an average stroke survivor is roughly 2 seconds (54) and this 8% gait phase estimation error corresponds to 160 ms. Previous literature has emphasized the importance of assistance timing in exoskeleton control and a constant 160 ms error (either leading or lagging) in timing can have a significant impact on the overall human outcome measures, such as an increase in the user's metabolic cost.

Viability of Using an Adaptable Framework in Improving Stroke Gait

Literature has indicated that optimal assistance strategy (e.g., magnitude and timing) varies across users. For able-bodied subjects, this exoskeleton performance benefit can range up to, in the context of the metabolic cost of walking, 18% if the selected assistance profile is suboptimal. Recently, the field has started to adopt this optimization scheme in exploring optimal exoskeleton assistance levels for stroke gait. Human-in-the-loop optimization is a popular, yet powerful, method that directly integrates the user's feedback into the control parameter optimization process. While it was a single-subject validation, we want to highlight that completing the personalization exoskeleton framework includes mid-level control parameter optimization. Our exciting results of improving the stroke survivor's mobility by increasing the walking speed (21.8%) and reducing the metabolic cost of walking (6.5%) paved a promising direction. In the final part of our study, we aimed to test the feasibility of integrating mid-level control parameter optimization in our online adaptation framework with clinical populations. Specifically, we conducted pilot testing on a stroke survivor, as there was a lack of understanding in the current field regarding the application of human-in-the-loop optimization in clinical populations. Although an N=1 pilot experiment, we wanted to demonstrate the feasibility of synergizing our adaptation approach with a standard human-in-the-loop optimization which has produced promising results. However, future work should fully validate this integrated system by conducting large-scale clinical studies. Some potential research directions relating to this would include determining the objective function (metabolic cost vs. walking speed) and optimizing other control parameters (assistance magnitude vs. timing). We think that our high-level online adaptation and mid-level controller optimization contribute to the same goal of personalizing the exoskeleton system to a new user. These two layers, interlinked and dependent on one another, created a fully stacked personalization framework, significantly contributing to maximizing the user's gait performance as the system organically adapts and learns the user's gait pattern over time.

Feasibility of Generalizing the Online Adaptation Framework to Other Applications

A great advantage of our framework is its generalizability to other applications. This personalization framework is transferrable to other high-level user state variables beyond gait phase. As long as the variable can be reliably reconstructed post-hoc, then an adaptation framework such as this one can be used. For example, we have demonstrated this works for walking speed and locomotion mode but could be extended to other state variables such as ground slope estimation, extending the framework to other ambulation contexts beyond level-ground walking. Our user-independent gait phase system is agnostic to locomotion modes such as stairs and ramps due to our unique training strategy allowing it to seamlessly integrate with these other strategies in the future. Since backward labeling in these other modes is feasible, the framework can maintain reliable adaptation performance in these settings. However, during multimodal adaptation, care should be taken to ensure distributed learning across multiple types of ambulation (i.e., to prevent catastrophic overlearning). One potential solution to achieve balanced learning is by binning newly acquired gait data into different classes (e.g., level-ground vs. ramp descent) and updating the model with a balanced gait data matrix at every update sequence. In cases where there is no recent data available for a particular class, previously acquired data can be repeated.

Another unique feature of our framework is its ability to transfer the model across physical hardware. In this study, we demonstrated the ability to transfer the gait phase model across devices by simply applying a transformation to the incoming data stream. However, this sensor data transformation was applied to exoskeletons targeting the same joint. To expand this framework to a new joint, a new set of baseline training data needs to be collected one time, but then similar transformations can be created to transfer between hardware. Regarding other joints, one scenario that needs be considered is the use case of multi-joint exoskeleton control (e.g., hip and knee joints). In this case, the performance of our model will not be affected unless the assistance provided at the other joint significantly alters the user's hip kinematics. However, such cases are rare, as indicated by our previous study which showed that excessive assistance that modifies the user's nominal joint kinematics can have a negative impact on the overall human-exoskeleton performance. Since the primary objective of exoskeleton control is to provide assistance that enhances human outcome measure, excessive assistance is unlikely to occur. This indicates that our baseline gait phase model performance should be maintained even if an additional degree-of-freedom is added to the exoskeleton structure.

Lastly, our online adaptation framework showcased its ability to adapt to users in clinical populations. For this study, there was no a priori neurologically impaired individuals or user-specific tuning of the gait phase model or adaptation framework before implementing the system for stroke survivors. This generalizability indicates that it would be feasible to target different populations, such as aging gait or other neurological injuries, such as cerebral palsy.

Laboratory-Based Optimized Controllers Limit the Translation of Exoskeleton Technology to the Real World

Our research findings have shown the feasibility of translating the exoskeleton technology to the real world. For example, the outdoor overground validation trial with the stroke survivor showcased the viability of using our framework in a real-world setting. Based on this result, we believe that future research moving forward should focus on rigorous testing and validation of our framework in outdoor settings. The past decade of exoskeleton literature explored the fundamental understanding of an effective assistance strategy during locomotion. While significant improvements and findings have directed researchers in advancing the state of exoskeletons systems, more researchers need to move outside of the laboratory environment and into the real world for meaningful advancement in the field to continue. We think the next decade will focus on bridging the gap between foundational knowledge and translational research. Our framework provides a solid underpinning in this cause, enabling exoskeleton technology translation as unexpected locomotor scenarios and users can easily be accommodated with our adaptable method. Our research findings provide significant scientific and technological contributions to the field, starting a broader movement of taking exoskeletons into the real world for improving the mobility of diverse populations.

### Experimental Protocol

The study consisted of 4 experimental protocols to validate the performance of our online adaptation framework: 1) experiment with 8 able-bodied individuals walking on a treadmill, 2) experiment with three able-bodied individuals walking on a split-belt treadmill, 3) experiment with six stroke survivors walking on a treadmill, and 4) experiment with one stroke survivor walking on a self-paced treadmill. For experiments 1 and 4, we included a separate online validation trial to evaluate the performance of the adapted gait phase model.

For experiment 1, each participant was asked to walk on a standard treadmill (Tuff Tread, TX) at a walking speed of 1.2 m/s while wearing our robotic hip exoskeleton. The exoskeleton controller utilized the static model for gait phase estimation. During walking, the exoskeleton provided bilateral hip flexion and extension assistance using a controller that provided a biological torque profile. As the participant acclimated to the exoskeleton, we gradually increased the assistance magnitude. The magnitude was targeted to the maximum level without causing any discomfort (e.g., mechanical play around the user interface) to the user. To ensure that ample magnitude was provided to each user, a magnitude threshold was set to a minimum of 6 Nm. Immediately following this acclimation phase, the online adaptation framework was applied by toggling a keyboard input from a separate experimental computer. During the adaptation phase, the gait phase model weights were updated every 5 seconds. The adaptation was applied for a minimum of 10 iterations with a stopping criterion of 2% convergence bandwidth (gait phase error not changing more than 2%). After the adaptation trial, a one-minute validation walking trial was performed using two different gait phase models (static and adapted). During this experiment, we recorded the estimated gait phase, hip joint position, and applied joint torque.

Experiment 2 had a similar walking protocol, except participants were asked to walk on a split-belt treadmill (Bertec, OH), operating with different belt speeds, simulating an asymmetric gait environment. The treadmill's left and right belt speeds were set differently (0.8 and 1.6 m/s) for all three subjects. All other protocol details were the same as experiment 1, such as the acclimation and the adaptation phase.

For experiment 3, six stroke survivors participated in a similar walking protocol as experiment 1. For the stroke group, since each participant had a different self-selected walking speed, we used an overground walkway (Zeno, ProtoKinetics, PA) to compute the participant's baseline walking speed of not wearing the exoskeleton. The treadmill speed was set to 80% of each participant's self-selected overground walking speed. Similar to the previous experiments, we used the same exoskeleton controller for providing bilateral assistance, where the maximum assistance magnitude was set to 6 Nm. During the acclimation phase, we increased the assistance magnitude incrementally where the assistance level for the paretic and non-paretic legs was set asymmetrically based on the participant's comfort and on-site clinician's observation of the overall gait quality. Gait quality was observed for the following: 1) congruity between the subject and device movement, 2) the presence of any new inappropriate gait deviations, 3) the reduction of existing gait deviations, and 4) improvement in symmetry and swing phase clearance. Following the acclimation phase, we performed an adaptation trial where the minimum number of iterations and stopping criteria were set equal to experiment 1. For one subject, we performed an outdoor overground validation walking trial to validate the performance of our adapted model.

For experiment 4, a single stroke survivor was asked to walk on a treadmill while wearing the Samsung GEMS hip exoskeleton. For this experiment, the treadmill was controlled with a self-paced mode using the real-time position of a motion capture marker (Nexus 2.12, Vicon Motion Systems, UK). To ensure the safety of the participant, the speed range of the self-paced treadmill was set to ±50% of the participant's baseline self-selected walking speed from the overground walkway. For the initial adaptation trial, the same protocol was taken as experiment 3. After the adaptation trial, a controller parameter optimization trial was performed where the exoskeleton assistance timings (onset and offset bilaterally) were parameterized through a Bayesian optimizer (FIG. 7) where the objective function was set to the participant's self-selected walking speed based on the self-paced treadmill. A total of 24 iterations (one minute each) of optimization were applied where a break was enforced after every 6 iterations. Once the optimization was completed, we evaluated the personalized exoskeleton (adapted gait phase model+optimized controller parameters). Two validation trials were conducted: 1) self-selected walking speed and 2) metabolic cost of walking. For the walking speed trial, the participant walked on the same self-paced treadmill (2 minutes each) with and without the exoskeleton. For the metabolic cost trial, the participant walked on a constant speed treadmill (speed set to the baseline walking speed) for 6 minutes with and without the exoskeleton. During each condition, the participant's metabolic cost was measured using an indirect calorimetry system (K5, COSMED, Italy).

Deployment of a User-Independent Gait Phase Estimator to an Exoskeleton System

To integrate the online adaptation framework 606 in the high-level control layer 60, we designed a deep convolutional neural network-based user-independent gait phase estimator. This gait phase model was trained using a dataset from 10 able-bodied subjects (different group from this study) navigating through 5 different locomotion modes (level-ground, ramp and stair ascent/decent). The fully trained model estimated the user's current gait phase based on kinematic input from on-board exoskeleton sensors. Input sensor data were joint position and angular velocity from bilateral hip encoders and 3-axis linear acceleration and gyroscopic data from an inertial measurement unit located at the sacrum. While a standard representation of gait phase utilizes heel contact (0%) as a deterministic gait event, we used the maximum hip extension position as the start of the gait cycle, which roughly corresponds to a toe-off event. This approach was specifically selected as we wanted to only leverage sensors native to the exoskeleton system (e.g., heel contact detection requiring a foot switch). Using a local peak detection method, we linearly interpolated local hip extension points from 0% to 100%. A detailed hyperparameter sweep and optimization of the proposed gait phase estimator are presented in the Supplementary Materials.

Biological Torque Controller for Torque Assistance

We utilized a biological torque controller in the mid-level layer in the exoskeleton that commands an assistance profile as a function of the gait phase. This controller generated smooth and continuous hip flexion and extension joint torque envelopes during the phase in line with the human biological joint demand. To generate the assistance profile, we used a Piecewise Cubic Hermite Interpolating Polynomial spline function dependent on gait phase where the nodes of this curve represented different control parameters, such as assistance timing and magnitude. For the timing parameters, we used values shown to have the largest metabolic cost benefit in able-bodied subjects from the literature with additional fine-tuning from a separate pilot experiment. During real-time exoskeleton control, the biological torque controller employed the estimated gait phase to generate a target torque, and safety measures have been implemented to ensure that the provided assistance is in the intended direction of the user's movement. Specifically, if the estimated gait phase value was lower than the previous estimate, the previous value was repeated to prevent any reversal of the system.

Self-Selected Walking Speed-Based Human-In-the-Loop Optimization

To further optimize exoskeleton control parameters, we implemented a Bayesian human-in-the-loop optimization (FIG. 7). Different from a conventional approach, we used the user's self-selected walking speed as the evaluating cost function. The four control parameters for optimization were bilateral peak flexion and extension assistance timing. To ensure that the high-level gait phase adaptation and mid-level controller parameter optimization do not counteract each other, we conducted the adaptation/optimization experiment sequentially. We first performed our online adaptation of the stroke survivor's gait phase using a generic assistance profile (same as the one for able-bodied subjects). Once the adaptation was completed, we locked the neural network model weights. Afterward, we carried out the parameter optimization process using this adapted gait phase model. For the first iteration, the general timing parameters (optimized based on able-bodied subjects) were evaluated. At the end of each iteration (one minute each), the participant's walking speed was evaluated by taking an average speed from the last 15 seconds of data. During this evaluation phase, the optimization updated the cost landscape (axis representing each control parameter) using Gaussian processes. Based on the updated landscape, the next sampling parameters were chosen by maximizing the expected improvement. After a total of 24 iterations, we stopped the optimization process and selected the final optimized control parameters to be evaluated. The processes (including the self-paced treadmill) were operated on a host computer (Matlab 2019b, MathWorks, MA) adjacent to the treadmill.

Data Analysis

For the validation trial, gait phase RMSE was calculated from one minute of walking data. RMSE is a popular evaluation metric in the field, compared to other metrics such as mean absolute error, as it is more sensitive to outliers and allows for a greater penalty on larger errors than smaller estimation errors. Additionally, the use of RMSE as a commonly used evaluation metric for gait phase estimation allows for easy comparison of our model performance across many studies analyzing gait phase estimation error with varying techniques. For each walking condition (static and adapted), we computed the ground truth using the hip joint position for each leg and evaluated the error from the last 10 gait cycles. Similarly, we calculated the joint torque RMSE for the validation trials. The metabolic cost trial consisted of three conditions where we recorded the user's respiratory data: 1) quiet standing, 2) walking without the exoskeleton, and 3) walking with the exoskeleton. For each condition, we calculated the user's metabolic cost from the last 2 minutes of oxygen and carbon dioxide rates using a modified Brockway equation. The reported metabolic cost from the experiment was the user's net metabolic cost where we subtracted the quiet standing metabolic cost from each corresponding condition.

Device-to-Device Transform of IMU Data

Different exoskeleton designers often locate and orient sensors differently, which is a common limiting factor for deep learning-based models in the existing paradigm, making them susceptible to shifts in sensor data. Due to the limited physical measurement information provided by most commercially available devices, calculating the geometric relationship between sensors in different exoskeleton systems is impractical, further complicating the issue. As a result, changes to sensor data content historically require new labeled data to be collected to retrain state estimation models, significantly limiting the transferability and accessibility of deep learning-informed exoskeleton control. In this study, we introduce a unique approach for transforming sensor data across devices, eliminating the need to retrain the state estimators before deployment on a new device (as described above with reference to FIG. 6C). Specifically, by optimizing a transformation using 10 strides of data from a single subject, we were able to transform incoming sensor data to a new coordinate system, enabling the transfer of our existing gait phase model to a new device. This was the first time a deep learning model used for exoskeleton control has been transferred across devices, representing a step in improving the accessibility of exoskeletons in the real world.

In this study, we trained a preliminary version of the hip moment estimator based on the nine-participant dataset collected as described above. This allowed the joint moment-informed controller of our study to be deployed immediately (i.e., without having to collect additional training data using alternative control strategies). The preexisting dataset was collected using the Gait Enhancing and Motivating System (GEMS), an autonomous robotic hip exoskeleton designed to provide sagittal plane hip assistance (Samsung, South Korea). The dataset included ground truth joint moments of the user during overground walking with time-synced exoskeleton sensor data measured from an integrated pelvis inertial measurement unit (IMU), integrated actuator encoders, and two IMUs custom-mounted on the thigh struts. Thus, the dataset included the same sensor modalities as those of our custom hip exoskeleton but the positions and orientations of the IMUs are inconsistent between the two devices. Since the GEMS and our custom hip exoskeleton fit the user differently, we did not assume transformations between the IMUs of the GEMS and the IMUs of our custom hip exoskeleton could be measured directly. Further, the example position and orientation of the GEMS pelvis IMU was unknown since it was mounted internally in the pelvis support structure. Instead, we optimized a rotation matrix (^{E1}\hat{R}*^{E2}) and position vector (^{E1}\hat{p}*_{E2E1}) mapping the coordinate system of each GEMS (EXO2) IMU to that of our custom exoskeleton (EXO1) using the device-to-device IMU transfer.

In this study, we introduce an algorithm to optimize a transformation between sensors of different exoskeleton devices or wearable sensor suites without the need for any assumptions about sensor orientation or position a priori aside from the knowledge that the sensors to be aligned were mounted on the same body segment when donned. Our approach used the kinematic trajectories of the exoskeleton sensor data collected during two 10-second-long walking trials (one trial per exoskeleton) to optimize a transformation between the sensors from each device. This allowed the sensor calibration from one device to another to be completed in one-shot (i.e., only done one time for a new exoskeleton) and did not require the subject to assume any specific calibration poses aside from their normal gait, maximizing the similarities in the sensor data between the two trials. By applying this transformation to the incoming data stream, user state estimators (e.g., a gait phase estimator) can be transferred across devices without the need to retrain the model to accommodate the sensor locations of the new device (i.e., without needing to collect a device-specific labeled dataset).

We evaluated our approach when transferring the static gait phase estimator trained on data from one device (EXO1), such that it was compatible with a completely new device (EXO2). Specifically, we optimized a rotation matrix and position vector to map incoming pelvis IMU measurements from EXO2 into the EXO1 coordinate system before inputting the data to the baseline gait phase estimator. Using a transformation optimized using 10 strides of data from a single subject, we were able to transform incoming pelvis inertial measurement unit (IMU) data from EXO2 to that of the original EXO1 coordinate system, enabling the transfer of our deep learning model to a secondary device. Thus, this was the first time a deep learning estimator used for exoskeleton control has been transferred across devices, representing a step in improving the accessibility of these effective models for generalizable exoskeleton control. Further, while we evaluated our transformation strategy using pelvis-mounted IMU data for a gait phase estimator, this approach could easily be applied to models trained to estimate alternative gait states or to other sensors by modifying the optimized variables.

In an example, one participant (Participant AB01, male, height of 1.77 m, body mass of 66.1 kg, and age of 29 years) walked on a treadmill at 1.3 m/s in EXO1 and EXO2 with assistance turned off while exoskeleton sensor data was recorded. To further improve the similarity in joint kinematics between the two conditions, the participant was asked to match his step cadence to a 110 bpm metronome. Ten seconds of exoskeleton sensor data from EXO1 and EXO2 were then collected in sequence and synced in time with each other by aligning the peak hip extension joint angle measured by the right-side hip actuator encoders. The resulting accelerometer and gyroscope data of EXO1 and EXO2 (i.e., A_{E1}, A_{E2}, G_{E1}, G_{E2}, respectively) were filtered using a zero-lag 5th order lowpass filter with a 20 Hz cutoff frequency to remove high frequency noise that would disrupt the similarities between the EXO1 and EXO2 IMU signals. The accelerometer data (A) and gyroscope data (G) were structured with the form described above with reference to Equations (4) and (5), in which the x-, y-, and z-axes of the sensors are represented in each row and N represents the total number of timesteps in the sequence. To align the EXO1 and EXO2 IMU data, we first defined the R^{6×1} vector Z, which was comprised of three Euler angles (\hat{θ}, \hat{ϕ}, \hat{ψ}) and the position vector (\hat{p}) as described in Equation (6) where the estimated rotation matrix (^{E1}\hat{R}^{E2}) was computed from the three Euler angles as described in Equation (7)

Using the estimated rotation matrix, the EXO2 gyroscope data was transformed into the EXO1 coordinate system as described in Equation (13).

Similarly, the EXO2 accelerometer data was transformed into the EXO1 coordinate system based on rigid body kinematics as described in Equation (14), in which the angular acceleration of the EXO2 IMU in the EXO1 coordinate system (\hat{α}_{E1}) was computed as described in Equation (15).

From this formulation, the vector Z* was optimized to minimize the mean-squared error (MSE) between the EXO1 and transformed EXO2 gyroscope data (\tilde{G}) and the MSE between the EXO1 and transformed EXO2 accelerometer data (Ã) as described in Equation (8), such that Equation (9) is satisfied, where the MSE along each perpendicular axis of the gyroscope (\tilde{g}ᵢ) was computed as described in Equation (10) and such that Equation (11) is satisfied, where the MSE along each perpendicular axis of the accelerometer (\tilde{α}ᵢ) was computed as described in Equation (12).

Using the time-aligned EXO1 and EXO2 IMU data, we optimized a unique rotation matrix and position vector for each IMU using the fmincon( ) function in MATLAB and the constraints shown in Table 3. The upper and lower bounds of each optimization variable used to transform the inertial measurement unit data are provided.

TABLE 3

| Variable | Lower Bound | Upper Bound |
|---|---|---|
| \hat{θ} | −π rad | π rad |
| \hat{ϕ} | −π rad | π rad |
| \hat{ψ} | −π rad | π rad |
| \hat{p}ₓ | −1 m | 1 m |
| \hat{p}_{y} | −1 m | 1 m |
| \hat{p}_{z} | −1 m | 1 m |

After transforming the EXO2 gyroscope data using Equation (13), the optimized alignment RMSE compared to the EXO1 data was 0.35, 0.42, and 0.17 rad/s (compared to 2.13, 2.24, and 0.33 rad/s without transforming the data), for the left thigh, right thigh, and pelvis IMUs, respectively. Similarly, after applying the optimized transformation to the EXO2 accelerometer data using Equations (14) and (15), the alignment RMSE of the accelerometers was reduced to 2.26, 2.86, and 0.90 m/s² (compared to 12.50, 13.23, and 8.80 m/s² without transforming the data) for the left thigh, right thigh, and pelvis IMUs, respectively. Thus, by optimizing a rotation matrix and position vector to align each of the IMUs from the original dataset with those of our custom hip exoskeleton, the sensor data could be used for training the TCN as if it was collected from our device.

Evaluation of IMU Transformation Accuracy

To evaluate the accuracy of our IMU transformation, two able-bodied subjects (2 males, height of 178 and 183 cm, body mass of 70 and 78 kg, and age of 30 and 28 years) participated in a validation trial after providing informed consent to the protocol approved by the Georgia Institute of Technology Institutional Review Board. Each subject walked on a split-belt treadmill at 1.3 m/s (Bertec, OH) while wearing two different exoskeletons, the Gait Enhancing and Motivating System (Samsung Electronics, South Korea) (EXO1) and our custom robotic hip exoskeleton (EXO2). To promote similar lower-limb kinematics between the two conditions, the exoskeletons did not provide assistance during the trials and the subjects' step frequency was constrained to 110 bpm by using a metronome. During each walking bout, the exoskeleton recorded right and left hip joint positions and velocities using actuator-mounted encoders and accelerometer and gyroscope data from a pelvis-mounted IMU at 200 Hz. Using the data from each subject, 10 consecutive strides of data collected from EXO1 and EXO2 were aligned in time based on the right leg's peak hip extension joint position. The data were also truncated such that the 10 strides of data from EXO1 and EXO2 were of equal length. Finally, the resulting pelvis-mounted IMU data were filtered using a zero-lag 5^{th} order lowpass filter with a 20 Hz cutoff frequency to remove differences in high frequency noise between the two sensors.

Using the time-aligned data from each subject, a unique pelvis IMU transformation (i.e., \hat{R}* and \hat{p}*) was optimized using the approach described above. We ran the optimization using the constrained optimization function, fmincon, in MATLAB with the constraints presented in Table 3. Using the resulting transformation from Subject 1, the root-mean-square error (RMSE) between the IMU data of EXO1 and EXO2 was computed under three conditions: 1) without transforming the EXO2 data (i.e., the reconstruction error without transforming the EXO2 data); 2) by transforming the EXO2 data into the EXO1 coordinate system using the optimized transformation from the same subject (i.e., the reconstruction error directly resulting from the transformation optimization); and 3) by transforming the EXO2 data into the EXO1 coordinate system using the optimized transformation from the alternative subject (i.e., the reconstruction error when applying the optimized transformation on data from the withheld subject). This analysis was then repeated using the transformation computed from Subject 2's data.

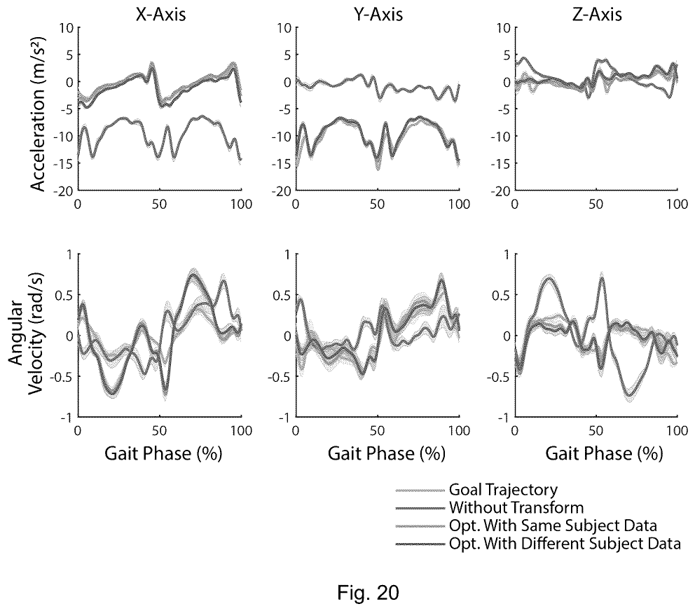

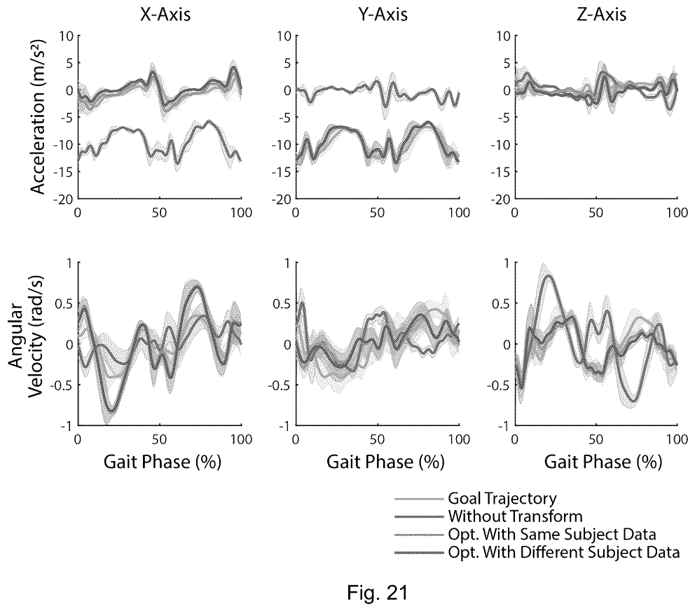

The stride-averaged results of the pelvis IMU transformation for Subjects 1 and 2 are shown in FIGS. 20-21, respectively.

FIG. 20 shows stride-averaged pelvis IMU data from Subject 1. The resulting accelerometer and gyroscope data from the pelvis-mounted IMU of EXO2 recorded from Subject 1 is shown. The red curves show the EXO2 data before transforming the data. The blue curves show the EXO2 data after realignment using the optimized transformation from Subject 1's data. The purple curves show the EXO2 data after realignment using the optimized transformation from Subject 2's data. Additionally, the green curves depict the pelvis-mounted IMU data from Subject 1 wearing EXO1 (i.e., the goal trajectory for the optimization). The shaded regions represent ±1 standard deviation.

FIG. 21 shows stride-averaged pelvis IMU data from Subject 2. The resulting accelerometer and gyroscope data from the pelvis-mounted IMU of EXO2 recorded from Subject 2 is shown. The red curves show the EXO2 data before transforming the data. The blue curves show the EXO2 data after realignment using the optimized transformation from Subject 2's data. The purple curves show the EXO2 data after realignment using the optimized transformation from Subject 1's data. Additionally, the green curves depict the pelvis-mounted IMU data from Subject 2 wearing EXO1 (i.e., the goal trajectory for the optimization). The shaded regions represent ±1 standard deviation.

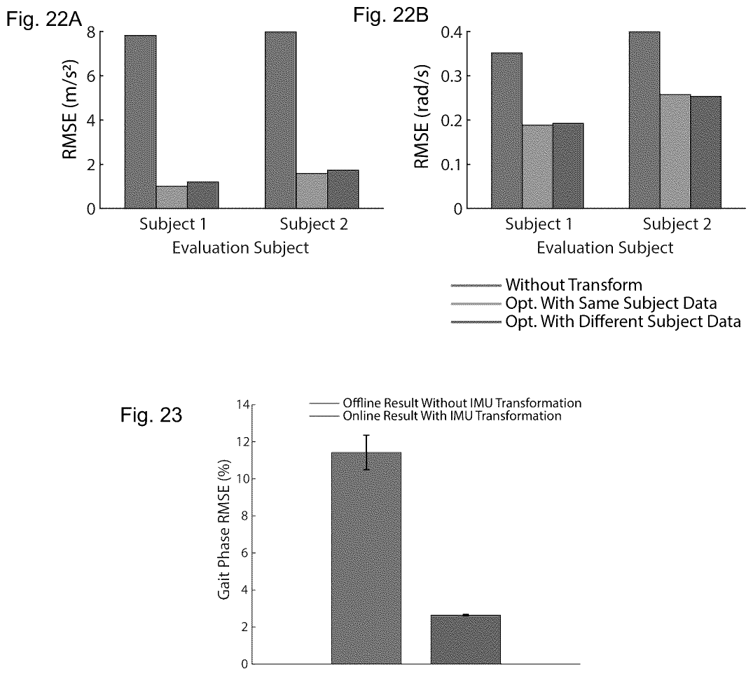

In general, implementing the pelvis IMU transformation reduced the reconstruction error for the accelerometer and gyroscope EXO2 data by 6.53 m/s² (82.6%) and 0.15 rad/s (40.6%), respectively, with respect to the EXO1 data (FIGS. 22A-22B). Additionally, the reconstruction error of the transformed IMU data when optimized on a different subject was similar to that of optimizing the transform on the same subject, with an average increase in the accelerometer reconstruction error of 0.17 m/s² and a decrease in the gyroscope reconstruction error of 2×10-4 rad/s, respectively. In general, optimizing the rotation matrix and position vector to transform the pelvis IMU from EXO2 into the EXO1 coordinate system substantially improved reconstruction error for the accelerometer and gyroscope data. Further, we found that applying an optimized transformation to data collected on a new subject had little impact on the overall reconstruction error. This suggests that the optimized transformation can be computed in one-shot, without the need to reoptimize with a new exoskeleton user.

FIGS. 22A-22B show the resulting RMSE for the accelerometer data (FIG. 22A) and gyroscope data (FIG. 22B) is shown relative to the EXO1 data without a transformation (first bar), with a transformation optimized using the same data (second bar), and with a transformation optimized using the data from the alternate subject (third bar).

Online Gait Phase Estimation Using a Robotic Hip Exoskeleton

To analyze our strategy for transferring the gait phase estimator to a new hip exoskeleton, three subjects, (2 males and 1 female, mean height of 177.8±4.4 cm, mean body mass of 67.3±10.8 kg, and mean age of 20.3±1.2 years), walked in EXO2 on the split-belt treadmill at 1.2 m/s for two minutes after providing informed consent. The exoskeleton provided sagittal hip assistance based on a predefined spline profile, which computed the desired exoskeleton torque as a function of instantaneous gait phase with a peak assistance of 7 Nm (both flexion and extension). The user's gait phase was computed online using the static gait phase estimator trained using data from EXO1 implemented on a separate onboard coprocessor (Jetson Nano, Nvidia) as described above; however, since the neural network was trained on EXO1 data but deployed on EXO2 data, the incoming stream of pelvis accelerometer and gyroscope data was first transformed into the EXO1 coordinate system before being input to the neural network using Equations (13) and (14) with the rotation matrix and position vector optimized from Subject 1.

During each trial, the exoskeleton recorded the hip encoder position and velocity, accelerometer and gyroscope data from the pelvis-mounted IMU, and online estimates of the users' instantaneous gait phase at 200 Hz. After the experimental protocol was completed, the gait phase estimator was then implemented offline on the recorded data without applying the optimized transformation to the IMU data, which served as a baseline condition to compare the optimized transformation. We did not test the gait phase estimator online without the transformation since it would have provided nonsensical torque assistance, which could be uncomfortable or dangerous for the user and would likely propagate gait phase estimator error far beyond the purely mathematical error resulting from an incorrect transform. The error resulting from the online, transformed and offline, untransformed gait phase estimator implementations was then computed as the RMSE between the ground truth and estimated gait phase over the two-minute trial.

As shown in FIG. 23, the resulting RMSE of the online gait phase estimator when implemented on a new exoskeleton was 2.65%. This resulted in a 76.8% reduction in gait phase RMSE relative to implementing the neural network on EXO2 without transforming the IMU data. Further, we found that the gait phase estimation error, when deployed on the new exoskeleton (EXO2), was comparable to the results described above, which deployed the gait phase estimator on the same device from which it was trained (EXO1). Thus, our results demonstrated that by optimizing the IMU transformation using 10 strides of unlabeled data from each exoskeleton, the convolutional neural network was able to maintain model accuracy, even when implemented on a new never-before-seen exoskeleton with a different fit, IMU model, and IMU placement compared to the initial device. This work presented a first in deep learning-enabled exoskeleton control, demonstrating the possibility to transfer models across devices without the need to recollect any labeled training data for the model, greatly decreasing the barrier-to-entry for enabling deep learning-based control on new exoskeleton devices.

Operation of Online Adaptation Framework

There are several technical features to be considered in developing the online adaptation framework 606: 1) ensuring no data loss in the real-time sensor data buffer, 2) robust backward labeler for ground truth labeling, 3) optimizing model parameters for a single cycle training, and 4) parallelizing adaptation and inference via multiprocessing.

Data Communication

During real-time inference, a new set of sensor data from onboard sensors is streamed into a data queue buffer (buffer size greater than the model's input window size). During this process, a potential signal loss can generate anomalies in data, which can cause biased learning, leading to model overfitting. To ensure zero data drop, we employed a universal asynchronous receiver-transmitter communication protocol via the internet protocol suite over a standard ethernet cable between the high-level coprocessor and the exoskeleton microprocessor. From here, the data buffer size is systematically swept to guarantee reliable model training while not causing significant overhead in memory storage.

Backward Labeler

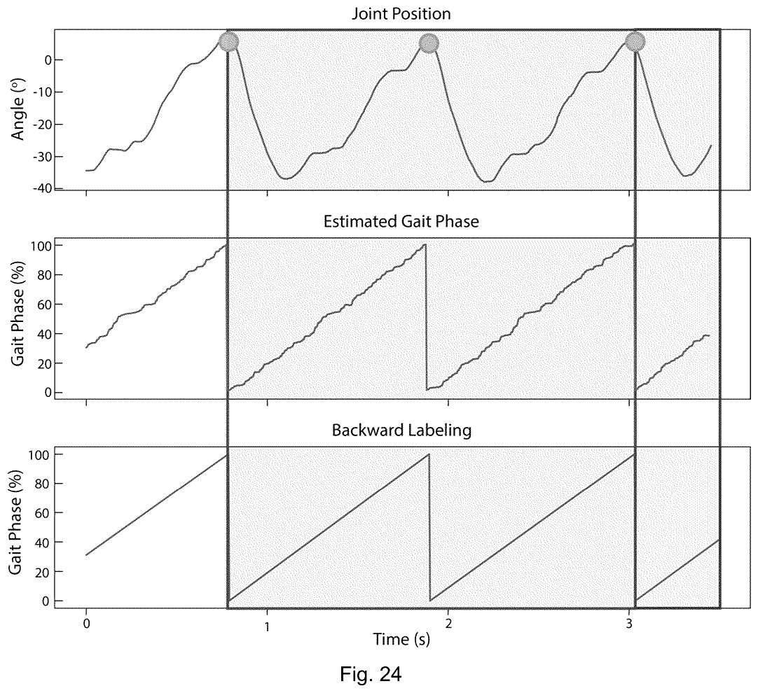

When the data buffer became full, we retroactively generated ground truth labels using an autonomous backward labeler (FIG. 24). FIG. 24 shows backward labeling of the user's gait phase. During the online adaptation phase, the user's maximum hip extension position (noted with circles) was detected using a local peak detector. From these points, a new set of gait phase labels was generated by linearly interpolating gait phase from 0% to 100%. Note that data from the last gait event to the end of the buffer cannot be correctly labeled. This segment of data was concatenated to the following data buffer and utilized in the next round of adaptation. We utilized a local peak detector on the user's hip joint position for ground truth labeling. To ensure robust peak extraction, we heuristically tuned the detector's parameters, such as prominence, based on the data distribution exhibited in our locomotion dataset. However, detecting local peaks in a patient population can be challenging, as there may be multiple fluctuations during a single gait cycle.

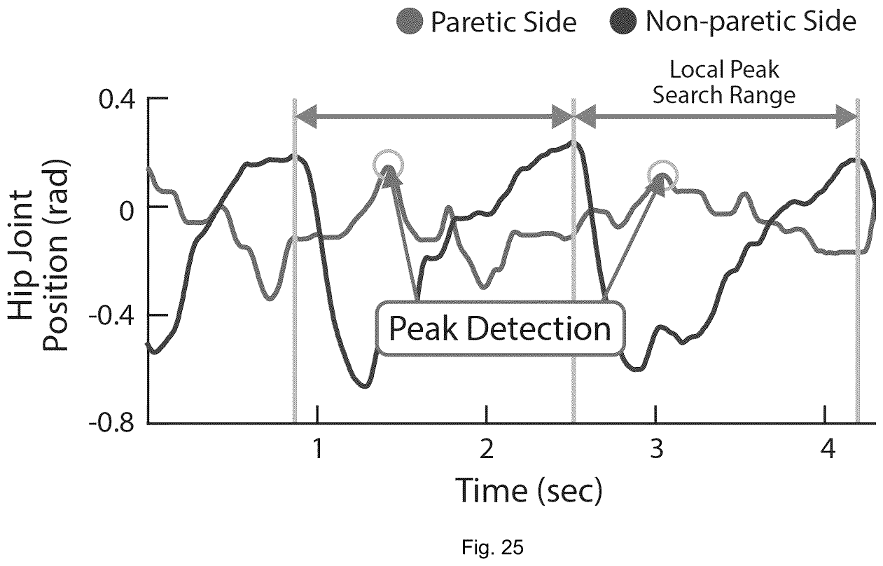

To mitigate potential errors, we restricted the range in which we search for local maximum values on the paretic side by analyzing the segmented data of the contralateral leg, as the peak detection performance of the non-paretic leg is comparable to that of an able-bodied individual (FIG. 25). FIG. 25 shows a time series graph illustrating the application of a peak detection algorithm in stroke gait. To ensure a robust local peak detection for the paretic side (lighter), a local maximum peak search range was constrained within the range of the contralateral leg's gait cycle (represented with two bars). This approach minimized potential errors and increased the reliability of peak detection on the user's paretic leg.

By utilizing this segmented gait cycle data, the search for local peaks on the patient's paretic side became significantly more reliable. Furthermore, in the case of stroke gait, these unreliable peaks tend to occur during the swing phase of the gait cycle. Therefore, we found that locating the first local peak on the paretic side following the non-paretic side's toe-off event was a robust approach for this population. A phenomenon to note during ground truth labeling was the limitation in labeling gait phase on data from the last gait event to the end of the buffer (cannot interpolate properly). To minimize data loss, this segment was loaded to the following buffer and utilized in the next adaptation cycle. The gait phase model described above was a single network with four outputs (left and right gait phase in x and y Cartesian coordinates). To implement the online adaptation framework to this architecture, a bilateral ground truth label was used. However, due to the labeling technique in the last part of the buffer, bilateral labeling was impractical due to the asynchronous nature of gait events across both legs causing significant loss in data (truncation to match the overall input data shape). To bypass this, we applied a unilateral gait phase model for each leg with minimal performance degradation compared to the model with bilateral architecture.

Single Epoch Training

At every adaptation cycle (for this study, 5 seconds), we online adapted the baseline gait phase model via single epoch training using this ground truth labeled data (Algorithm 1). To ensure that the model can adapt reliably to a small amount of data, we hyperparameter swept the learning rate and the optimizer based on a preliminary offline experiment using exoskeleton data. One feature to consider during this online adaptation is to freeze any existing batch normalization layers in the architecture. Generally, adding a normalization layer to the network improves the overall performance as the layer can stabilize the input data via re-centering and re-scaling. However, if the layer is not locked during adaptation, the normalization statistics can be changed based on the buffer data, which can lead to performance degradation. After the adaptation cycle, the adapted model was transferred to the real-time inference module.

Parallel Processing

Speed of inference was a significant characteristic targeted during this algorithm design. This is because delayed state estimation can result in phase lag in assistance provided by the exoskeleton and thus would result in very poor performance during ambulatory tasks. To combat this, we employed parallel processing to reduce latency as much as possible. We used 3 processes, one for data input and output, one for model inference, and the last for model adaptation. The data input and output thread were singularly responsible for communication with the exoskeleton and would block waiting for the new sensor data which was sent from the robot at a synchronous rate of 200 Hz. The newest data was passed to the inference process which immediately queried the model for the state estimate, taking less than 0.005 s (capable of 200 Hz operation) and the estimate was sent back to the main processor. Only when gait events were detected would the third process run, training on the newest strides of data, but since this process was separated from the inference process the real-time inference speed was maintained. Training time took approximately 0.6-0.8 seconds per stride, meaning training time was faster than the necessary 0.2 Hz.

Offline Performance Validation and Generalization to Other State Variables

Prior to deployment to a physical system, we validated offline our adaptation framework to ensure that the developed algorithm could reliably adapt to the user. Furthermore, during this validation period, we tested the generalizability of our framework to other user state variables, such as the user's walking speed. 11 subjects (11 males and 1 female, mean height of 1.80±0.05 m, mean body mass of 72.5±4.98 kg, and mean age of 23.1±1.7 years) were recruited for data collection after providing informed consent. The subjects were asked to walk on a treadmill (Bertec, USA) with walking speeds ranging from 0.3 m/s to 1.2 m/s with a 0.1 m/s increment (one minute of walking per speed condition) for a total of 10 minutes while wearing a robotic hip exoskeleton. This varying speed profile was specifically chosen to mimic an overground scenario where the user can dynamically modulate the walking speed, which can influence the overall estimation performance (e.g., poor gait phase estimation during slow walking speed). During the trials, unilateral exoskeleton sensor data (a hip joint encoder, trunk and thigh IMUs) were recorded at 100 Hz. During each trial, the exoskeleton used the gait phase-based biological torque controller to provide bilateral hip assistance to the user.

Adaptation Performance on Gait Phase and Walking Speed Estimation

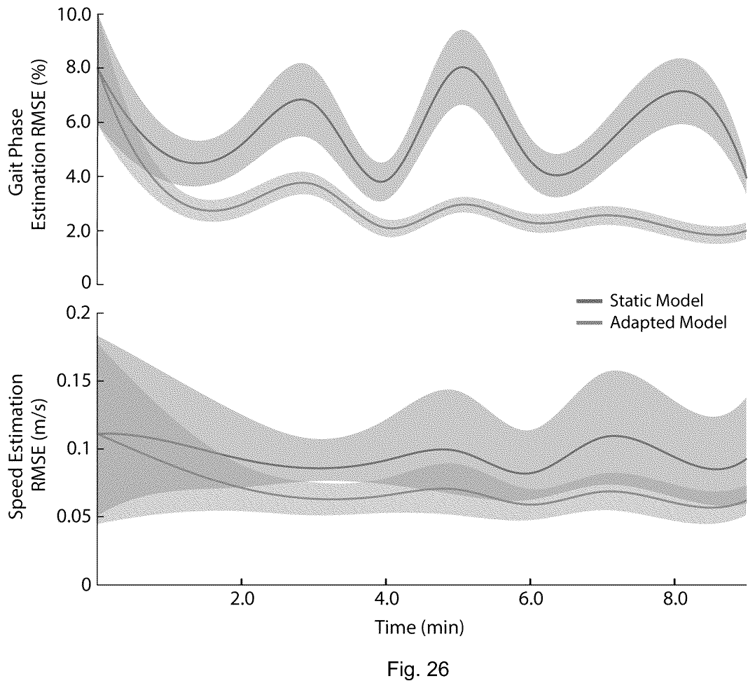

Using this data, we trained a deep learning-based gait phase model. For this validation of the framework's generalizability, we additionally trained a model to estimate the user's walking speed. Following the same method, we systematically optimized the network architecture and hyperparameters using 11-fold leave-one-subject-out validation for both gait phase and walking speed models. After a full optimization process, the final user-independent model had an offline gait phase estimation RMSE of 4.74±0.34% and a walking speed estimation RMSE of 0.090±0.008 m/s. The offline validation of our adaptation framework on the baseline user-independent model indicated that we were able to further reduce both the gait phase and walking speed estimation errors (FIG. 26). FIG. 26 shows offline performance validation of the adaptation framework. The user's gait phase and walking speed estimation models were adapted using the framework while the treadmill speed varied. The fluctuations in the estimated gait phase and walking speed were due to the dynamic changes in the user's walking speed. The shaded regions represent ±1 standard deviation.

For gait phase, the adapted model performed significantly better than the static user-independent model during the last minute of the trial reducing the baseline gait phase estimation RMSE by 54.7±8.59%. For walking speed, using our adaptation framework, the final adapted model further reduced the baseline walking speed estimation RMSE by 39.79±6.81% compared to the user-independent model during the last minute of the trial. Furthermore, as shown with the static model's time series graph, the high variance in estimation error (caused by the dynamic speed profile) was significantly reduced using our adaptation framework, showcasing the viability of using our approach during overground locomotion. Lastly, as shown with the convergence rate of our adaptation for both gait phase and walking speed, our adaptation framework can be applied to multiple user state variables simultaneously.

Generalizing the Adaptation Framework to Other Locomotion Modes

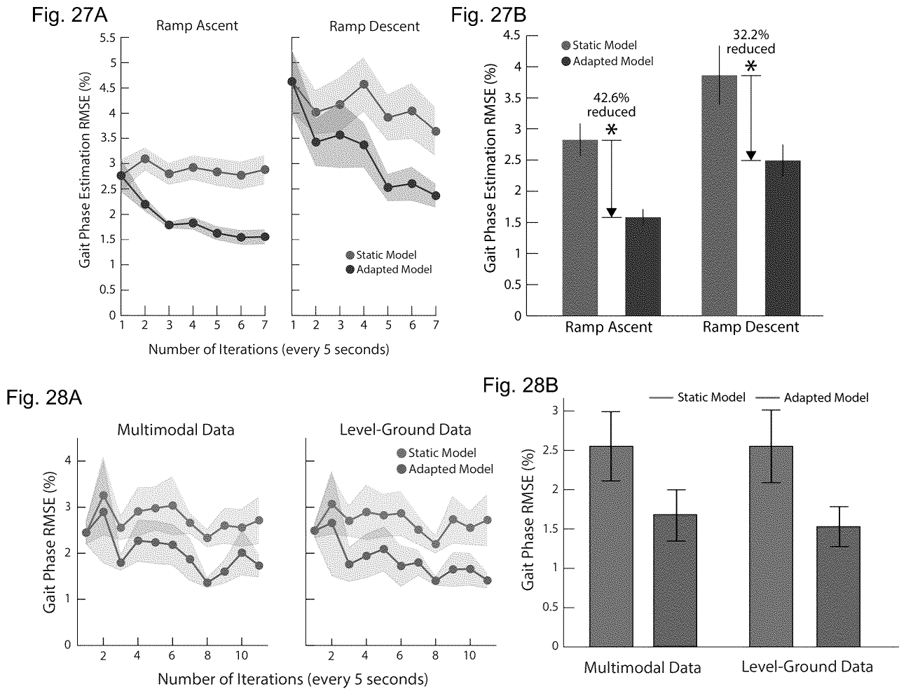

One objective of this study was to deploy the exoskeleton system to real-world settings. To ensure that our online adaptation framework can reliably adapt to the user's gait in varying environments, the system's generalizability in other locomotion modes was validated. We utilized a dataset of multimodal locomotion (i.e., ramp ascent and ramp descent with a slope incline of 11°) while wearing a hip exoskeleton, which was the same dataset used in generating the baseline static gait phase estimator. To ensure user-independent nature in the baseline static model, we utilized training data from nine subjects at a time to run a 10-fold validation for each testing subject. During adaptation, the same baseline parameters described above were used (e.g., learning rate). Our results indicated that the system was able to reliably adapt after 5 iterations for each given mode (FIGS. 27A-27B). FIGS. 27A-27B show performance of the online adaptation framework during multimodal locomotion. FIG. 27A shows the baseline static gait phase estimation model was able to adapt to a new locomotion mode after 5 iterations. FIG. 27B shows after the adaptation phase, the adapted model significantly reduced the baseline gait phase estimation error compared to the static model. The shaded regions and error bars represent ±1 standard error of the mean and asterisks indicate statistical significance (p<0.05).

After the adaptation phase, the final adapted model reduced the relative gait phase estimation RMSE by 42.61±13.86% and 32.23±15.15% compared to the static model for ramp ascent and ramp descent, respectively (p<0.05). Note in this multimodal adaptation result, the ramp mode adaptation results were based on a smaller number of iterations compared to the level-ground results, primarily due to the limited number of strides available for each subject in the dataset.

Effect of Using Multimodal Gait Phase Estimator for Online Adaptation

The aim of this study was to extend the framework's applicability to different environmental settings, including various ambulation modes. In such cases, a multimodal gait phase estimator would be used for the baseline model. It is desirable to ensure that there was no performance discrepancy between the two baseline models in this particular mode. To address this, we performed an offline analysis using treadmill walking data from three able-bodied individuals, similar to Experiment 1 described above. We evaluated the performance of two gait phase estimator models: 1) a model trained on data from five different locomotion modes (i.e., the static model in the main study) and 2) a model trained on data from level-ground walking only. We ensured a fair comparison between the two models by using the same neural network architecture and hyperparameters as in the main study. The results showed that the difference in gait phase estimation performance between the two models during level-ground treadmill walking was negligible (FIGS. 28A-28B). FIGS. 28A-28B show gait phase estimator performance during level-ground walking using different baseline models. Two different baseline models were using 1) a model trained on data from 5 locomotion modes and 2) a model trained on data from only level-ground mode. As shown in FIG. 28A, for both systems, the adaptation framework reduced the baseline estimation error compared to the static model. As shown in FIG. 28B, using a different set of data did not have any effect on the underlying gait phase estimation performance during level ground.

Furthermore, running online adaptation using these two models confirmed that the adaptation performance converged similarly to the results obtained for able-bodied subjects (FIGS. 15A-15C, described above), indicating that our adaptation framework was capable of learning the user's specific gait pattern rather than the generic ambulation task.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. An exoskeleton control architecture of one or more memory structures and/or computer executable instructions stored on one or more non-transitory computer readable medium and executable by one or more processors, the exoskeleton control architecture comprising:
a high-level control layer comprising a convolutional neural network (CNN) configured to receive exoskeleton sensor data from one or more sensors on an exoskeleton and generate a user state estimate; and
a mid-level control layer configured to receive the user state estimate and generate a torque command for an actuator of the exoskeleton based on the user state estimate.

2. The exoskeleton control architecture of claim 1, further comprising:
a low-level control layer implemented on a motor driver of the actuator and configured to translate the torque command into an actuator action to supply a joint torque.

3. The exoskeleton control architecture of claim 2, wherein the actuator action is a motor current, wherein the low-level control layer uses closed-loop current-feedback control to translate the torque command into the motor current.

4. The exoskeleton control architecture of claim 1, wherein the exoskeleton is an autonomous robotic joint exoskeleton.

5. The exoskeleton control architecture of claim 1, wherein the one or more sensors include an encoder configured to measure a joint position and/or angular velocity and/or one or more inertial measurement units (IMUs) configured to measure joint position and/or kinematics.

6. The exoskeleton control architecture of claim 5, wherein the exoskeleton sensor data comprises measured sensor data and/or derived sensor data including one or more of position, velocity, and/or acceleration.

7. The exoskeleton control architecture of claim 1, wherein the user state estimate is an estimated joint moment, and
wherein the mid-level control layer is configured to scale, delay, and filter the estimated joint moment to generate the torque command.

8. The exoskeleton control architecture of claim 1, wherein the user state estimate is an estimated gait phase, and
wherein the mid-level control layer is configured to generate the torque command as a function of the estimated gait phase based on an assistance profile.

9. The exoskeleton control architecture of claim 8, wherein timing and magnitude of nodes of the assistance profile represent control parameters,
wherein the mid-level control layer comprises a human-in-the-loop optimization process that updates a cost landscape based on walking speed and samples the control parameters that increases walking speed improvement based on the updated cost landscape.

10. The exoskeleton control architecture of claim 1, wherein the CNN is a temporal convolutional network (TCN) and the TCN comprises:
a series of a plurality of residual blocks and skip connections, wherein an output of a previous residual block is summed elementwise with an output of a following residual block via the skip connections,
wherein each of the plurality of residual blocks comprises one or more convolutional layers, wherein a dilation factor of the one or more convolutional layers increases with one or more subsequent residual blocks in the series of the plurality of residual blocks.

11. The exoskeleton control architecture of claim 10, wherein each of the plurality of residual blocks comprises two convolutional layers that are each followed by a weight normalization layer and an activation layer.

12. The exoskeleton control architecture of claim 11, wherein the TCN further comprises a convolution layers following each of the plurality of residual blocks.

13. The exoskeleton control architecture of claim 11, wherein the TCN further comprises a fully connected output layer.

14. The exoskeleton control architecture of claim 1, wherein the high-level control layer further comprises a backward labeler configured to relabel ground truth gait phase from the exoskeleton sensor data using a local peak detection,
wherein the high-level control layer further comprises a real-time adaptation trainer configured to train the CNN in a single epoch of backpropagation with the ground truth gait phase.

15. The exoskeleton control architecture of claim 14, wherein the backward labeler and the real-time adaptation trainer operate at different frequencies during an adaptation cycle, wherein the adaptation cycle occurs at a predetermined period.

16. The exoskeleton control architecture of claim 14, wherein the backward labeler and the real time adaptation trainer operate in parallel.

17. The exoskeleton control architecture of claim 1, wherein the CNN is trained based on sensor data from a second exoskeleton, wherein the high-level control layer comprises a transformation matrix that transforms the sensor data from the one or more sensors on the exoskeleton to a data form for the second exoskeleton.

18. The exoskeleton control architecture of claim 1, further comprising:
a first processor configured to execute an inference process with the CNN as a dedicated process; and
a second processor configured to execute the mid-level control layer.

19. The exoskeleton control architecture of claim 18, wherein the first processor is further configured to execute an I/O process configured to receive and supply the exoskeleton sensor data to the inference process via an input queue.

20. The exoskeleton control architecture of claim 19, wherein the second processor is further configured to supply the torque command to the actuator of the exoskeleton.
